(19) United States
(12) Patent Application Publication
(10) Pub. No.: US 2024/0377216 A1
(43) Pub. Date: Nov. 14, 2024

(54) USER INTERFACES FOR MAPS ON MOBILE DEVICES

(71) Applicant: Apple Inc., Cupertino, CA (US)

(72) Inventors: Kevin N. EUGENE, San Francisco, CA (US); Yekaterina Chanba, Campbell, CA (US); Nathaniel G. SLAUGHTER, IV, Cupertino, CA (US); William N. DANNER, Santa Cruz, CA (US); Sung Eun PARK, Santa Clara, CA (US); Philip C. Davis, San Francisco, CA (US); Woo Yung Choi, San Francisco, CA (US)

(21) Appl. No.: 18/660,088

(22) Filed: May 9, 2024

Related U.S. Application Data
(60) Provisional application No. 63/501,369, filed on May 10, 2023.

(51) Int. Cl. G01C 21/36; G06F 3/0481

(52) U.S. Cl. CPC G01C 21/367; G01C 21/3676; G06F 3/0481

(57) ABSTRACT

In some embodiments, an electronic device displays a visual indication of a walking radius while in a maps application. In some embodiments, an electronic device displays information on a map, including indications of locations. In some embodiments, an electronic device displays navigation directions in different formats while navigating using different modes of transportation. In some embodiments, an electronic device performs additional features while the current location of the electronic device is in a predetermined area.

### CROSS-REFERENCE TO RELATED APPLICATIONS

This application claims the benefit of U.S. Provisional Application No. 63/501,369, filed May 10, 2023, the contents of which are herein incorporated by reference in their entireties for all purposes.

### FIELD OF THE DISCLOSURE

This disclosure relates generally to user interfaces presenting map features based on mode of transportations and map areas.

### BACKGROUND OF THE DISCLOSURE

User interaction with electronic devices has increased significantly in recent years. These devices can be devices such as computers, tablet computers, televisions, multimedia devices, or mobile devices. In some circumstances, users want to efficiently view map information using multiple transportation modes or while in different areas of a map.

### SUMMARY OF THE DISCLOSURE

Providing efficient ways of presenting content to a user via a maps application of an electronic device may improve the user's experience with the electronic device and reduce the number of inputs needed to view relevant information in a maps application, thereby reducing power usage and improving the battery life of the electronic device.

In some embodiments, an electronic device displays a visual indication of a walking radius while in a maps application. In some embodiments, an electronic device displays information on a map, including indications of locations. In some embodiments, an electronic device displays navigation directions in different formats while navigating using different modes of transportation. In some embodiments, an electronic device performs additional features while the current location of the electronic device is in a predetermined area. The full descriptions of the embodiments are provided in the Drawings and the Detailed Description, and it is understood that the Summary provided above does not limit the scope of the disclosure in any way.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6L illustrate examples of an electronic device displaying a visual indication of a walking radius while in a maps application according to some embodiments of the disclosure.

FIG. 7 is a flow diagram illustrating a method in which an electronic device displaying a visual indication of a walking radius while in a maps application according to some embodiments of the disclosure.

FIGS. 8A-8N illustrate exemplary ways in which an electronic device displays information on a map, including indications of locations according to some embodiments of the disclosure.

FIG. 9 is a flow diagram illustrating a method in which an electronic device displays information on a map, including indications of locations according to some embodiments of the disclosure.

FIGS. 10A-10P illustrate examples of an electronic device displays navigation directions in different formats while navigating using different modes of transportation according to some embodiments of the disclosure.

FIG. 11 is a flow diagram illustrating a method in which an electronic device displays navigation directions in different formats while navigating using different modes of transportation according to some embodiments of the disclosure.

FIGS. 12A-12J illustrate exemplary ways in which an electronic device performs additional features while the current location of the electronic device is in a predetermined area according to some embodiments of the disclosure.

FIG. 13 is a flow diagram illustrating a method in which an electronic device performs additional features while the current location of the electronic device is in a predetermined area according to some embodiments of the disclosure.

### DETAILED DESCRIPTION

In the following description of embodiments, reference is made to the accompanying drawings which form a part hereof, and in which it is shown by way of illustration specific embodiments that are optionally practiced. It is to be understood that other embodiments are optionally used and structural changes are optionally made without departing from the scope of the disclosed embodiments.

There is a need for user interfaces of a maps application that can present relevant content without the need for additional inputs. In some embodiments, an electronic device displays a map of a physical area. In some embodiments, an electronic device concurrently displays an indication of a current location of the electronic device, an indication of a radius around the current location of the electronic device, and a visual indication indicating a distance of the current location of the electronic device to the radius. In some embodiments, the indications and visual indications are displayed while in various modes of the maps application (e.g., explore mode, compass mode, or transit mode). Displaying the indication of the radius and indication indicating the distance between the current location of the electronic device and the radius enhances user interactions with the electronic device by providing more information without requiring additional inputs.

In some embodiments, the electronic device displays information on a map, including indications of locations. For example, in response to a request to search for locations matching a search query, the electronic device displays a map with indications at locations on the map corresponding to locations in the region represented by the map that match the search query. In some embodiments, the electronic device displays one of the indications with increased visual prominence compared to the other indications and displays a user interface element overlaid on the map with information about the location corresponding to the indication displayed with increased visual prominence. In some embodiments, in response to receiving an input, the electronic device changes which indication is displayed with visual prominence and updates the user interface element to including information about the location corresponding to the indication that is now displayed with increased visual prominence. Displaying indications of locations on the map and information about one of the indications enhances user interactions with the electronic device by reducing the number of inputs needed to concurrently view indications of multiple locations corresponding to a request for information and additional information about one of the locations.

In some embodiments, the electronic device navigates from a current location of the electronic device to a destination location of the electronic device using a maps application. In some embodiments, while navigating, the electronic device displays information relevant to the navigation in different formats. In some embodiments, in response to a user input, the electronic device updates the format of the information to a different format with different information. In some embodiments, Displaying information in different formats while in different modes of transportation provides quick and efficient access to relevant content without the need for additional inputs and thereby reducing erroneous inputs to the electronic device.

In some embodiments, the electronic device performs additional features while the current location of the electronic device is in a predetermined area. For example, the predetermined area is a hiking area including hiking trails and/or trailheads, such as a park. In some embodiments, while the current location of the electronic device is in the hiking area and while displaying a user interface of a maps application, the electronic device displays a selectable option associated with the hiking area. In some embodiments, in response to receiving an input selecting the selectable option, the electronic device displays a map including indications of locations of hiking trails and trailheads at locations on the map corresponding to the locations of these features in the physical area represented by the map. Performing additional features associated with the predetermined area enhances user interactions with the electronic device by reducing the number of inputs needed to perform functions likely of interest to the user based on the current location of the electronic device.

Although the following description uses terms “first,” “second,” etc. to describe various elements, these elements should not be limited by the terms. These terms are only used to distinguish one element from another. For example, a first touch could be termed a second touch, and, similarly, a second touch could be termed a first touch, without departing from the scope of the various described embodiments. The first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

### Exemplary Devices

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touch pads), are, optionally, used. It should also be understood that, in some embodiments, the device is not a portable communications device, but is a desktop computer or a television with a touch-sensitive surface (e.g., a touch screen display and/or a touch pad). In some embodiments, the device does not have a touch screen display and/or a touch pad, but rather is capable of outputting display information (such as the user interfaces of the disclosure) for display on a separate display device, and capable of receiving input information from a separate input device having one or more input mechanisms (such as one or more buttons, a touch screen display and/or a touch pad). In some embodiments, the device has a display, but is capable of receiving input information from a separate input device having one or more input mechanisms (such as one or more buttons, a touch screen display and/or a touch pad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse and/or a joystick. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

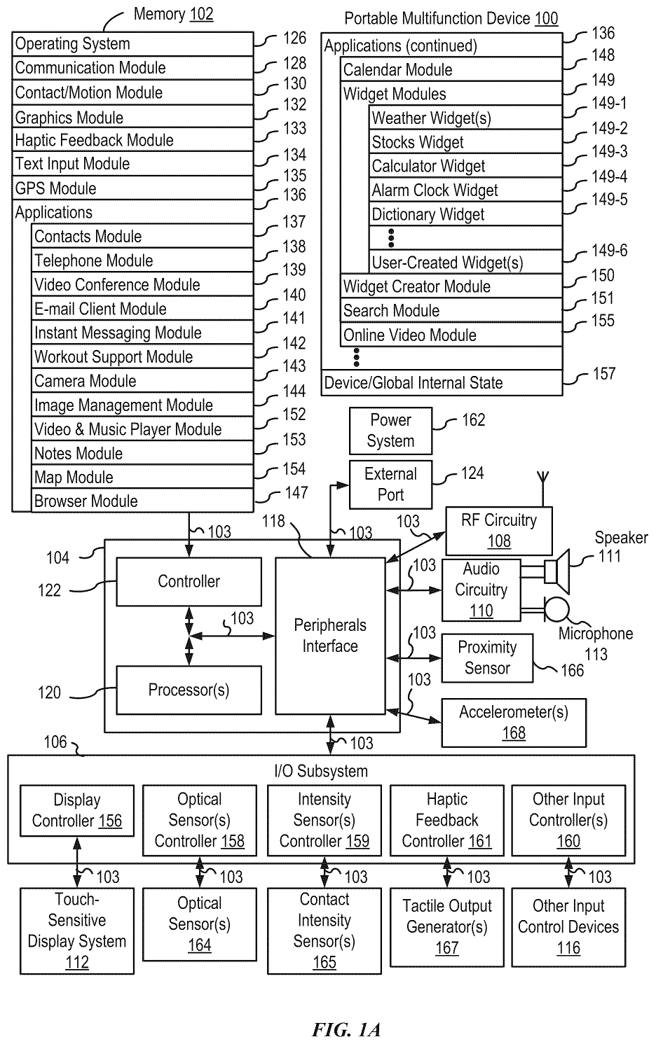

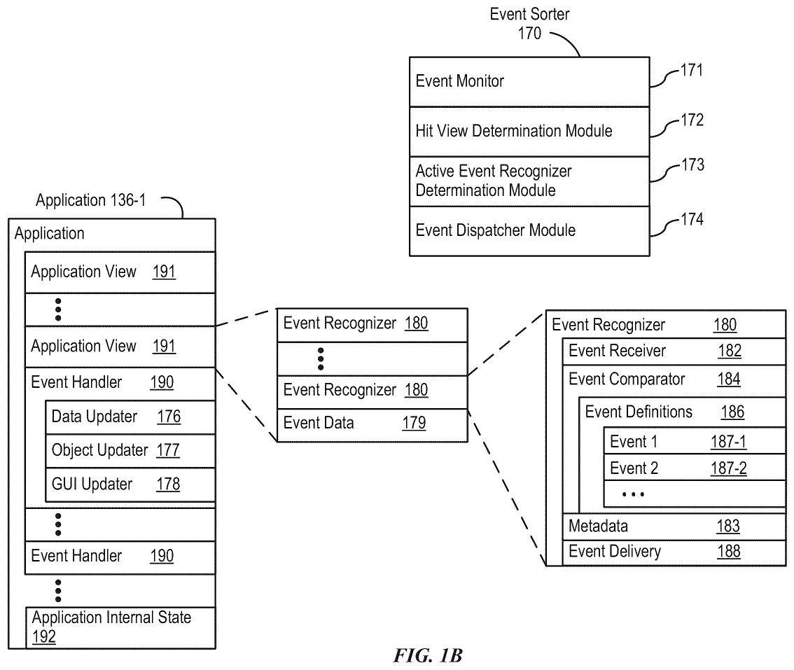

Attention is now directed toward embodiments of portable or non-portable devices with touch-sensitive displays, though the devices need not include touch-sensitive displays or displays in general, as described above. FIG. 1A is a block diagram illustrating portable or non-portable multifunction device 100 with touch-sensitive displays 112 in accordance with some embodiments. Touch-sensitive display 112 is sometimes called a “touch screen” for convenience, and is sometimes known as or called a touch-sensitive display system. Device 100 includes memory 102 (which optionally includes one or more computer readable storage mediums), memory controller 122, one or more processing units (CPU's) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as a “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable or non-portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application specific integrated circuits. Further, the various components shown in FIG. 1A are optionally implemented across two or more devices; for example, a display and audio circuitry on a display device, a touch-sensitive surface on an input device, and remaining components on device 100. In such an embodiment, device 100 optionally communicates with the display device and/or the input device to facilitate operation of the system, as described in the disclosure, and the various components described herein that relate to display and/or input remain in device 100, or are optionally included in the display and/or input device, as appropriate.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs and/or sets of instructions stored in memory 102 to perform various functions for device 100 and to process data.

In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

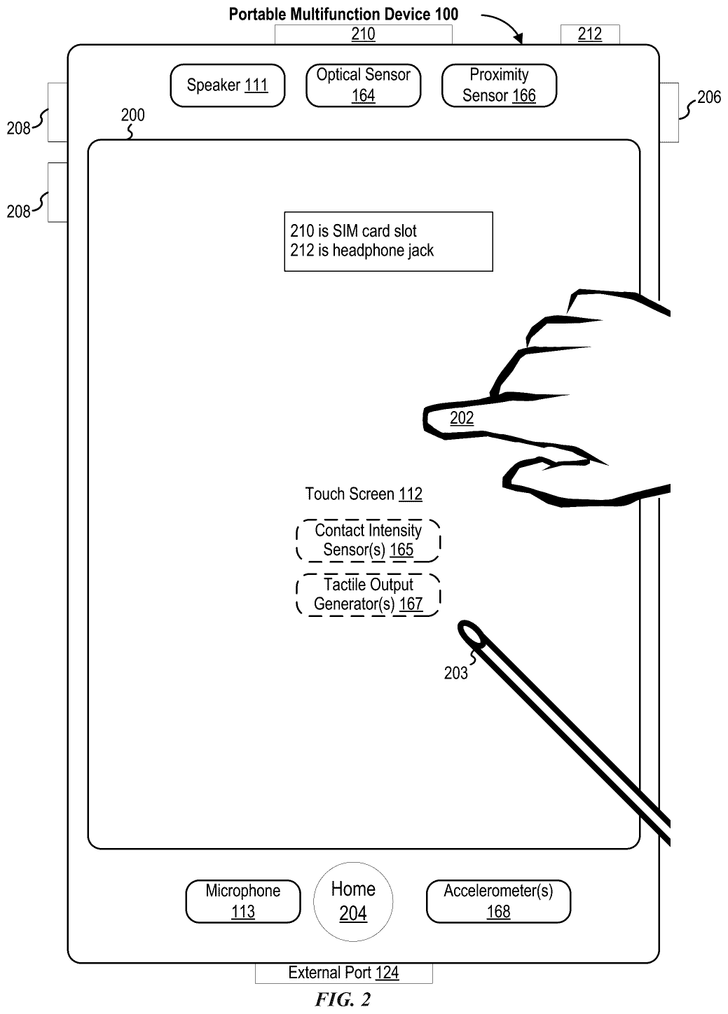

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, intensity sensor controller 159, haptic feedback controller 161 and one or more input controllers 160 for other input or control devices. The one or more input controllers 160 receive/send electrical signals from/to other input or control devices 116. The other input control devices 116 optionally include physical buttons (e.g., push buttons, rocker buttons, etc.), dials, slider switches, joysticks, click wheels, and so forth. In some alternate embodiments, input controller(s) 160 are, optionally, coupled to any (or none) of the following: a keyboard, infrared port, USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. As described above, the touch-sensitive operation and the display operation of touch-sensitive display 112 are optionally separated from each other, such that a display device is used for display purposes and a touch-sensitive surface (whether display or not) is used for input detection purposes, and the described components and functions are modified accordingly. However, for simplicity, the following description is provided with reference to a touch-sensitive display. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output corresponds to user-interface objects.

Touch screen 112 has a touch-sensitive surface, sensor or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone®, iPod Touch®, and iPad® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad (not shown) for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable or non-portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112 which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112 which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer (not shown) and a GPS (or GLONASS or other global navigation system) receiver (not shown) for obtaining information concerning the location and orientation (e.g., portrait or landscape) of device 100.

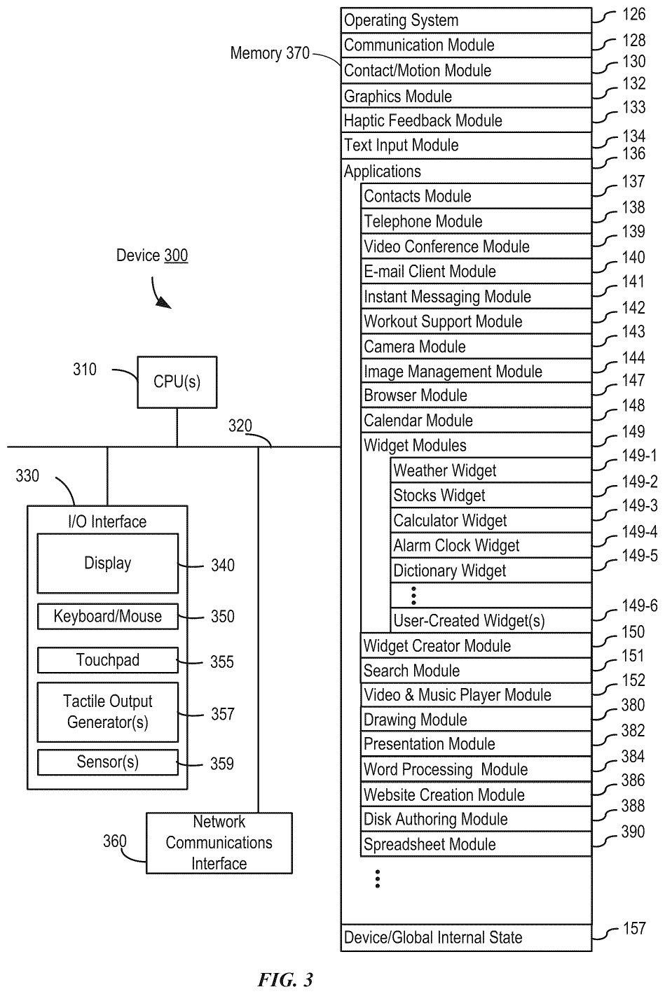

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used on iPod (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact) determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing, to camera 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
video player module;
music player module;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which merges video player module and music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo!Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs, procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit (not shown) or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (187) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable or non-portable multifunction device 100 having a touch screen 112 in accordance with some embodiments. As stated above, multifunction device 100 is described as having the various illustrated structures (such as touch screen 112, speaker 111, accelerometer 168, microphone 113, etc.); however, it is understood that these structures optionally reside on separate devices. For example, display-related structures (e.g., display, speaker, etc.) and/or functions optionally reside on a separate display device, input-related structures (e.g., touch-sensitive surface, microphone, accelerometer, etc.) and/or functions optionally reside on a separate input device, and remaining structures and/or functions optionally reside on multifunction device 100.

The touch screen 112 optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As previously described, menu button 204 is, optionally, used to navigate to any application 136 in a set of applications that are, optionally executed on device 100. Alternatively, in some embodiments, the menu button is implemented as a soft key in a GUI displayed on touch screen 112.

In one embodiment, device 100 includes touch screen 112, menu button 204, push button 206 for powering the device on/off and locking the device, volume adjustment button(s) 208, Subscriber Identity Module (SIM) card slot 210, head set jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not include the display and the touch-sensitive surface, as described above, but rather, in some embodiments, optionally communicates with the display and the touch-sensitive surface on other devices. Additionally, device 300 need not be portable. In some embodiments, device 300 is a laptop computer, a desktop computer, a tablet computer, a multimedia player device (such as a television or a set-top box), a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable or non-portable multifunction device 100 (FIG. 1A), or a subset thereof. Furthermore, memory 370 optionally stores additional programs, modules, and data structures not present in memory 102 of portable or non-portable multifunction device 100. For example, memory 370 of device 300 optionally stores drawing module 380, presentation module 382, word processing module 384, website creation module 386, disk authoring module 388, and/or spreadsheet module 390, while memory 102 of portable or non-portable multifunction device 100 (FIG. 1A) optionally does not store these modules.

Each of the above identified elements in FIG. 3 are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

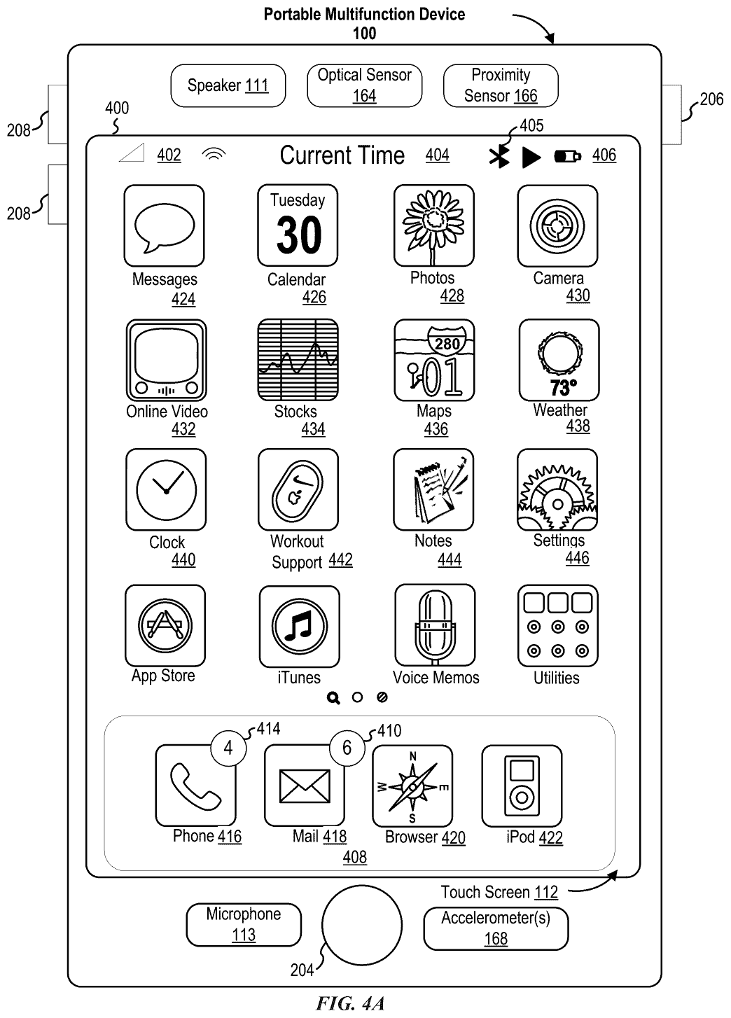

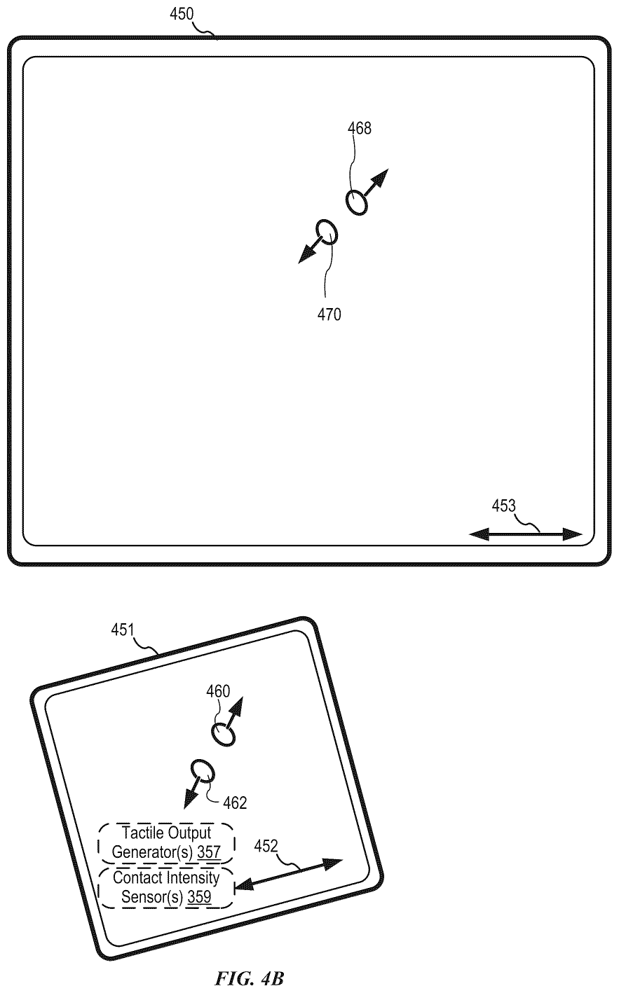

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
Icon 420 for browser module 147, labeled “Browser;” and
   Icon 422 for video and music player module 152, also referred to as iPod (trademark of Apple Inc.) module 152, labeled “iPod;” and
   Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.5, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90% or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the description of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

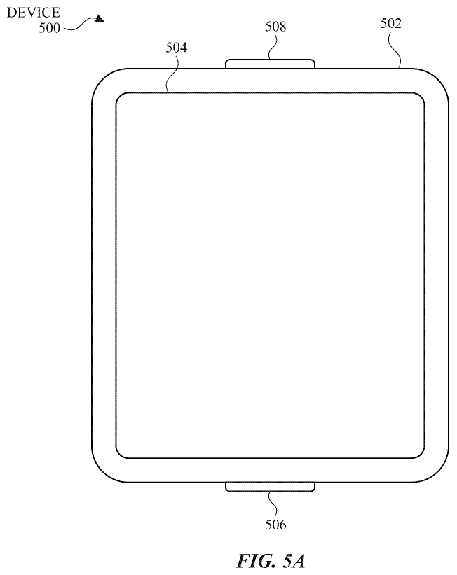

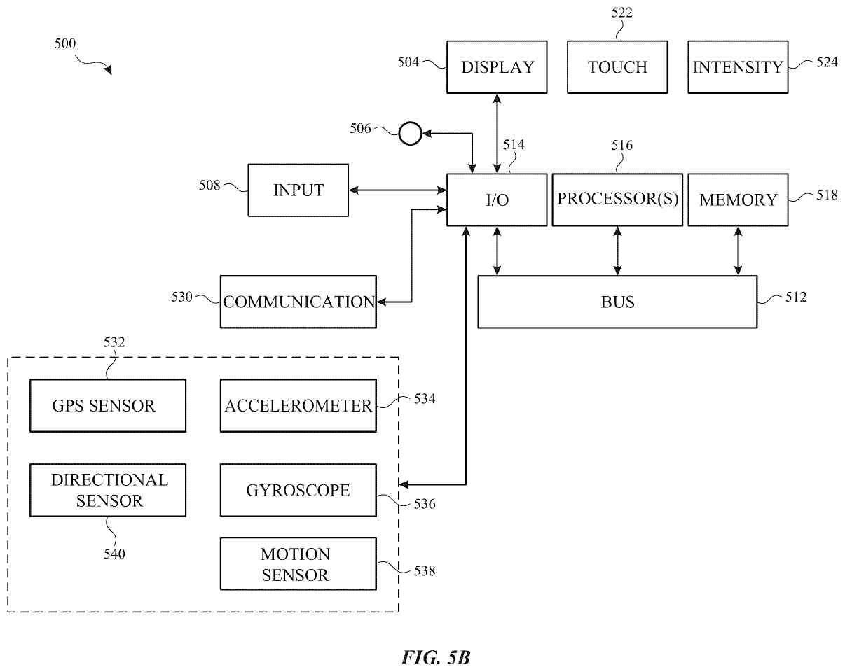

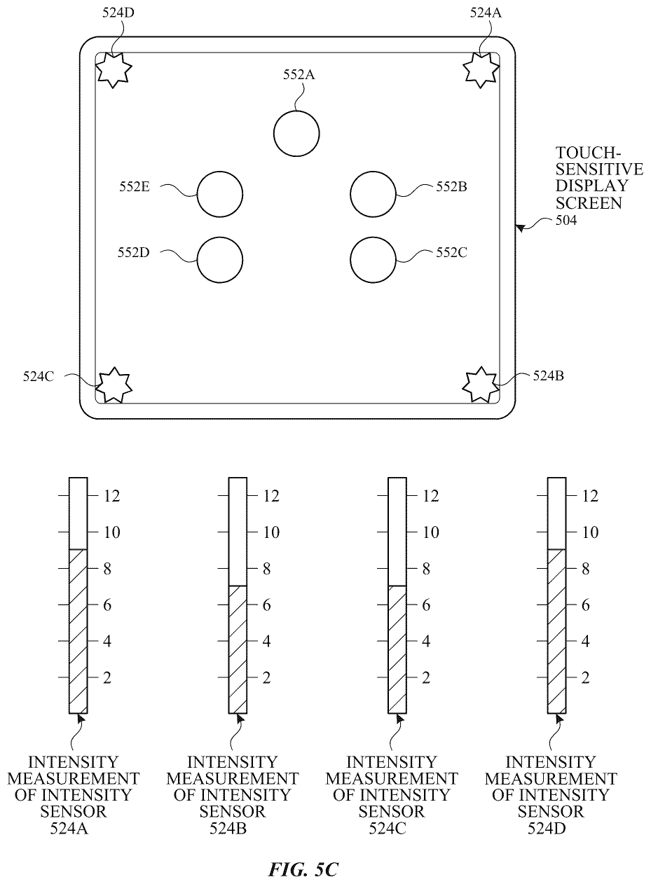

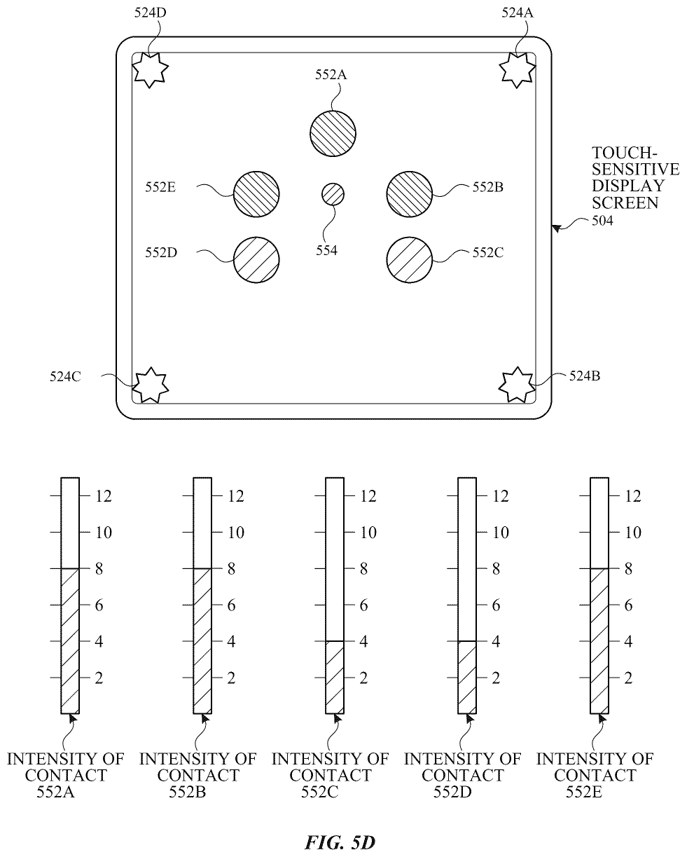

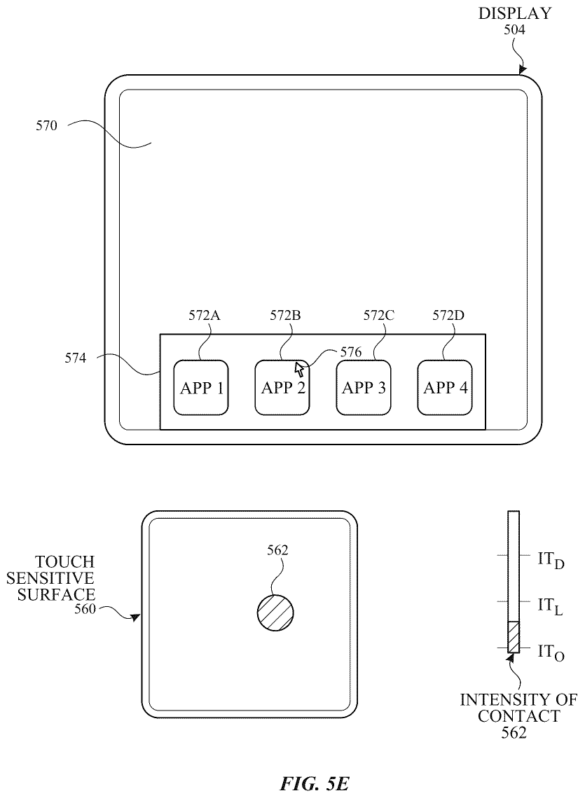

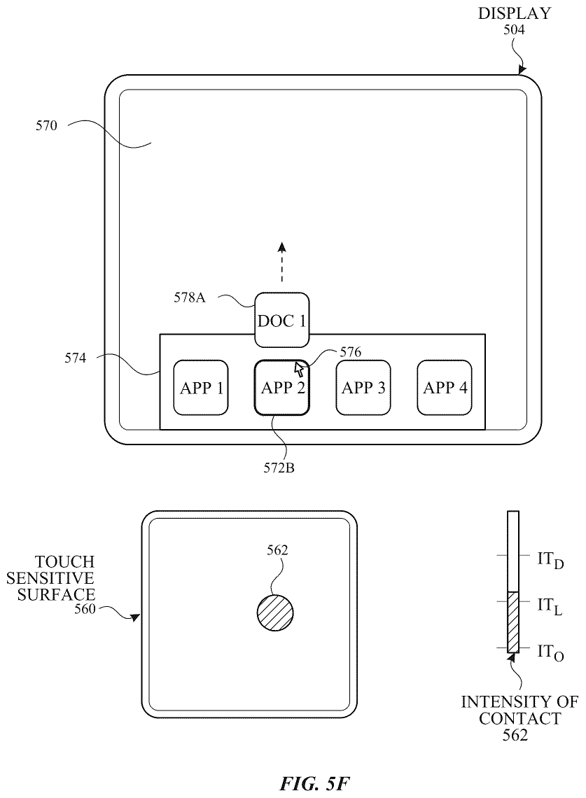

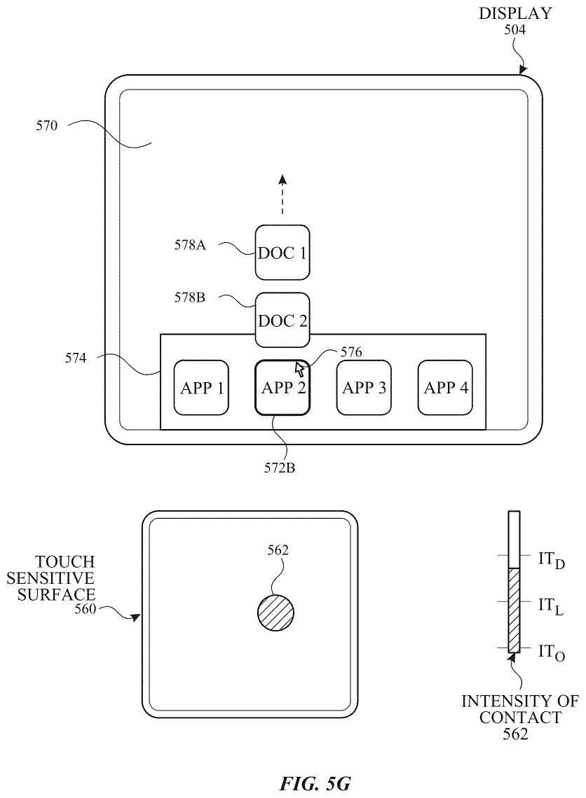

FIG. 5A illustrates a block diagram of an exemplary architecture for the device 500 according to some embodiments of the disclosure. In the embodiment of FIG. 5A, media or other content is optionally received by device 500 via network interface 502, which is optionally a wireless or wired connection. The one or more processors 504 optionally execute any number of programs stored in memory 506 or storage, which optionally includes instructions to perform one or more of the methods and/or processes described herein (e.g., method 700, 900, 1100, and/or 1300). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIGS. 5, but can include other or additional components in multiple configurations.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.5, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “IT_{D}”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “IT_{D}”). Contact 562 is maintained on touch-sensitive surface 560. In response to the detection of the gesture, and in accordance with contact 562 having an intensity that goes above the deep press intensity threshold (e.g., “IT_{D}”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “IT_{D}”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

Attention is now directed towards embodiments of user interfaces (“UI”) and associated processes that are implemented on an electronic device, such as device 100, device 300, or device 500.

### USER INTERFACES AND ASSOCIATED PROCESSES DISPLAYING VISUAL INDICATION OF a WALKING RADIUS WHILE IN a MAPS APPLICATION

Users interact with electronic devices in many different manners. In some embodiments, an electronic device presents a visual indication of a walking radius while in a maps application. In some embodiments, the visual indication of the walking radius is presented while in various modes of the maps application. The embodiments described below provide ways in which an electronic device presents the visual indication of the walking radius while in various modes of the maps application. The ability of an electronic device to display the visual indication of the walking radius reduces the amount of time needed by a user to view relevant information, thus reducing power usage of the electronic device. When a person uses an electronic device, that person is optionally referred to as a user of the electronic device.

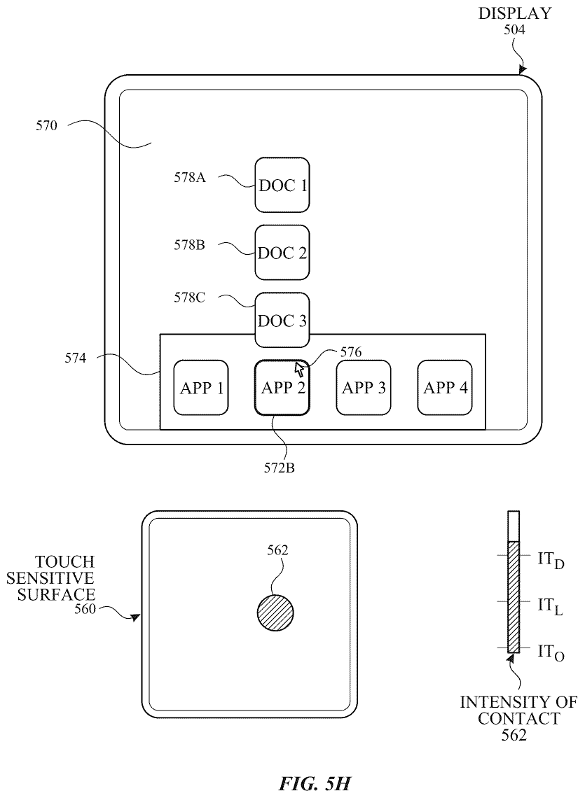

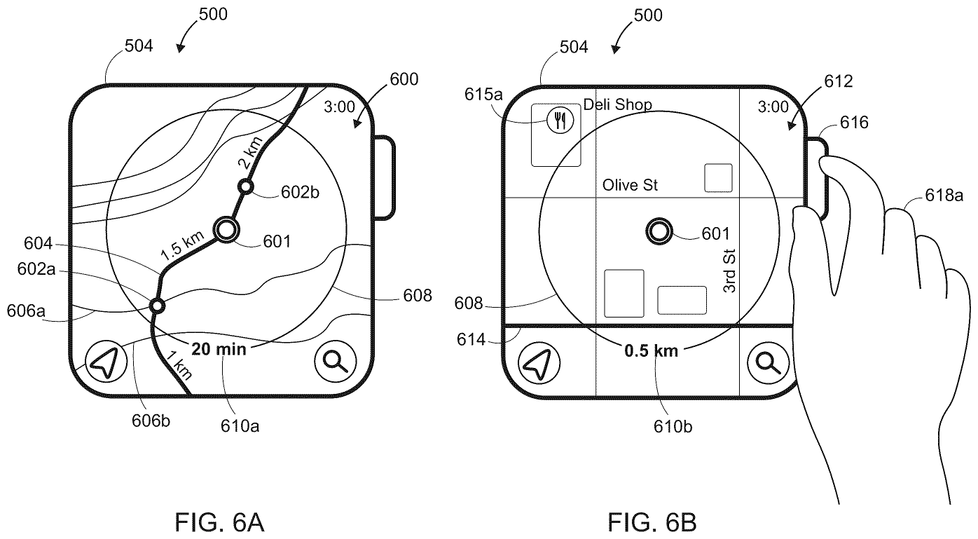

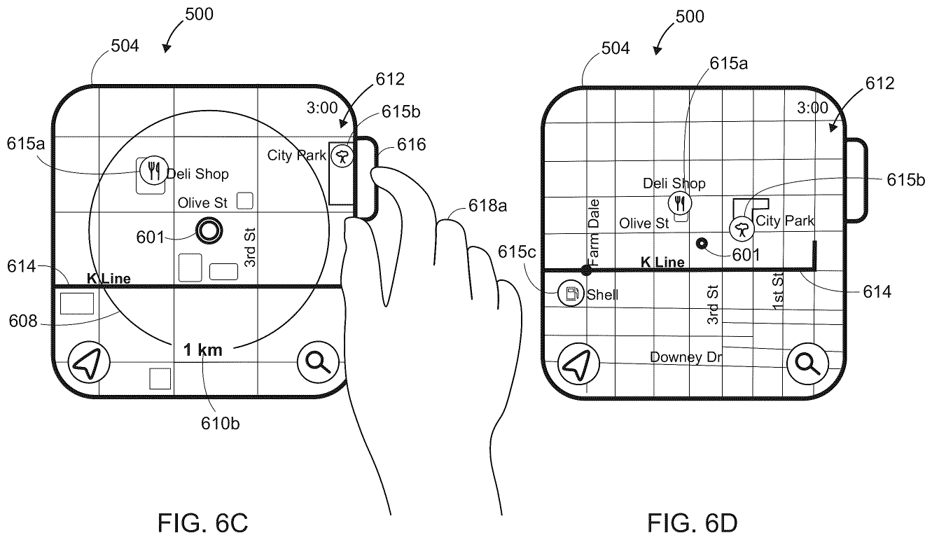

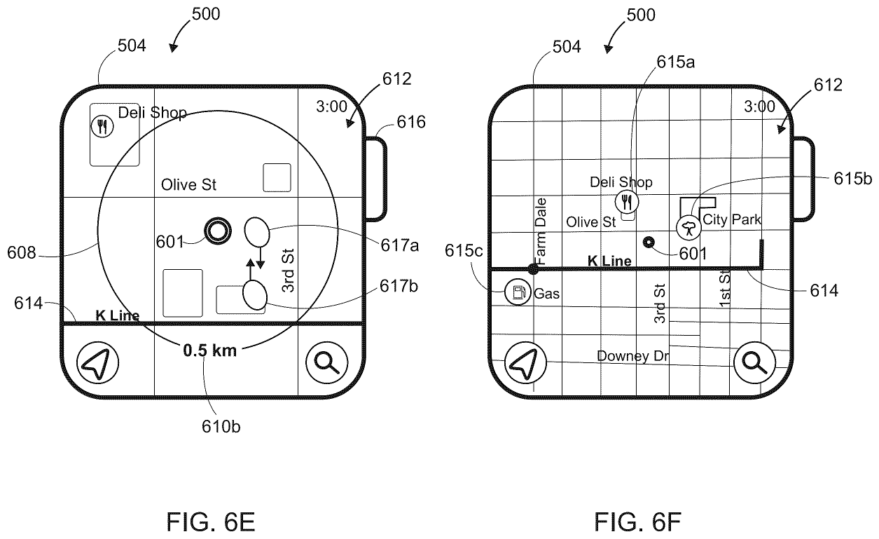

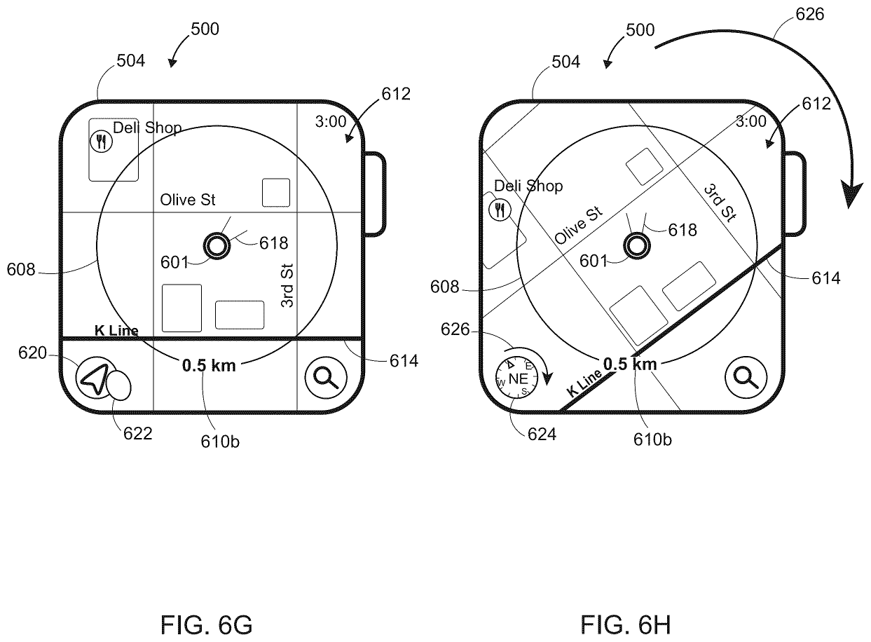

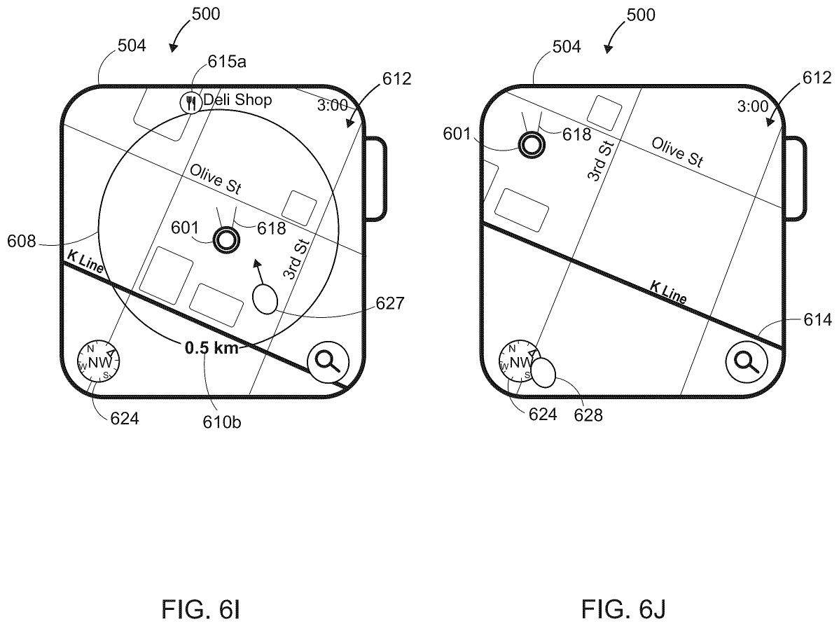

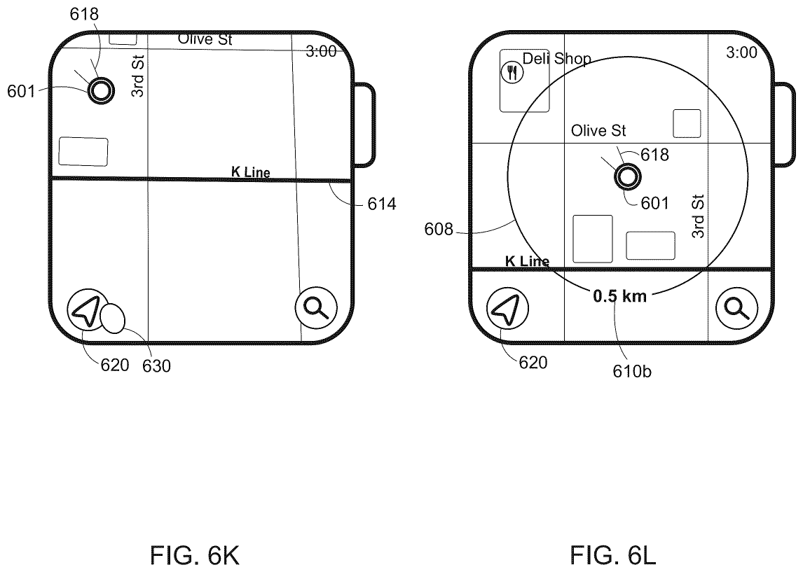

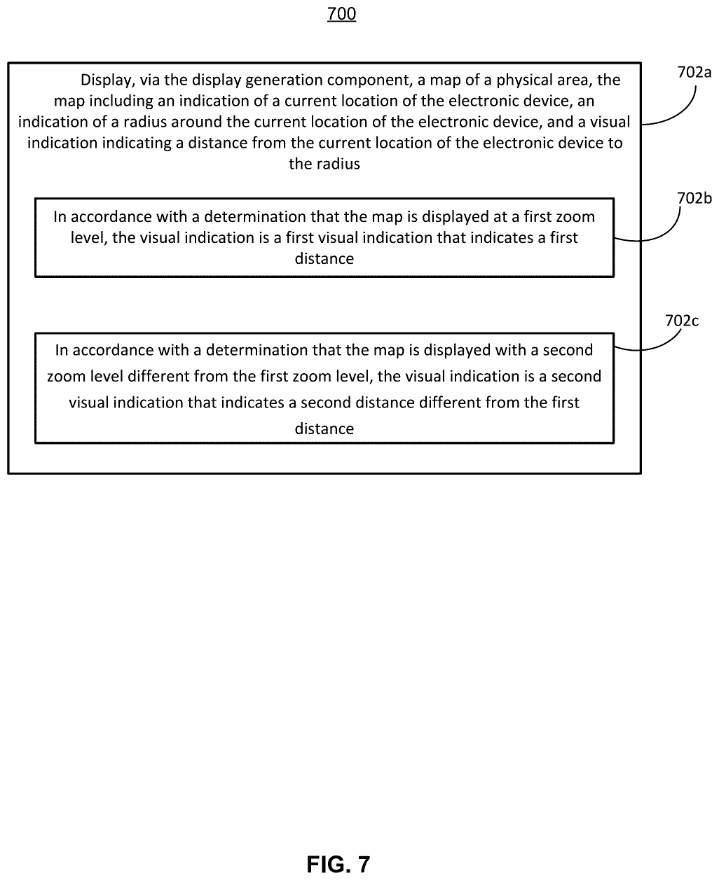

FIGS. 6A-6L illustrate exemplary ways in which an electronic device displays a visual indication of a walking radius while in a maps application. The embodiments in these figures are used to illustrate the processes described below, including the processes described with reference to FIG. 7. These figures are not meant to be limiting; other user interfaces are possible in accordance with method 700 without departing from the scope of the disclosure.

FIG. 6A illustrates electronic device 500 displaying user interface 600 (e.g., via a display device, via a display generation component, or via a touch screen 504). In some embodiments, user interface 600 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with device 500. In some embodiments, device 500 is a wearable device such as a smart watch. In some embodiments, the electronic device 500 includes a crown 616. The electronic device 500 can receive inputs directed to the crown 616, such as inputs that press the crown 616 like a button and inputs that turn the crown 616 like a dial.

In some embodiments, user interface 600 is a user interface of a maps application. In some embodiments, the user interface 600 includes a portion of a map in a predefined area, such as a hiking area (e.g., a national park, a state park, or another park that has trails and/or trailheads). In some embodiments, the user interface 600 includes an indication 601 of the current location of the electronic device 500. In some embodiments, while in the predefined area (e.g., hiking area), the device 500 displays indications 602a-b of trail junctions and an indication 604 of a trail segment between the indications 602 of trail junctions on the map. In some embodiments, the indications 602a-b of trail junctions indicate a location at which the trail splits. In some embodiments, the trails are hiking trails that exist in the predefined area. In some embodiments, each segment of the trail (indication 604) includes a distance label indicating the distance of the trail between trail junctions. For example, the distance between the indication 602a and the indication 602b through the trail segment (indication 604) is 1.5 km. in some embodiments, while in a predefined area, user interface 600 also shows topography of the area. For example, the user interface 600 includes a plurality of indications (indications 606a-b) which indicates elevation in the given area. For example, the elevation between indication 606a and indication 606b represents 100 m and the contours of the indications 606a-b of elevation indicate the contours of elevation in the physical area represented by the map.

In some embodiments, the user interface 600 includes an indication 608 of a radius around the indication 601 of the current location of the device 500. For example, the indication 608 is displayed as a circle around the indication 601 of the current location, as described in further detail in method 700. In some embodiments, the user interface 600 includes an indication 610a of a distance from the current location of the electronic device to the locations corresponding to indication 608 (e.g., the distance is the radius of the circle). In some embodiments, indication 610a is represented in units of time. In some embodiments, the units of time are calculated using an average walking speed (for a user that walks) or an average rolling speed (for a user in a wheelchair) and the distance between the current location and the indication 608, as described in further detail in method 700. In some embodiments, a user of device 500 toggles between a wheelchair unit of time and a walking unit of time using a settings user interface of the device 500 and/or a settings user interface of the maps application.

FIG. 6B illustrates an example of the electronic device 500 displaying a user interface 612 including a map of a physical area in a city. In some embodiments, the electronic device 500 displays user interface 612 in FIG. 6B while in a transit mode of the maps application. For example, operating in the transit mode includes displaying an indication 614 of a transit line on the map in the user interface 612. In some embodiments, indication 608 of the radius around the current location of the electronic device 500 and indication 610b of the distance of the radius are displayed while in the transit mode. In some embodiments, indications 608 and 610a-b are displayed in different modes of the maps application (e.g., while displaying a map of a city without transit lines indicated, while displaying a map of a predefined area (e.g., hiking area), and/or while displaying a map in the transit mode).

In some embodiments, the distance from the current location of the electronic device to the location of the indication 608 is represented in units of distance (e.g., indication 610b), rather than in units of time (e.g., indication 610a), as described in further detail in method 700. For example, the indication 610b of distance in FIG. 6B indicates the distance between the current location of the electronic device 500 and the location of the indication 608 in kilometers. In some embodiments, the distance between the current location and the location of indication 608 and is determined using a scale of a map (e.g., 1 cm: 250 m) regardless of whether the indication 610b is displayed in units of distance or units of time. For example, as described in more detail below with reference to method 700 and FIG. 6C, the indication 608 is displayed at a fixed size irrespective of the scale of the map, thereby representing a different amount of distance (or different estimated walking or rolling time) depending on the scale of the map.

In some embodiments, the user interface 612 (and the user interface 600) includes indications 615a-c of points of interest on the map while displaying indication 608 and 610a-b. For example, in FIG. 6B, the user interface 612 includes an indication 615a of a restaurant within the map area. In some embodiments, the indications 615a-c include a textual and/or visual description of the point of interest (e.g., “Deli Shop” and the restaurant logo). In some embodiments, the indications 615a-c and/or the labels are displayed over (e.g., overlayed) the indication 608 and/or 610a-b. For example, in FIG. 6I, indication 615a is overlayed over indication 608. In some embodiments, selecting any of indications 615a-c results in device 500 displaying a user interface including additional information about indications 615a-c. In some embodiments, indication 608 and/or 610a-b are overlaid over non-selectable indications on user interface 600 and/or user interface 612. For example, non-selectable indications include topographical lines, roads, road names, and other features of the user interface without additional information.

In some embodiments, the device 500 receives an input (e.g., a turning/twisting input) using a crown 616 of device 500. In some embodiments, the zoom level of the map on user interface 612 is based on the amount (e.g., of speed, distance, and/or duration) of turning by user 618a of the crown 616. For example, a half twist of the crown 616 zooms out the map less than a full twist of the crown 616. In some embodiments, the zoom level of the map on user interface 612 is dependent on the direction of the input. For example, a clockwise twist zooms in and a counter clockwise twist zooms out, or vice versa. In response to receiving the input shown in FIG. 6B, the device 500 displays a larger portion of the map on user interface 612 (e.g., the map is zoomed out), as shown in FIG. 6C.

FIG. 6C illustrates an example of the electronic device 500 displaying the maps application user interface with the updated zoom level in response to receiving the input illustrated in FIG. 6B. In some embodiments, indication 608 remains the same size irrespective of the level of zoom with which the electronic device 500 displays the map. In some embodiments, in response to the input illustrated in FIG. 6B, indication 610b is displayed with an updated distance because the scale of the map has changed (e.g., 1 cm: 500 m). In some embodiments, in response to receiving the input illustrated in FIG. 6B, more of the map is visible. In some embodiments, in FIG. 6C, indication 615b is now shown on user interface 612. In some embodiments, indication 615b is an indication of a point of interest different than the point of interest represented by indication 615a. In some embodiments, indication 615b includes a logo of a tree to indicate that the location of indication 615b is a green space (e.g., a park), and a textual description indicating the location of interest (“City Park”). In some embodiments, in response to the input from contact 618a, the indication 614 of the transit line remains displayed.

In some embodiments, device 500 receives an input using the crown 616 of device 500, as shown in FIG. 6C. In response to receiving the input shown in FIG. 6C, device 500 displays a further zoomed out map on user interface 612, as shown in FIG. 6D.

As shown in FIG. 6D, in some embodiments, the updated map includes indication 615c of a point of interest, including a logo of a gas station, and a textual description representing the point of interest (“Gas”). In some embodiments, indication 614 continues to be displayed in FIG. 6D in response to the input in FIG. 6C. In some embodiments, additional information is displayed in FIG. 6D while the map is at a zoom level different than shown in FIG. 6A. For example, in FIG. 6C and in FIG. 6D, indication 614 includes a textual description of the transit line (“K line”). In some embodiments, while at the zoom level illustrated in FIG. 6D, indication 610b and 608 are no longer displayed. In some embodiments, the zoom level of FIG. 6D exceeds a pre-defined threshold for displaying indications 608 and 610b. For example, in FIG. 6D, the distance between the indication 601 and the indication 608 exceeds 1 km. In some embodiments, the units of time of the distance between indication 601 and the indication 608 exceeds 60 minutes in FIG. 6D. In some embodiments, there is also a minimum map scale threshold under which the electronic device 500 forgoes display of indications 608 and 610b. Example thresholds are provided below in the description of method 700.

FIG. 6E illustrates device 500 with user interface 612 including indications 608 and 610b, as described with reference to FIG. 6C. In FIG. 6E, the electronic device 500 receives an input from contacts 617a and 617b directed towards the user interface 612. In some embodiments, a user of device 500 pinches with a thumb and index finger (e.g., with contacts 617a and 617b) on the touch screen 504 to zoom out on the map displayed on user interface 612. In response to receiving the input with contacts 617a and 617b, the device 500 displays the map on user interface 612 with a different zoom level, as shown in FIG. 6F. In some embodiments, FIG. 6F has one or more characteristics of FIG. 6D. In some embodiments, a pinch input with contacts 617a and 617b shown in FIG. 6E elicits a similar response as a twist input on crown 616 as described in FIG. 6C.

FIG. 6G illustrates device 500 displaying user interface 612 including a map of a portion of a city, which is described in further detail above with reference to FIG. 6B. In some embodiments, FIG. 6B illustrates the map with a predetermined orientation such that north corresponds to the top of the map. In some embodiments, the electronic device displays the indication 601 of the current location of the electronic device with an indication 618 that shows the orientation of the device 500 relative to north. For example, as shown in FIG. 6G, indication 618 is pointed northeast because the device 500 is facing northeast. In some embodiments, the user interface 612 includes a selectable option 620 that, when selected, causes the electronic device to display the user interface 612 in a compass mode. As shown in FIG. 6G, the electronic device 500 receives an input (e.g., including contact 622) directed to the selectable option 620.

In some embodiments, in response to the selection input using contact 622 on option 620 shown in FIG. 6G, the device 500 displays interface 612 in the compass mode, as shown in FIG. 6H. In some embodiments, the selection on option 620 displays a compass mode while indication 601 of the current location of the device 500 is in the center of the map in the user interface 612. In some embodiments, in response to receiving the input shown in FIG. 6G, option 620 ceases to be displayed, and option 624 is displayed in its place, as shown in FIG. 6H. In some embodiments, option 624, shown in FIG. 6H, includes a visual indication of a compass including a textual description of the cardinal direction that device 500 is facing. For example, while the device 500 is facing northeast, option 624 includes “NE”. If the device 500 is facing west, option 624 includes “W”. In some embodiments, the visual indication of the compass also includes a representation of north and/or other cardinal directions (e.g., south, east, and/or west). For example, as shown in FIG. 6H, the representation of north is pointed towards north, which is to the left of NE. In some embodiments, the electronic device 500 animates the option 624 to rotate the visual indication of the compass, such as in response to a rotation of the device 500 in the direction of arrow 626. In some embodiments, while displaying the user interface 612 in compass mode, the electronic device displays the map with an orientation that corresponds to the orientation of the electronic device in the physical area shown on the map. For example, if the device is facing northeast of north, displaying the user interface 612 in compass mode includes orienting the map so that the northeast direction is facing up on the map, as shown in FIG. 6H. While displaying the user interface 612 in compass mode, indication 618 is pointed up because up is northeast in FIG. 6H, for example. In some embodiments, as the device 500 rotates in the direction of arrow 626, the map on user interface 612 also rotates in the same direction. For example, if device 500 is rotating towards cardinal east, then the map on user interface 612 is rotated to orient the map with the direction that device 500 is facing being at the top of the user interface 612, as described further in method 700.

FIG. 6I shows the electronic device 500 displaying the user interface in compass mode after rotating as shown in FIG. 6H. In FIG. 6I, the electronic device 500 is oriented facing northwest. In some embodiments, in response to the rotation of the device 500 clockwise as shown in FIG. 6H, device 500 updates user interface 612, as shown in FIG. 6I including option 624. In some embodiments, the map displayed in user interface 612 is orientated such that northwest is facing up in FIG. 6I. In some embodiments, indication 618, which is a visual indication of the direction the device 500 is facing, is pointed up in the map while displaying the user interface 612 in the compass mode. As shown in FIG. 6I, option 624 includes the visual indication of the compass with an indication of north pointed to the right (while facing northwest, north is to the right). Additionally, option 624 includes a textual description, “NW”, indicating that the device 500 is facing northwest. In some embodiments, indication 608 and 610b continue to be displayed while the device detects rotation and updates the user interface 612 in response to detecting the rotation.

In some embodiments, while displaying the user interface 612 in the compass mode, device 500 receives a swipe input from contact 627 to pan the map on user interface 612, as shown in FIG. 6I. In some embodiments, panning on the user interface 612 reveals additional portions of the map. In response to receiving the input shown in FIG. 6I, the device 500 updates the portion of the map included in user interface 612 in accordance with the panning input, as shown in FIG. 6J. For example, the electronic device 500 displays a map of a physical area such that the indication 601 of the current location of the electronic device 500 is not in the center of the map. In some embodiments, in response to the panning input, the user interface 612 remains in compass mode, with the direction that the device is facing oriented up. In some embodiments, in response to receiving the panning input, the indication 608 and 610b are no longer displayed, as described with reference to method 700, and as shown in FIG. 6J. For example, the electronic device 500 ceases displaying indications 608 and 610b because the indication 601 of the current location of the electronic device 500 is no longer displayed in the center of the map.

In some embodiments, while displaying the portion of the map shown in FIG. 6J in which the indication 601 of the current location of the electronic device 500 is not displayed in the center of the map, the device 500 receives a selection input including contact 628 directed towards indication 624. In response to the input shown in FIG. 6J, device 500 ceases displaying the user interface 612 in the compass mode and resumes the display of the map with the predetermined orientation (e.g., north facing up). In some embodiments, in response to the selection input, the map remains panned, and continues to display the same portions of the map as in FIG. 6J, as shown in FIG. 6K. In some embodiments, while displaying the map with the predetermined orientation, indication 618 continues to point northwest (the direction the device 500 is facing), though the orientation of indication 618 is not facing up if the electronic device 500 is not facing north. In some embodiments, in response to the input shown in FIG. 6J, indication 624 ceases to be displayed and indication 620 is displayed in its place, as shown in FIG. 6K. In some embodiments, indication 620 indicates that the map is currently displayed with the predetermined orientation. In some embodiments, while displaying the user interface 612 including the map with the predetermined orientation (e.g., north facing up) while the indication 601 of the current location of the electronic device 500 is not in the center of the map, the electronic device 500 continues to forgo display of indications 608 and 610b.

In some embodiments, the device 500 receives a selection input including contact 630 directed towards the indication 620, as shown in FIG. 6K. In response to the selection input in FIG. 6K, the device 500 redisplays the map with the indication 601 of the current location of device 500 in the center of the user interface 612, as shown in FIG. 6L. In some embodiments, while the indication 610 of the current location of the device 500 is in the center of the user interface 612, indication 608 and 610b are redisplayed around the indication 601.

FIG. 7 is a flow diagram illustrating a method in which an electronic device displays a visual indication of a walking radius while in the maps application. The method 700 is optionally performed at first and/or electronic devices such as device 100, device 300, or device 500 as described above with reference to FIGS. 1A-1B, 2-3, 4A-4B and 5A-5C. Some operations in method 700 are, optionally combined and/or order of some operations is, optionally, changed.

In some embodiments, method 700 is performed at an electronic device in communication with a display generation component. For example, a mobile device (e.g., a tablet, a smartphone, a media player, or a wearable device) including wireless communication circuitry, optionally in communication with one or more of a mouse (e.g., external), trackpad (optionally integrated or external), touchpad (optionally integrated or external), remote control device (e.g., external), another mobile device (e.g., separate from the electronic device), a handheld device (e.g., external), and/or a controller (e.g., external), etc.). In some embodiments, the display generation component is a display integrated with the electronic device (optionally a touch screen display), external display such as a monitor, projector, television, or a hardware component (optionally integrated or external) for projecting a user interface or causing a user interface to be visible to one or more users, etc. In some embodiments, method 700 is performed at or by an automobile (e.g., at an infotainment system of an automobile having or in communication with one or more display generation components and/or input devices).

In some embodiments, the electronic device (e.g., electronic device 500 in FIG. 6A) displays (702a), via the display generation component, a map of a physical area, such as user interface 600 in FIG. 6A or user interface 612 in FIG. 6B, (e.g., a hiking area, a park, or an area of a city), the map including an indication of a current location of the electronic device, such as indication 601 in FIG. 6A, (e.g., a dot that indicates a single location on the map at which the electronic device is determined to be located), an indication of a radius around the current location of the electronic device, such as indication 608 in FIG. 6A, (e.g., a circle or other shape surrounding the indication of the current location), and a visual indication indicating a distance from the current location of the electronic device to the radius, such as indication 610a in FIG. 6A or indication 610b in FIG. 6B. In some embodiments, the current location of the electronic device is determined using a GPS component of the electronic device. In some embodiments, based on the number of satellites the GPS component is able to lock onto, the electronic device is able to determine the location of the electronic device to a particular accuracy level (e.g., more satellites results in a higher accuracy level and fewer satellites results in a lower accuracy level). In some embodiments, the electronic device is in communication with a cellular provider and is able to determine, using data from the cellular provider, the location of the electronic device (e.g., based on the cell tower(s) with which the electronic device is in communication). In some embodiments, the electronic device is able to determine its location based on other mechanisms. In some embodiments, the map includes indications of roads, buildings, points of interest, landmarks, natural landforms (e.g., bodies of water, mountains, or canyons) at locations corresponding to the locations of those features in a physical area represented by the map. In some embodiments, the indication of the radius around the current location remains constant as the scale of the map changes. For example, the circle with the radius surrounding the indication of the current location remains constant as the scale of the map changes. Alternatively, in some embodiments, the displayed size of the indication of the radius around the current location changes as a function of the zoom level of the map. In some embodiments, the indication of the current location of the electronic device is displayed at the center of the circle. In some embodiments, if the map does not include the current location of the electronic device, the electronic device forgoes displaying the indication of the radius.

In some embodiments, in accordance with a determination that the map is displayed at a first zoom level, the visual indication is a first visual indication that indicates a first distance (702b), such as indication 610b in FIG. 6B. In some embodiments, the first distance is the distance from the current location of the electronic device to the radius (e.g., physical locations corresponding to the displayed location of the circle on the map) as a function of the first zoom level. For example, if the first zoom level includes a scale where 3 cm represents 150 m and the distance from the indication of the current location of the electronic device to the indication of the radius (e.g., the radius of the circle) is 6 cm as displayed by the display generation component, then the first visual indication is 300 m. In some embodiments, the first visual indication is a first time, which indicates a time from the current location of the electronic device to the radius, which is estimated using an average walking speed (e.g., 1 km/hr, 5 km/hr, or 8 km/hr) or average speed rolling in a wheelchair, as described in more detail below. Following the previous example, the first number would be 4 minutes if using an average walking speed of 5 km/hr.

In some embodiments, in accordance with a determination that the map is displayed with a second zoom level different from the first zoom level, the visual indication is a second visual indication that indicates a second distance different from the first distance (702c), such as indication 610b in FIG. 6C. In some embodiments, the electronic device adjusts the zoom level of the map to the second zoom level in response to receiving a user input requesting to zoom in or zoom out in the map, as described in more detail below. In some embodiments, the first zoom level is adjusted to the second zoom level in response to receiving an input provided with a hardware input device, such as a dial or crown integrated with the electronic device. For example, in response to an input requesting to zoom out, the electronic device adjusts the map to the second zoom level that uses a scale is of 3 cm representing 300 m. The adjustment of the scale optionally causes the first distance to change to the second distance. Similar to the first visual indication, the second visual indication optionally represents a time it takes a user of the electronic device to travel from the current location to the indication of the radius and/or a distance from the current location of the electronic device to the radius. In some embodiments, while displaying the map with the second zoom level, the electronic device displays the indication of the radius at the same size on the display generation component at which the indication of the radius was displayed while the electronic device displayed the map at the first zoom level. In some embodiments, the electronic device displays the indication of the radius at different sizes on the display generation component when displaying the map with the first zoom level and displaying the map with the second zoom level. Displaying a map including a current location of the electronic device, an indication of a radius, and a number representing a distance from the current location of the electronic device to the radius provides quick and efficient access to relevant content without the need for additional inputs and thereby reducing erroneous inputs to the electronic device to determine travel distance or travel time.

In some embodiments, while displaying the map of the physical area including the indication of the current location of the electronic device, the indication of the radius around the current location of the electronic device, and the visual indication indicating the distance from the current location of the electronic device to the radius, (e.g., as discussed above) the electronic device displays a visual indication of a location of a point of interest on the map without displaying a visual indication of a location of a transit line on the map, such as if indication 615a in FIG. 6B was displayed without indication 614 being displayed. In some embodiments, the visual indication of a location of a point of interest includes an icon representing the point of interest. For example, if the point of interest is a hotel, the visual indication includes an icon of a house. In some embodiments, points of interest include trails, trailheads, hotels, gas stations, restaurants, grocery stores, and bars. In some embodiments, the visual indication of the location of the point of interest also the name of the point of interest. For example, the visual indication includes the name of the restaurant, the name of the trail head, etc. In some embodiments, the visual indication of the point of interest is displayed at a location on the map corresponding to the location of the point of interest in physical space. In some embodiments, the indication of the point of interest is selectable. For example, in response to detecting selection of the indication of the point of interest, the electronic device displays a user interface element including information about the point of interest, including hours of operation, an address, a description of the point of interest, and/or photos. In some embodiments, the electronic device displays the indication of the location of the point of interest without displaying the visual indication of the location of the transit line while displaying the map in a first mode associated with points of interest. In some embodiments, the visual indication of the location of the transit line indicates the route traveled by public transportation, including indications of one or more stops along the route and/or an indication of the name or number of the route. In some embodiments, the visual indication of the location of the point of interest is overlayed on top of the indication of the radius and the visual indication indicating the distance from the current location of the electronic device to the radius on the map. Alternatively, in some embodiments, the visual indication of the location of the point of interest may be shown underneath the indication of the radius and the visual indication indicating the distance from the current location of the electronic device to the radius on the map.

In some embodiments, while displaying the map with a visual indication of a location of a transit line without displaying the visual indication of the location of the point of interest, the electronic device displays the indication of the current location of the electronic device, the indication of the radius around the current location of the electronic device, and the visual indication indicating the distance from the current location of the electronic device to the radius on the map, such as if indication 614 in FIG. 6B was displayed without indication 615a being displayed. In some embodiments, and as discussed above, the visual indication of the location of the transit line indicates the route traveled by public transportation, including indications of one or more stops along the route and/or an indication of the name or number of the route. In some embodiments, the electronic device receives an input corresponding to a request to display the visual indication of the location of the transit line and in response to the input, the visual indication of the location of the point of interest stops displaying, while the other indications continue to be displayed. In some embodiments, the visual indication of the location of the transit line is selectable. For example, in response to detecting selection of the visual indication of the location of the transit line, the electronic device displays a user interface element including information about the transit line, including hours of operation, the stops along the route, the name/number of the transit line, and/or photos. In some embodiments, the indication of the current location of the electronic device, the indication of the radius around the current location of the electronic device, and the visual indication indicating the distance from the current location of the electronic device to the radius on the map is displayed in different modes of the map. Displaying a map including a current location of the electronic device, an indication of a radius, and a number representing a distance from the current location of the electronic device to the radius while in different modes provides quick and efficient access to relevant content without the need for additional inputs and thereby reducing erroneous inputs to the electronic device to determine travel distance or travel time.

In some embodiments, while displaying the map at the first zoom level including the indication of the current location of the electronic device, the indication of the radius around the current location of the electronic device, and the visual indication indicating the distance from the current location of the electronic device to the radius, the electronic device receives, via the one or more input devices, an input corresponding to a request to adjust the zoom level, such as an input from user 618a onto the crown 616 in FIG. 6B. (e.g., zooming in or zooming out). In some embodiments, the input is a gesture including touching a touch-sensitive display with two contacts (e.g., the index finger and thumb of a hand) and then spreading or pinching the contacts. In some embodiments, pinching the contacts decreases the zoom level (e.g., zooming out). In some embodiments, spreading the contacts increases the zoom level (e.g., zooming in). In some embodiments, the input is detected using a hardware device communicatively connected to the electronic device. For example, twisting of a crown or dial.

In some embodiments, in response to receiving the input, and in accordance with a determination that the input satisfies one or more criteria (e.g., a criterion that the two contacts are within a threshold distance of each other, a criterion that the zoom level is within a predefined threshold), in accordance with a determination that the input corresponds to a request to adjust the zoom level to the second zoom level, the electronic device displays the map at the second zoom level, wherein the visual indication is the second visual indication that indicates the second distance, such as shown by indication 610b and the second zoom level in FIG. 6C. In some embodiments, the threshold distance is 0.1 cm, 0.1 cm, or 1 cm. In some embodiments, displaying the map at the second zoom level includes enlarging portions of the map and/or adding more details or reducing the size of portions of the map and/or removing details. In some embodiments, the second zoom level is at a magnification greater than the first zoom level. In some embodiments, the second zoom level is at a magnification less than the first zoom level. In some embodiments, the size of the indication of the radius around the current location of the electronic device remains the same before and after receiving the input. For example, the distance between the radius and the current location remains the same (e.g., at 3 cm). In some embodiments, the second distance is determined using the scale of the map at the second zoom level, as discussed in above. For example, at the first zoom level 3 cm represents 150 m, the first distance. At the second zoom level, for example, 3 cm represents 75 m, and therefore the second distance is 75 m. Alternatively, in some embodiments, the indication of the radius around the current location adjusts with the zoom level of the map. For example, at the first zoom level, where 3 cm represents 150 m, the distance between the radius and the current location is 3 cm and the first visual indication is 150 m. At the second zoom level, where 3 cm represents 75 m, the distance between the radius and the current location is 6 cm, and the indication is 150 m.

In some embodiments, in accordance with a determination that the input corresponds to a request to adjust the zoom level to a third zoom level different from the second zoom level, such the input provided by user 618a directed to the crown 616 in FIG. 6C, the electronic device displays the map at the third zoom level, wherein the visual indication is a third visual indication that indicates a third distance different from the second distance, such as if FIG. 6D included indication 610b with a third distance. In some embodiments, displaying the map at the third zoom level includes enlarging portions of the map and/or adding more details or reducing the size of portions of the map and/or removing details. In some embodiments, the third zoom level is at a magnification greater than the first zoom level and/or the second zoom level. In some embodiments, the third zoom level is at a magnification less than the first zoom level and/or the second zoom level. In some embodiments, the third distance is determined using the scale of the map at the third zoom level, as discussed in above. In some embodiments, the second distance is determined using the scale of the map at the second zoom level, as discussed above. In some embodiments, the distance between the radius and the current location scales with the zoom level, as discussed above. In some embodiments, while displaying the map at the third zoom level, the distance between the visual indication of the radius is the same distance from the indication of the current location of the electronic device as the distance between the visual indication of the radius and the visual indication of the current location while displaying the map at the first zoom level. In some embodiments, adjusting the zoom level changes the scale of the map, therefore changing the distance from the current location of the electronic device to the radius. Adjusting the visual indication of the distance between the indication of the current location and the radius provides quick and efficient access to relevant content without the need for additional inputs and thereby reducing erroneous inputs to the electronic device to determine travel distance or travel time.

In some embodiments, in response to receiving the input (e.g., as discussed above), in accordance with a determination that the input fails to satisfy the one or more criteria, including a criterion that is satisfied when the zoom level is within a predefined threshold, the electronic device displays the map at a fourth zoom level different from the first, second, or third zoom level without displaying the visual indication of the radius and without displaying the visual indication indicating the distance from the current location of the electronic device to the radius, such as shown by the zoom level and lack of indication 608 and indication 610b in FIG. 6D. In some embodiments, the predefined threshold is when the distance between the radius and the current location is between 5 minutes and 60 minutes of walking or rolling in a wheelchair, 400 m to 5000 m, or 400 m to 1000 m. For example, if the zoom level is such that the distance between the radius and the current location is less than 5 minutes of walking or rolling in a wheelchair or 400 m, or greater than 60 minutes of walking or rolling in a wheelchair, 5000 m, or 1000 m, then the threshold is not met. In some embodiments, displaying the map at the fourth zoom level includes enlarging portions of the map and/or adding more details or reducing the size of portions of the map and/or removing details. In some embodiments, a visual indication of a location of a point of interest continues to be displayed as described above. In some embodiments, the visual indication of a location of a point of interest includes an icon but optionally does not include the name of the point of interest. In some embodiments, the fourth zoom level is outside the predefined threshold. In some embodiments, the visual indication of the radius and the visual indication indicating the distance from the current location of the electronic device to the radius is not displayed when the map is at a fourth zoom level. Displaying the map at a zoom level outside the predefined threshold without the visual indication of the radius and the visual indication indicating the distance from the current location of the electronic device to the radius allows for efficient access to the map at the fourth zoom level thereby reducing the risk of spatial conflicts between the visual indications and the map.

In some embodiments, the visual indication indicating the distance from the current location of the electronic device to the radius indicates distance in units of length, such as indication 610b in FIG. 6B, or in units of time including an estimation of time to travel from the current location of the electronic device to the radius, such as indication 610a in FIG. 6A. In some embodiments, and as discussed above, the units of time assume an average walking speed of 1 km/hr, 3 km/hr, or 8 km/hr. In some embodiments, the estimation of the time to travel from the current location of the electronic device to the radius is determined using the average walking speed and the distance between the current location and the radius. In some embodiments, the distance between the current location and the radius is based on the shortest path to the radius (e.g., as the crow flies) or based on an average path to the radius (e.g., on roads). In some embodiments, a setting of the electronic device changes the visual indication from displaying distance units or time units. In some embodiments, both units of length and units of time are displayed on the visual indication depending on the setting of the electronic device. Displaying the visual indication in units of distance or in units of time provides quick and efficient access to relevant content without the need for additional inputs and thereby reducing erroneous inputs to the electronic device to determine travel distance or travel time.

In some embodiments, the visual indication indicating the distance from the current location of the electronic device to the radius indicates distance in units of time including an estimation of time to travel from the current location of the electronic device to the radius, such as indication 610a shown in FIG. 6A. In some embodiments, the distance in units of time includes minutes or hours.

In some embodiments, in accordance with a determination that a user of the electronic device is a wheelchair user (e.g., the user of the electronic device has activated a wheelchair setting in the electronic device or in a map application), the estimation of time to travel from the current location of the electronic device to the radius is an estimation of time to travel from the current location of the electronic device to the radius by rolling in a wheelchair, such as if indication 610a includes an estimated of time to travel by rolling in a wheelchair. In some embodiments, the estimating the time to travel from the current location to the radius includes using an average rolling speed of a person in a wheelchair. In some embodiments, the estimation of time includes determining obstacles in the path of the wheelchair user (e.g., stairs or hills).

In some embodiments, in accordance with a determination that the user of the electronic device is not a wheelchair user, the estimation of time to travel from the current location of the electronic device to the radius is an estimation of time to travel from the current location of the electronic device to the radius by walking, such as if indication 610a includes an estimated of time to travel by walking. As discussed above, estimating the time to travel includes using the average speed of a person. In some embodiments, the estimation of time to travel from the current location of the electronic device to the radius is based on the mode of travel of a user of the electronic device (e.g., wheelchair or walking). Displaying the visual indication in units of time including the estimation of time to travel by rolling in a wheelchair provides quick and efficient access to relevant content without the need for additional inputs and thereby reducing erroneous inputs to the electronic device to determine travel distance or travel time.

In some embodiments, while displaying the map including the indication of the current location of the electronic device, the indication of the radius around the current location of the electronic device, and the visual indication indicating the distance from the current location of the electronic device to the radius, the electronic device displays, on the map, a first visual indication of a first location on the map, wherein the first visual indication is not selectable and the indication of the radius and the indication indicating the distance from the current location of the electronic device to the radius are displayed overlaid on the first visual indication, such as indication 606a in FIG. 6A. For example, the first visual indication includes visual representation of streets, highways, and map features (e.g., oceans and mountains). In some embodiments, the first visual indication includes image(s), symbol(s), and/or text. In some embodiments, an input directed to the first visual indication does not result in a display of additional information. In some embodiments, the indication of the radius and the indication indicating the distance from the current location of the electronic device to the radius are displayed on top of the first visual indication. For example, a circle representing the indication of the radius optionally “cuts through” the first visual indication.

in some embodiments, the electronic device displays, on the map, a second visual indication of a second location on the map, wherein the second visual indication is selectable, and the second visual indication is displayed overlaid on the indication of the radius and the indication indicating the distance from the current location of the electronic device to the radius, such as indication 615a in FIG. 6B. For example, the second visual indication includes visual representations of restaurants, trails, trailheads, hotels, gas stations, city names, and other points of interest. In some embodiments, the second visual indication continues to be selectable while being displayed on top of the indication of the radius and the indication indicating the distance from the current location of the electronic device to the radius. In some embodiments, in response to detecting an input selecting the second visual indication, the electronic device displays a user interface element including information about the second location, as described above. In some embodiments, selectable options are displayed over the indication of the radius and the indication indicating the distance from the current location of the electronic device to the radius, wherein non-selectable options are displayed below the aforementioned indications. Displaying selectable visual indications over the indication of the radius and the indication indicating the distance from the current location of the electronic device to the radius makes it easier for the user to enter inputs directed to the selectable visual indications thereby reducing erroneous inputs to the electronic device to select selectable options.

In some embodiments, while displaying the map including the indication of the current location of the electronic device, the indication of the radius around the current location of the electronic device, and the visual indication indicating the distance from the current location of the electronic device to the radius, in accordance with a determination that the current location of the electronic device is in a predefined physical area (e.g., a national park, city park, national forest, and/or other hiking areas), such as shown by user interface 600 in FIG. 6A, the electronic device displays, on the map, via the display generation component, visual indications of topography of the physical area, such as indication 606a and 606b in FIG. 6A (e.g., indications of elevation gain and elevation loss), visual indications of trail junctions in the physical area, such as indications 602a and 602b in FIG. 6A (e.g., with a dot at each junction), and visual indications indicating distances between the trail junctions, such as indication 604 in FIG. 6A (e.g., in miles, feet, kilometers, or meters). In some embodiments, a hiking area is a nature area with trails such as predefined paths.

in some embodiments, in accordance with a determination that the current location of the electronic device is not in the predefined physical area, the electronic device forgoes displaying, on the map, the visual indications of the topography of the physical area, the visual indications of the trail junctions in the physical area, and the visual indications indicating distances between the trail junctions, such as in user interface 612 shown in FIG. 6B. For example, while the electronic device is in a non-hiking area (e.g., city, ocean, or other areas without trails), the visual indications of the topography, trail junctions, and distances between trail junctions are not displayed. Alternatively, in locations not in the predefined physical area, the visual indications of the topography of the physical area are displayed. In some embodiments, the predefined physical area includes a different visual appearance than other areas. For example, the predefined physical area is colored differently (e.g., shaded green). In some embodiments, the map includes visual indications of topography, trail junctions, and distances between trail junctions in a predefined area. Displaying topography, trail junctions, and distances between trail junctions provides quick and efficient access to relevant content without the need for additional inputs and thereby reducing the number of inputs to the electronic device to determine elevation and distances, which saves time and power consumption.

In some embodiments, while displaying the map including the indication of the current location of the electronic device, the indication of the radius around the current location of the electronic device, and the visual indication indicating the distance from the current location of the electronic device to the radius, the electronic device receives, via the one or more input devices, an input corresponding to a request to pan the map to a second physical area, such as with contact 627 in FIG. 6I. In some embodiments, the input includes a tap and swipe gesture, such as a tap on a touch-sensitive display (e.g., with an index finger of a hand) and then a movement of the contact, while still touching the touch-sensitive display. In some embodiments, the input includes an air-gesture of an air-pinch (e.g., using an index finger and thumb) and an air-drag (e.g., while still in the air-pinch gesture, dragging the hand to a different location).

In some embodiments, in response to receiving the input, the electronic device pans the map to the second physical area, such as shown the movement on the map between FIG. 6I and FIG. 6J. In some embodiments, the second physical area is another area on a map. For example, the second physical area is optionally a pre-defined physical area, discussed above, or a portion of a city/state. In some embodiments, the second physical area includes overlap with the physical area. For example, the physical area shows the West Rim trail in Zion National park, and in response to the input, the West Rim trail continues to be displayed in a different location on the electronic device, while other portions of Zion National Park and surrounding regions, not displayed in the map including the physical area, are shown in the map including the second physical area. In some embodiments, the indication of the current location ceases to be displayed in second physical area. Alternatively, the indication of the current location is displayed at a different displayed location while displaying the second physical area than the displayed location while displaying the first physical area. In some embodiments, the spatial relationship between the first and second physical areas corresponds to the distance and/or magnitude of the input. For example, in response to an input panning in a first direction, the second physical area is adjacent to the first physical area in the first direction. As another example, in response to an input panning in a second direction different from the first direction, the second physical area is adjacent to the first physical area in the second direction. For example, in response to an input including a first amount of movement (e.g., speed, distance, or duration), the second physical area is a distance from the first physical location by an amount corresponding to the first amount of movement. For example, in response to an input including a second amount of movement (e.g., speed, distance, or duration) different from the first amount of movement, the second physical area is a distance from the first physical location by an amount corresponding to the second amount of movement.

In some embodiments, the electronic device ceases to display the indication of the radius around the current location of the electronic device and the visual indication indicating the distance from the current location of the electronic device to the radius, such as shown by the lack of indication 608 and indication 610b in FIG. 6J. In some embodiments, ceasing the display of the indication of the radius and the visual indication of the distance from the current location of the electronic device to the radius does not include ceasing the display of the second physical area. Ceasing the display of the indication of the radius and the visual indication of the distance from the current location of the electronic device optionally includes a fade-out effect. In some embodiments, the indication of the radius around the current location of the electronic device and the visual indication indicating the distance from the current location of the electronic device to the radius stops displaying when a user of the electronic device pans the map. In some embodiments, in response to an input directed towards redisplaying the map with a predetermined orientation based on the cardinal direction, as described below, the map is re-oriented with the current location of the electronic device in the center and the indication of the radius around the current location redisplayed. Ceasing the display of the indication of the radius when panning the map allows for efficient access to the map thereby reducing the risk of spatial conflicts between the indications and the map.

In some embodiments, while displaying the map of the physical area with a predetermined orientation based on cardinal directions relative to the physical area with the visual indication of the current location of the electronic device not displayed in a center of the map, such indication 601 in FIG. 6K, the electronic device receives, via the one or more input devices, a first input directed to a selectable option, such as with contact 630 shown in FIG. 6K. In some embodiments, the visual indication of the current location of the electronic device is displayed at a location other than the center of the map. In some embodiments, the indication of the current location of the electronic device is not displayed. For example, the portion of the map being displayed does not include the current location of the electronic device. In some embodiments, the predetermined orientation of the map of the physical area includes showing north as pointing towards the top of the map. In some embodiments, the first input directed to the selectable option is a selection input. The selection input optionally includes tapping on a touch-sensitive displaying (e.g., using a finger). In some embodiments, the selection input includes pressing on a hardware input device (e.g., a crown or a dial) like a button. As described above, in some embodiments, while the indication of the current location of the electronic device is not displayed in the center of the map, the electronic device forgoes displaying the indication of the radius and the indication of the distance between the current location and the radius.

In some embodiments, in response to receiving the first input, the electronic device displays the map of the physical area with the predetermined orientation based on the cardinal directions relative to the physical area with the visual indication of the current location of the electronic device displayed in the center of the map, such as indication 601 shown in FIG. 6L. In some embodiments, the zoom level of the map remains the same. In some embodiments, the predetermined orientation includes pointing north towards the top of the map. In some embodiments, west, east, or south is pointed towards the top of the map. In some embodiments, the orientation of the electronic device does not affect the orientation of the map while displaying the map of the physical area with the predetermined orientation based on the cardinal directions.

In some embodiments, while displaying the map of the physical area with the predetermined orientation based on the cardinal directions relative to the physical area with the visual indication of the current location of the electronic device displayed in the center of the map, such as indication 601 in FIG. 6G, the electronic device receives, via the one or more input devices, a second input directed to the selectable option, such as with contact 622 in FIG. 6G. In some embodiments, the second input has one or more of the characteristics of the first input.

In some embodiments, in response to receiving the second input, the electronic device displays the map of the physical area with an orientation based on an orientation of the electronic device relative to the physical area, such as shown in FIG. 6H (e.g., based on the orientation of the top of the electronic device). In some embodiments, the map of the physical area changes orientation based on the orientation of the electronic device relative to the physical area. In some embodiments, while displaying the map of the physical area with the orientation based on the orientation of the electronic device relative to the physical area and while the electronic device has a first orientation, the electronic device displays the map with an orientation corresponding to the first orientation and while displaying the map of the physical area with the orientation based on the orientation of the electronic device relative to the physical area and while the electronic device has a second orientation different from the first orientation, the electronic device displays the map with an orientation corresponding to the second orientation. For example, if the electronic device is rotated such that it is pointed northwest, the orientation of the map is also changed such that northwest is at the top of the map. In some embodiments, the map is displayed with a predetermined orientation where north is up and in response to an input, the map is displayed with an orientation based on the current orientation of the electronic device. Displaying the map of the physical area with an orientation based on an orientation of the electronic device relative to the physical area provides visual feedback on the direction the electronic device is facing which reduces the time and inputs needed for the user to see relevant information.

In some embodiments, while displaying the map of the physical area with the orientation based on the orientation of the electronic device relative to the physical area, the electronic device receives, via the one or more input devices, an input corresponding to a request to pan the map to a second physical area, such as with contact 627 in FIG. 6I. In some embodiments, the input has one or more characteristics corresponding to the input to pan the map described above, and the second physical area has one or more characteristics corresponding to the second physical area displayed in response to the input to pan the map described above.

In some embodiments, in response to receiving the input, the electronic device pans the map to the second physical area while maintaining the orientation of the map based on the orientation of the electronic device relative to the physical area, such as shown in FIG. 6J. In some embodiments, the orientation of the map simultaneously changes based on the orientation of the electronic device relative to the physical area while the electronic device pans the map. In some embodiments, the map of the physical area includes visual indications that are selectable or non-selectable, as described above. The selectable visual indications optionally change orientations such that they are facing upward (e.g., labels are orientated such that they are right side up). In some embodiments, the non-selectable visual indication do not change orientation with the change in orientation of the electronic device. Alternatively, the non-selectable visual indications also change orientation with the changes in orientation of the electronic device. Maintaining the orientation of the map when panning the map allows for efficient access to the map thereby reducing time and inputs needed for the user to see relevant information at a particular orientation.

In some embodiments, while displaying the map of the physical area with the orientation based on the orientation of the electronic device relative to the physical area, the electronic device displays the selectable option with an indication of the cardinal directions that changes in accordance with the orientation of the electronic device relative to the physical area, such as indication 624 in FIG. 6H. For example, the selectable option is displayed with a compass that updates as the orientation of the electronic device changes while the electronic device displays the map with the orientation based on the orientation of the electronic device.

In some embodiments, while displaying the map of the physical area with the predetermined orientation based on the cardinal directions relative to the physical area, the electronic device displays the selectable option without the indication of the cardinal directions that changes in accordance with the orientation of the electronic device relative to the physical area, such as indication 620 in FIG. 6G. For example, the selectable option is not displayed with a compass indicating the orientation of the electronic device while the electronic device displays the map with the predetermined orientation. For example, while the electronic device displays the map with the predetermined orientation, the selectable option includes an image that does not change when the orientation of the electronic device changes. Displaying the selectable option with the indication of the cardinal directions provides feedback about orientation of the map, thereby reducing the number of inputs needed to retrieve additional information relating to the respective content and displaying more information without sacrificing additional display area.

In some embodiments, while displaying the map of the physical area with the orientation based on the orientation of the electronic device relative to the physical area and while displaying the selectable option with an indication of the cardinal directions that changes in accordance with the orientation of the electronic device relative to the physical area, the electronic device receives, via the one or more input devices, receiving a third input directed to the selectable option, such with contact 628 on indication 624 in FIG. 6J. In some embodiments, the third input is a selection input with one or more characteristics described above with reference to the input selecting the selectable option to orient the map based on the orientation of the electronic device.

In some embodiments, in response to receiving the third input, the electronic device displays the map of the physical area with the predetermined orientation based on the cardinal directions relative to the physical area, and displaying the selectable option without the indication of the cardinal directions that changes in accordance with the orientation of the electronic device relative to the physical area, such as indication 620 shown in FIG. 6J. In some embodiments, the selectable visual indications are also re-orientated. In some embodiments, the selectable option including the indication of the cardinal directions changes to the selectable option without the indication of the cardinal directions in response to the third input. In some embodiments, the map re-orients without re-centering on the indication of the current location of the electronic device. For example, the physical location corresponding to the center of the map does not change in response to receiving the third input. In some embodiments, the map re-centers on the indication of the current location of the electronic device while changing the orientation of the predetermined orientation in response to the third input. Displaying the selectable option without the indication of the cardinal directions while in the predetermined orientation provides feedback about orientation of the map, thereby reducing the number of inputs needed to retrieve additional information relating to the respective content.

It should be understood that the particular order in which the operations in FIG. 7 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 900, 1100, 1300) are also applicable in an analogous manner to method 700 described above with respect to FIG. 7. For example, the operation of the electronic device to display a visual indication of a walking radius in a maps application described above with reference to method 700 optionally has one or more of the characteristics of the presentation of information on a map, including indications of locations, the presentation of navigation directions in different formats while navigating using different modes of transportation, and the presentation of additional features while the current location of the electronic device is in a predetermined area described herein with reference to other methods described herein (e.g., methods 900, 1100, and 1300). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 7 are, optionally, implemented by components depicted in FIGS. 1A-1B. For example, displaying operation 702a is, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### User Interfaces for Displaying Information on Maps

Users interact with electronic devices in many different manners, including requesting information related to locations. In some embodiments, an electronic device concurrently displays indications of locations corresponding to a request for information on a map. The embodiments described below provide ways in which an electronic device facilitates interaction with maps including indications of locations. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

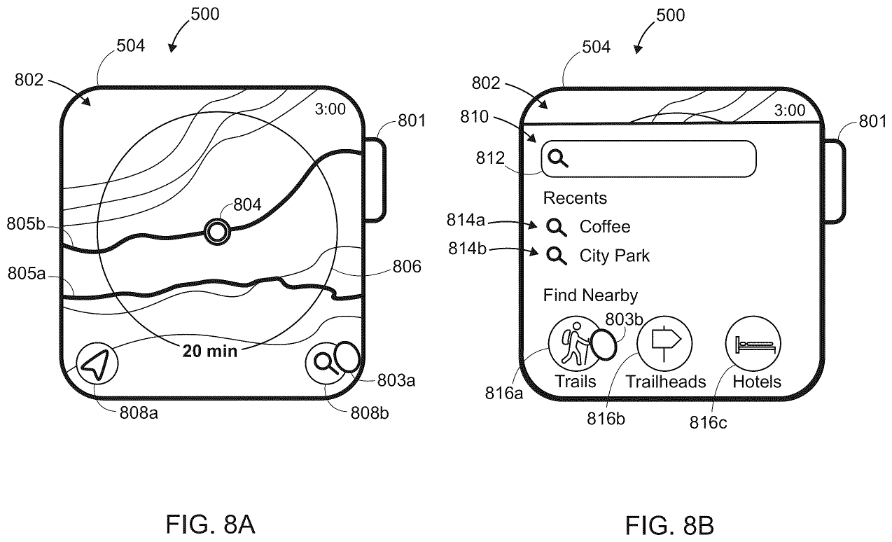

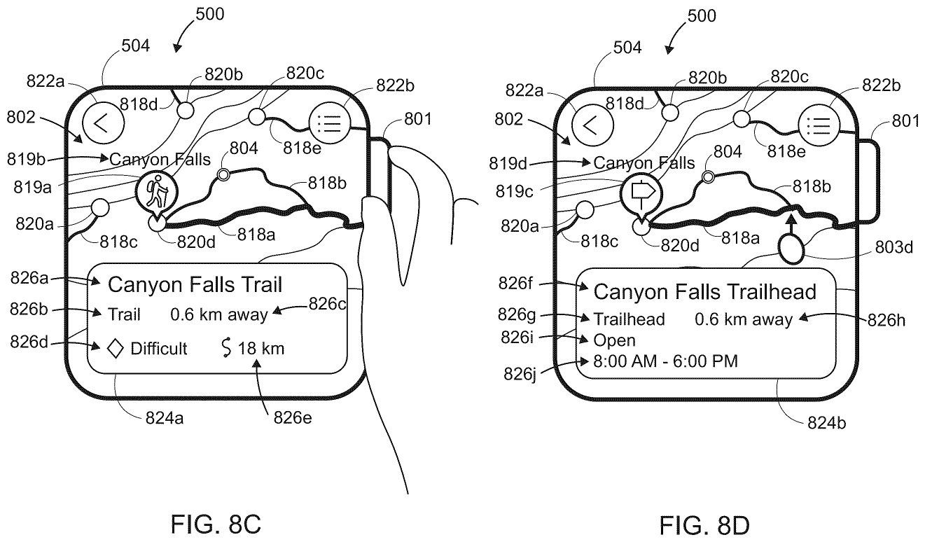

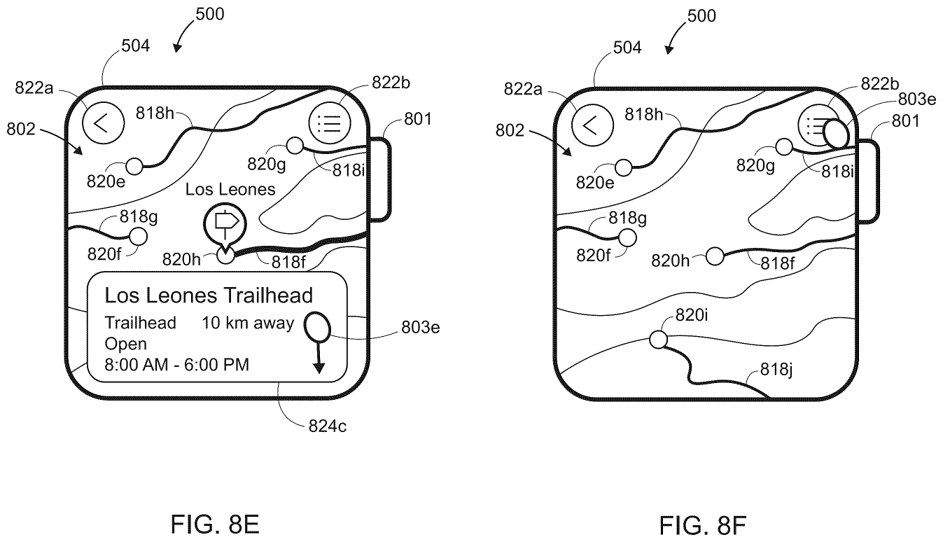

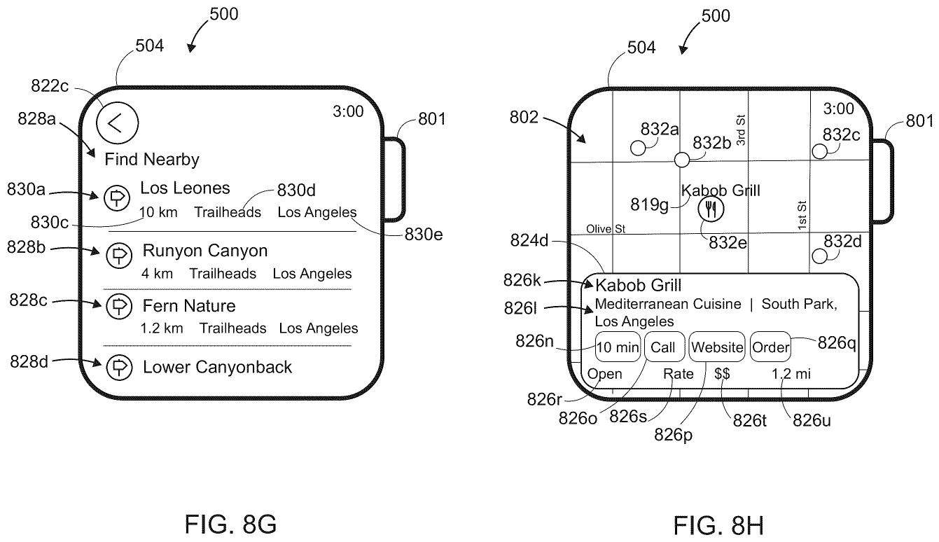

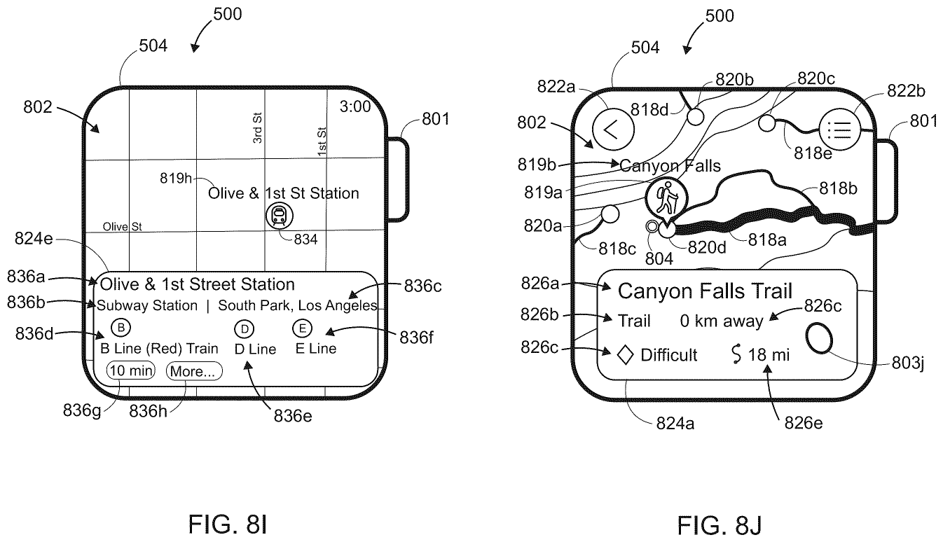

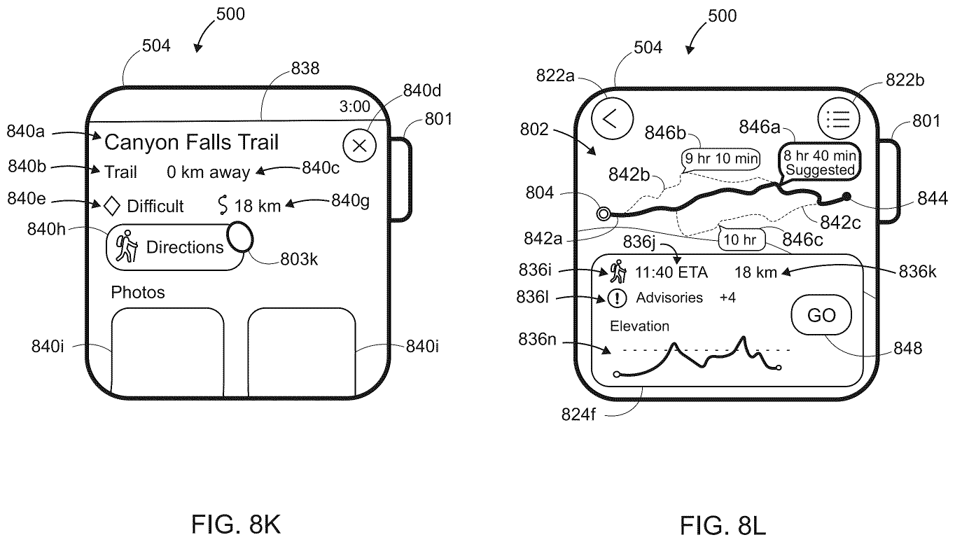

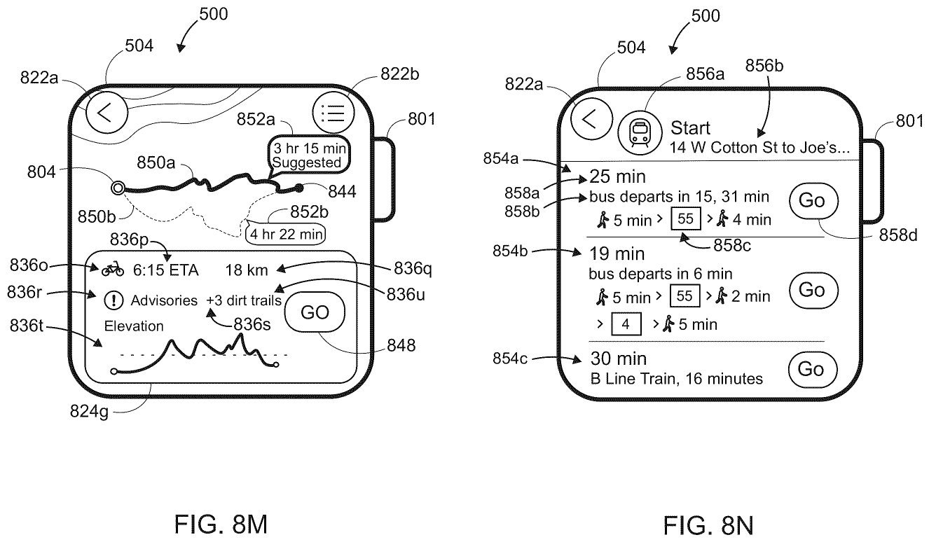

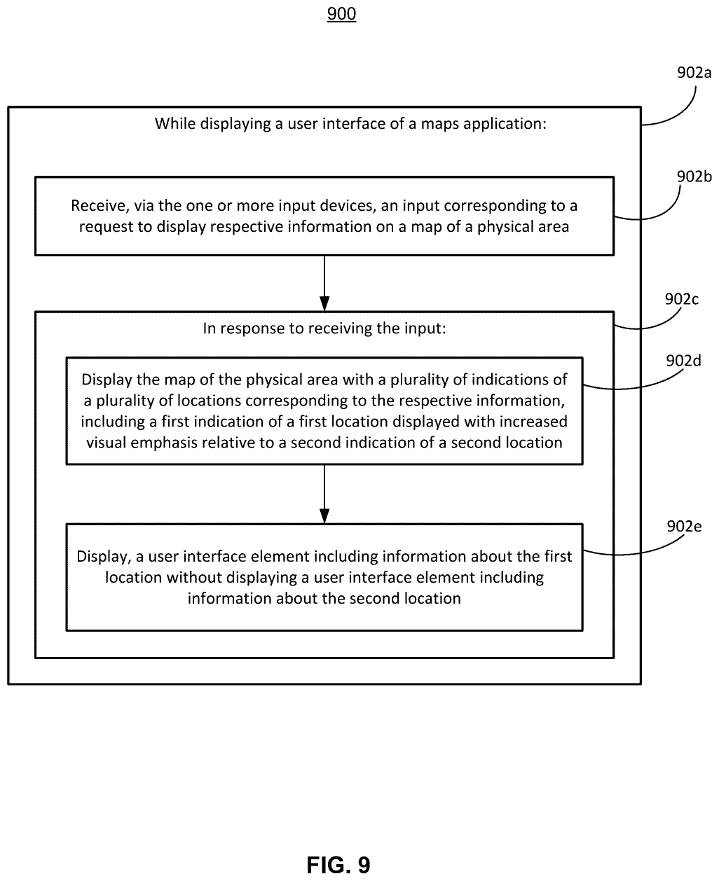

FIGS. 8A-8N illustrate exemplary ways in which an electronic device 500 displays information on a map, including indications of locations according to some embodiments of the disclosure. The embodiments in these figures are used to illustrate the processes described below, including the processes described with reference to FIG. 9. These figures are not meant to be limiting; other user interfaces are possible in accordance with method 900 without departing from the scope of the disclosure.

FIG. 8A illustrates electronic device 500 displaying user interface (e.g., via a display device, via a display generation component, or via a touch screen 504). In some embodiments, the user interface is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with device 500. In some embodiments, device 500 is a wearable device such as a smart watch. In some embodiments, the electronic device 500 includes a crown 801. The electronic device 500 can receive inputs directed to the crown 801, such as inputs that press the crown 801 like a button and inputs that turn the crown 801 like a dial.

As shown in FIG. 8A, in some embodiments, the electronic device 500 displays a map 802 of a physical area. For example, the map 802 is displayed in a user interface of a maps application. In some embodiments, the electronic device 500 displays the map 802 with an indication 804 of the current location of the electronic device 500 and an indication 806 of a radius around the indication 804 of the current location of the electronic device to indicate the scale of the map. For example, the indication 806 of the radius has one or more characteristics described above with reference to method 700. As shown in FIG. 8A, the map 802 further includes indications 805a and 805b of trails in the geographic area represented by the map 802. Although not shown in FIG. 8A, in some embodiments, the map 802 includes indications of points of interest and/or geographic features of the physical area represented by the map 802 according to method 700. As shown in FIG. 8A, the electronic device 500 displays selectable options 808a and 808b overlaid on the map 802 in the user interface, for example. In some embodiments, in response to detecting selection of option 808a, the electronic device 500 transitions to displaying the maps application user interface in the compass mode described above with reference to method 700. In some embodiments, in response to detecting selection of option 808b, the electronic device 500 displays a map searching user interface, as will be described in more detail below at least with reference to FIG. 8B.

As shown in FIG. 8A, the electronic device 500 receives an input selecting option 808b (e.g., with contact 803a). In response to the input in FIG. 8A, the electronic device 500 displays the map searching user interface 810 illustrated in FIG. 8B.

FIG. 8B illustrates an example of the electronic device 500 displaying the map searching user interface 810. In some embodiments, the electronic device 500 displays the user interface in FIG. 8B in response to the input illustrated in FIG. 8A. As shown in FIG. 8B, the map searching user interface 810 is displayed overlaid on the map 802, though in some embodiments, the electronic device 500 displays the map searching user interface 810 without displaying the map 802. In some embodiments, the map searching user interface 810 includes a text entry field 812, indications 814a and 814b of previous searches conducted using the electronic device 500, and selectable options 816a through 816c for searching for locations based on the type of location. In some embodiments, the electronic device 500 receives inputs directed to the text entry field 812 to define a search query. While the search query is displayed in the text entry field 812, the electronic device 500 can receive an input corresponding to a request to display results for the search query. In response to receiving the input, the electronic device 500 can display search results on a map in accordance with examples described herein. In some embodiments, in response to receiving an input selecting one of the indications 814a or 814b of previous searches, the electronic device 500 can display results corresponding to the selected indication on the map in accordance with examples described herein.

In some embodiments, in response to receiving an input selecting one of the options 816a through 816c, the electronic device 500 displays indications of locations corresponding to the selected option on the map in accordance with examples described herein. In some embodiments, options 816a through 816c are horizontally scrollable to reveal additional options corresponding to other types of locations. In some embodiments, as described in more detail below with reference to method 1300, the electronic device 500 changes the order of options 816a through 816c depending on the current location of the electronic device 500. For example, while the current location of the electronic device 500 is in a hiking area (e.g., a state or national park or other areas with hiking trails and/or trailheads), the electronic device 500 displays option 816a to search for trails and option 816b to search for trailheads before other options, as shown in FIG. 8B for example. In some embodiments, while the electronic device 500 is outside of the hiking area, the electronic device 500 displays different options other than options 816a and 816b first, as described in more detail below with reference to method 1300. As shown in FIG. 8B, the electronic device 500 receives an input selecting (e.g., with contact 803b) the option 816a to view indications of trails on the map. In response to receiving the input shown in FIG. 8B, the electronic device 500 displays indications of trails and trailheads on the map, as shown in FIG. 8C, in some embodiments. In some embodiments, in response to receiving the input shown in FIG. 8B, the electronic device 500 displays indications of trails on the map 802 without displaying indications of trailheads. In some embodiments, in response to receiving an input selecting option 816b, the electronic device 500 displays the map 802 with indications of trails and trailheads, as shown in FIG. 8C. In some embodiments, in response to receiving an input selecting option 816b, the electronic device 500 displays the map 802 with indications of trailheads without displaying indications of trails.

FIG. 8C illustrates an example of the electronic device 500 displaying indications 818a through 818e of trails and indications 820a through 820d of trailheads on the map 802 in response to the input illustrated in FIG. 8B. As shown in FIG. 8C, indication 818a of one of the trails is displayed with increased visual emphasis relative to indications 818b through 818e and 820a through 820d. For example, indication 818a is displayed with a thicker and/or darker line than indications 818b through 818e and includes an additional icon 819a and label 819b not included in indications 818b and 820a through 820d. For example, icon 819a includes an image of a person hiking, which indicates that indication 818a corresponds to a hiking trail and label 819b (“Canyon Falls”) indicates the name of the hiking trail. In some embodiments, the electronic device 500 also displays an option 822a that, when selected, causes the electronic device 500 to navigate back to the user interface shown in FIG. 8B and an option 822b to cease display of the map 802 and view indications of the search results in a “list” view similar to the user interface described below with reference to FIG. 8G.

As shown in FIG. 8C, the electronic device 500 displays a user interface element 824a including indications 826a through 826e of information about the trail corresponding to user interface element 824a overlaid on the map 802. In some embodiments, the electronic device does not display a user interface element similar to user interface element 824a including information about one of the other trails and/or trailheads and user interface element 824a does not include information about one of the other trails and/or trailheads. User interface element 824a optionally includes an indication 826a of the name of the location, an indication 826b that the location is a trail, an indication 826c of the distance between the current location of the electronic device and the closest access point to the trail, an indication 826d of the difficulty of the trail, and an indication 826e of the type and distance of the trail. For example, the icon included in indication 826e indicates that the trail is a point-to-point trail.

In some embodiments, in response to receiving an input directed to crown 801 of the electronic device 500, the electronic device 500 ceases display of user interface element 824a and updates indication 818a to be displayed without visual emphasis relative to other indications 818b and/or 820a through 320d and displays a user interface element similar to element 824a with information about a different location indicated on map 802 and updates the representation of that location to be displayed with visual emphasis relative to the other indications. For example, in FIG. 8C, while displaying indication 818a with increased visual emphasis relative to indications 818b and 820a through 820d and displaying user interface element 824a, the electronic device 500 receives an input directed to crown 801, such as detecting twisting of the crown 801. In response to the input in FIG. 8C, the electronic device 500 updates the user interface as shown in FIG. 8D.

FIG. 8D is an example of the electronic device 500 updating the user interface in response to the input illustrated in FIG. 8C. As shown in FIG. 8D, the electronic device 500 displays indication 820d with visual emphasis relative to indications 820a through 820d and 818a through 818e and displays user interface element 824b with indications 826f through 826j of information about the location corresponding to indication 820d. For example, indication 820d is displayed with icon 819c and label 819d, whereas the other indications 820a through 820c, 818a, and 818b do not include icons and labels. Icon 819c can include an image of a signpost, indicating that indication 820d corresponds to a trailhead and label 819d (“Canyon Falls”) can include the name of the trailhead. Additionally or alternatively, in some embodiments, indication 820d is displayed at a bigger size, different color, and/or less translucency than indications 820a through 820c as part of displaying indication 820d with increased visual emphasis.

As shown in FIG. 8D, user interface element 824b can include information about the trailhead corresponding to indication 820d on map 802. In some embodiments, user interface element 824b includes an indication 826f of the name of the trailhead, an indication 826g that the location is a trailhead, an indication 826h of the distance between the trailhead and the current location of the electronic device 500, an indication 826i that the trailhead is currently open, and an indication 826j of the hours of operation of the trailhead. In some embodiments, if the current time is outside of the hours of operation of the trailhead, the electronic device 500 displays an indication that the trailhead is currently closed instead of displaying indication 826i. As shown in FIGS. 8C and 8D, the types of information included in the user interface element about the location is different depending on the type of location. The information included in user interface element 824a is associated with trails while the information included in user interface element 824b is associated with trailheads, for example. In some embodiments, in response to receiving another input directed to crown 801 (e.g., including twisting the crown), the electronic device 500 replaces the user interface element 824b with a user interface element with information about a different location indicated on map 802 and displays the indication of that location with increased visual emphasis relative to the other indications. In this way, the electronic device 500 displays indications of the plurality of locations on the map concurrently with additional information about one of the locations and enables the user to scroll through the locations with crown 801 to view additional information about the various locations one at a time, for example.

In some embodiments, in response to receiving an input to pan and/or zoom the map 802, the electronic device 500 updates the map 802 to include indications of different locations matching the search inquiry (e.g., selection of option 816a in FIG. 8B) that are within the updated area of the map 802. For example, in FIG. 8D, the electronic device 500 receives an input including movement of contact 803d that corresponds to a request to pan the map 802. In response to receiving the input in FIG. 8D, in some embodiments, the electronic device 500 updates the map 802 as shown in FIG. 8E.

FIG. 8E illustrates an example of the electronic device 500 displaying the map 802 updated in response to the input shown in FIG. 8D. As shown in FIG. 8E, the electronic device 500 displays a portion of the map 802 that is adjacent to the portion of the map 802 that was displayed in FIG. 8D. For example, the electronic device 500 panned the map 802 in a direction corresponding to the direction of the movement of the contact 803d in FIG. 8D and by an amount corresponding to an amount (e.g., of speed, distance, and/or duration) of movement of the contact 803d in FIG. 8D. Additionally or alternatively, in some embodiments, the electronic device 500 updates the map 802 to include indications 820e through 820h and 818g through 818i of locations matching the search inquiry (e.g., the input in FIG. 8B selecting option 816a) within the updated map 802 area. The electronic device 500 displays indication 820h with increased visual emphasis relative to the other indications 820e through 820g and 818g through 818i including displaying indication 820h with icon 819e and label 819f. As described above, other techniques for increasing visual emphasis are possible. Additionally or alternatively, in some embodiments, the electronic device 500 displays user interface element 824c including information about the location corresponding to indication 820h. User interface element 824c optionally includes information similar to the information included in user interface element 824b in FIG. 8D because user interface element 824b and user interface element 824c both include information about trailheads. For the sake of brevity, the details of user interface element 824c, which are similar to those of user interface element 824b, will not be repeated.

As shown in FIG. 8E, the electronic device 500 receives an input including contact 803e at the location of user interface element 824c followed by movement of contact 803e towards the edge of the display generation component 504. For example, the input is a downward swipe from user interface element 824c. In response to the input illustrated in FIG. 8E, the electronic device 500 ceases display of the user interface element 824c as shown in FIG. 8F.

FIG. 8F illustrates the electronic device 500 displaying the map 802 without user interface element 824c in response to the input illustrated in FIG. 8E. In some embodiments, the electronic device 500 displays an indication 820i of a location matching the search inquiry that is displayed at a location in the user interface at which user interface element 824c had previously been displayed. As shown in FIG. 8F, the electronic device 500 also ceases display of icon 819e and label 819f in response to the input shown in FIG. 8E. In some embodiments, the electronic device 500 maintains display of label 819f and/or icon 819e in response to the input in FIG. 8E. In some embodiments, in response to receiving another input corresponding to a request to pan and/or zoom the map 802, the electronic device 500 pans and/or zooms the map 802 in accordance with the input, including displaying indications of locations matching the search inquiry on the updated map 802 without displaying a user interface overlaid on the map including information about one of the locations (e.g., similar to user interface 824a, 824b, or 824c).

As shown in FIG. 8F, the electronic device 500 receives an input including selection of option 822b with contact 803f. In response to receiving the input shown in FIG. 8F, the electronic device 500 presents indications of the locations corresponding to the search inquiry without map 802 in a “list view”, as shown in FIG. 8G.

FIG. 8G illustrates the electronic device 500 displaying indications 828a through 828d of nearby locations matching the search inquiry in a list view that does not include a map in response to the input illustrated in FIG. 8F. In some embodiments, the electronic device 500 displays the indications 828a through 828d in a scrollable list and, in response to receiving a scrolling input, the electronic device 500 scrolls the list to show additional indications not shown in FIG. 8G. In some embodiments, the electronic device 500 receives the scrolling input using crown 801 or touch screen 504 (e.g., detecting a swipe input). Indication 828a optionally includes information about a trailhead, such as an icon 830a indicating that the location is a trailhead, an indication 830b of the name of the trailhead, an indication 830c of the distance between the trailhead and the current location of the electronic device 500, a typed indication 830d that the location is a trailhead, and an indication 830e of the city in which the trailhead is located. In some embodiments, indications 828b through 828d include similar contents as indication 828a. In some embodiments, the electronic device 500 displays representations of search results of a different type, such as trails. In some embodiments, an indication representing a trail similar to indications 828a through 828d would instead include an icon and/or text indicating that the location is a trail and optionally information specific to trails, such as distance, type, or difficulty of the trail.

As described above with reference to FIGS. 8C-8E, for example, the electronic device 500 displays indications of multiple search results on a map concurrently with a user interface element including additional information about one of the search results. In some embodiments, the contents of the user interface element differs depending on the type of location of the search result to which the user interface element corresponds. For example, a user interface element 824a including information about a trail has different types of information than a user interface element 824b or 824c including information about a trailhead. Additional examples of user interface elements including information about a search result are described below with reference to FIGS. 8H and 8I.

FIG. 8H illustrates an example of the electronic device 500 displaying indications 832a through 832e of restaurants on the map 802. In some embodiments, the electronic device 500 displays the user interface in FIG. 8H in response to an input selecting an option to display indications of restaurants on the map and/or in response to detecting the user enter a search inquiry, such as “restaurants” followed by an input to display the results on map 802. In FIG. 8H, indication 832e is displayed with increased visual emphasis relative to indications 832a through 832d and the electronic device 500 concurrently displays user interface element 824d including additional information about the restaurant corresponding to indication 832e. The user interface element 824e is displayed with increased visual emphasis relative to indications 832a through 832d, including being displayed with an image indicating that the location is a restaurant and being displayed with text label 819g, for example. In contrast, as shown in FIG. 8H, indications 832a through 832d do not include images or text labels.

In some embodiments, the types of information included in user interface element 824d are different from the types of information included in similar user interface elements for other types of locations (e.g., user interface element 824a in FIG. 8C, user interface element 824b in FIG. 8D, and user interface element 824c in FIG. 8E). For example, user interface element 824d includes an indication 826k of the name of the restaurant, an indication 826l of the type of cuisine of the restaurant, an indication 826m of the neighborhood and/or city in which the restaurant is located, an option 826n to initiate navigation directions to the restaurant that includes an indication of the estimated duration of the navigation route, an option 826p to place a phone call to a phone number associated with the restaurant, an option 826q to view the website associated with the restaurant, an option 826q to open an application for ordering takeout or delivery from the restaurant, an indication 826r that the restaurant is currently open, an option 826s to add a rating (e.g., stars or thumbs up/thumbs down) to the data for the restaurant included in the maps application, an indication 826t of the price range of the restaurant, and an indication 826u of the distance between the current location of the electronic device 500 and the restaurant.

In some embodiments, if the electronic device 500 were to receive an input directed to crown 501, such as detecting turning of the crown, the electronic device 500 would update the user interface shown in FIG. 8H similarly to the manner described above with reference to FIGS. 8C-8D. For example, the electronic device 500 would display a different one of indications 832a through 832d with increased visual emphasis, display indication 832e with less visual emphasis than the now-emphasized indication, and replace user interface element 824d with a similar user interface element including information about the restaurant corresponding to the indication displayed with increased visual emphasis.

FIG. 8I is an example of the electronic device 500 displaying information about a transit station overlaid on the map 802. In some embodiments, the electronic device 500 displays the user interface in FIG. 8I in response to an input selecting an option to display indications of transit stations on the map and/or in response to detecting the user enter a search inquiry, such as “stations” followed by an input to display the results on map 802. As shown in FIG. 8I, the electronic device 500 displays an indication 834 of the location of the transit station on map 802 and a user interface element 824e including information about the transit station overlaid on the map 802. Indication 834 includes an icon indicating a transit station and a text label 819h with the name of the station (e.g., “Olive & 1^{st} Street Station”). In some embodiments, the user interface element 824e includes an indication 836a of the name of the transit station, an indication 836b that the station is a subway station, an indication 836c of the neighborhood and/or city in which the station is located, indications 836d through 836e of transit lines available at the station, an option 836g that, when selected, causes the electronic device 500 to present navigation directions from the current location of the electronic device 500 to the location of the transit station, and an option 836h that, when selected, causes the electronic device 500 to display indications of additional transit lines available at the station. In some embodiments, indications 836d through 836f correspond to the most popular lines at the transit station and, in response to detecting selection of option 836h, the electronic device 500 displays indications of additional transit lines available at the station.

In some embodiments, if the area of map 802 included additional transit stations, the electronic device 500 would display indications of the other transit stations with reduced visual emphasis relative to indication 834. For example, the indications of other transit stations are displayed without icons indicating transit stations and/or without text labels. In some embodiments, while displaying indications of additional transit stations on map 802, in response to receiving an input directed to crown 501, the electronic device 500 would update the user interface similarly to the manner described above with reference to FIGS. 8C-8D. For example, the electronic device 500 would reduce the visual emphasis of indication 834 by ceasing display of the icon indicating a transit station and text label 819h, display an indication of a different transit station with increased visual emphasis, and replace user interface element 824e with a user interface element including information about the transit station corresponding to the indication updated to be displayed with increased visual emphasis.

In some embodiments, in response to detecting selection of the user interface element including additional information about one of the locations indicated on the map 802, the electronic device 500 displays a user interface including additional details about the location. For example, in FIG. 8J, the electronic device 500 receives an input including selection of user interface element 824a with contact 803j. The user interface in FIG. 8J can include the same elements as those described above with reference to FIG. 8C. For the sake of brevity, those details will not be repeated. In response to the input illustrated in FIG. 8J, the electronic device 500 displays a user interface with additional details about the trail corresponding to user interface element 824a, as shown in FIG. 8J.

FIG. 8K illustrates an example of the electronic device 500 displaying a user interface 838 including additional information about a trail in response to the input illustrated in FIG. 8J. The user interface 838 optionally includes an indication 840a of the name of the trail, an indication 840b that the location is a trail, an indication 840c of the distance between the current location of the electronic device 500 and the closest access point to the trail, an option 840d to cease display of the user interface 838, an indication 840e of the difficulty of the trail, an indication 840f that the trail is a point-to-point trail, an indication 840g of the length of the trail, an option 840h to present navigation directions to the trail, and photos 840i of the trail. In some embodiments, the user interface 838 includes additional content as described below with reference to method 1300. As shown in FIG. 8K, the electronic device 500 receives an input including selection of option 840h with contact 803k. In response to the input shown in FIG. 8K, the electronic device 500 displays indications of available navigation routes to the trail, as shown in FIG. 8L.

FIG. 8L illustrates an example of the electronic device 500 displaying indications 842a through 842c of available navigation routes from the current location of the electronic device 500 to the trail in response to the input illustrated in FIG. 8K. In some embodiments, the map 802 further includes an indication 804 of the current location of the electronic device and an indication 844 of the access point of the trail at which the navigation routes end. In some embodiments, indication 842a is displayed with increased visual emphasis relative to indications 842b and 842c and the user interface further includes a user interface element 824f with additional information about the navigation route corresponding to indication 842a. For example, displaying indication 842a with increased visual emphasis relative to indications 842b and 842c includes displaying the indication 842a with a darker, thicker, and/or less translucent line than the lines of indications 842b and 842c. In some embodiments, the electronic device 500 further displays an indication 846a of the estimated time of navigation along the route corresponding to indication 842a, an indication 846b of the estimated time of navigation along the route corresponding to indication 842b, and an indication 846c of the estimated time of navigation along the route corresponding to indication 842c.

As shown in FIG. 8L, the user interface element 824f includes an indication 836i that the navigation route is a hiking/walking route, an indication 836j of the estimated time of arrival at the access point to the trail if the navigation route is used, an indication 836k of the distance of the navigation route, an option 836l to view advisories associated with the navigation route, an indication 836m of the number of advisories associated with the navigation route, and an indication 836n of the elevation profile of the navigation route. In some embodiments, advisories include conditions and/or events that cause navigation along the route to take longer than usual and/or characteristics of the route that may make the user choose a different route. Example advisories include weather advisories, road closure advisories, traffic along the route, stairs along a walking route, and requirement to pay a fee to access a route (e.g., tolls or entrance fees). In some embodiments, the electronic device 500 further displays an option 848 overlaid on user interface element 824f that, when selected, causes the electronic device 500 to initiate navigation along the route corresponding to user interface element 824f.

In some embodiments, if the electronic device 500 were to receive an input directed to crown 501, such as detecting turning of the crown, the electronic device 500 would update the user interface shown in FIG. 8L similarly to the manner described above with reference to FIGS. 8C-8D. For example, the electronic device 500 would display a different one of indications 842b or 842c with increased visual emphasis, display indication 842a with less visual emphasis than the now-emphasized indication, and replace user interface element 824f with a similar user interface element including information about the route corresponding to the indication displayed with increased visual emphasis. In some embodiments, the electronic device 500 further displays the option 822a to navigate back (e.g., to the user interface illustrated in FIG. 8K) and an option 822b to view the navigation routes in a list view similar to the user interfaces in FIGS. 8G and 8N).

In some embodiments, the information presented about available navigation routes varies depending on the mode of transportation of the navigation routes. FIG. 8M illustrates an example of the electronic device 500 displaying a user interface including indications of available cycling routes to a destination (e.g., the trail access point). The electronic device 500 displays indications 850a and 850b of available cycling routes on the map 802 with an indication 804 of the current location of the electronic device 500 and an indication 844 of the end of the routes (e.g., the trail access point). In some embodiments, indication 850a is displayed with an indication 852a of the estimated duration of the route corresponding to indication 850a and indication 850b is displayed with an indication 852b of the estimated duration of the route corresponding to indication 850b. As shown in FIG. 8M, indication 850a is displayed with increased visual emphasis relative to indication 850b using one or more of the techniques described above with reference to FIG. 8L and the electronic device 500 further displays a user interface element 824g with information about the route corresponding to indication 850a.

In some embodiments, indication 850a includes information relevant to a cycling route. For example, indication 850a includes an indication 836o that the route is a cycling route, an indication 836p of the estimated time of arrival at the destination if the route is used, an indication 836q of the distance of the route, an option 836r that, when selected, causes the electronic device 500 to display advisories for the route, an indication 836s of the number of advisories present for the route, an indication 836t of the elevation profile of the route, and an indication 836u of a type of path included on the route. In some embodiments, types of advisories for cycling routes may be different from types of advisories for other modes of transportation, such as indicating that stairs will be required for a portion of the route. Also, as shown in FIGS. 8L and 8M, the user interface element 824g with information about a cycling route includes the indication 836u of the road type, whereas the user interface element 824f with information about the hiking route does not include an indication of the road types used. In some embodiments, the information included can further vary among modes of transportation. For example, information about a driving route may not include an indication 836t of an elevation profile, but may include information about predicted traffic conditions.

In some embodiments, if the electronic device 500 were to receive an input directed to crown 501, such as detecting turning of the crown, the electronic device 500 would update the user interface shown in FIG. 8M similarly to the manner described above with reference to FIGS. 8C-8D. For example, the electronic device 500 would display indication 850b with increased visual emphasis, display indication 850a with less visual emphasis than the now-emphasized indication, and replace user interface element 824g with a similar user interface element including information about the route corresponding to indication 850b displayed with increased visual emphasis. In some embodiments, the electronic device 500 further displays the option 822a to navigate back (e.g., to the user interface illustrated in FIG. 8K) and an option 822b to view the navigation routes in a list view similar to the user interfaces in FIGS. 8G and 8N).

FIG. 8N illustrates an example of the electronic device 500 displaying indications 854a through 854c of available public transportation routes to a navigation destination. In some embodiments, rather than displaying indications of available public transportation routes on map 802 similar to FIGS. 8L and 8M, the electronic device 500 displays the indication 854a through 854c of available public transportation routes in a list view without map 802, as shown in FIG. 8N. In some embodiments, the electronic device 500 displays an indication 856a that the routes use public transportation and an indication 856b of the starting and ending locations of the navigation routes. In some embodiments, the electronic device 500 displays the indications 854a through 854c of the available navigation routes in a scrollable list. For example, in response to receiving an input including turning of crown 501 or a swipe input detected using touch screen 504, the electronic device 500 scrolls the list of indications 854a through 854c in accordance with the input (e.g., by an amount and in a direction corresponding to characteristics of the swipe input).

As shown in FIG. 8N, indication 854a includes an indication 858a of the estimated duration of the route, an indication 858b of when the first segment of the route including public transportation departs, indications 858c of the steps of the navigation route (e.g., walking, followed by using a bus, followed by walking), and an option 858d that, when selected, causes the electronic device 500 to initiate navigation using the route. In some embodiments, the electronic device 500 forgoes displaying an option to view indications of the public transportation routes on a map 802, as shown in FIG. 8N. In some embodiments, the electronic device 500 further an option to view indications of the public transportation routes on a map 802. In some embodiments, the electronic device 500 displays an option to view the indications of public transportation routes on a map 802 in the user interface illustrated in FIG. 8N and, in response to receiving selection of the option, the electronic device 500 displays indications of the available public transportation routes on a map 802 similar to the user interfaces illustrated in FIGS. 8L and 8M.

In some embodiments, in response to initiating navigation along one of the routes described herein with reference to FIGS. 8A-8N, the electronic device 500 initiates navigation, including displaying one or more of the user interfaces described below with reference to method 1100.

FIG. 9 is a flow diagram illustrating a method in which an electronic device displays information on a map, including indications of locations according to some embodiments of the disclosure. The method 900 is optionally performed at first and/or electronic devices such as device 100, device 300, or device 500 as described above with reference to FIGS. 1A-1B, 2-3, 4A-4B and 5A-5C. Some operations in method 900 are, optionally combined and/or order of some operations is, optionally, changed.

As described below, the method 900 provides ways in which an electronic device presents indications of locations on a map and a user interface element with additional information about one of the locations. Concurrently presenting the indications on the map and the information about one of the locations enables the device to present more information at once, thus reducing the number of inputs needed to view the content and the location information corresponding to the content.

In some embodiments, method 900 is performed at an electronic device in communication with a display generation component and one or more input devices. In some embodiments, the electronic device has one or more of the characteristics of the electronic device of method 700. In some embodiments, the display generation component has one or more of the characteristics of the display generation component of method 700. In some embodiments, the one or more input devices have one or more of the characteristics of the one or more input devices of method 700. In some embodiments, method 900 is performed at or by an automobile (e.g., at an infotainment system of an automobile having or in communication with one or more display generation components and/or input devices).

In some embodiments, while displaying a user interface of a maps application, such as in FIG. 8B, the electronic device 500 receives, via the one or more input devices, an input corresponding to a request to display respective information on a map of a physical area, such as input with contact 803b in FIG. 8B. In some embodiments, the maps application includes user interfaces for displaying maps of geographic areas according to method(s) 700, 1100, and/or 1300, information about physical locations according to method 1300, and/or navigation directions according to method 1100. In some embodiments, the map of the physical area is a map of the physical environment of the electronic device, including the current location of the electronic device. In some embodiments, the map of the physical area is a map of a physical area that does not include the current location of the electronic device, such as a physical area selected by the user. In some embodiments, the map of the physical area includes indications of roads, buildings, landmarks, natural features such as mountains, bodies of water, and canyons. In some embodiments, if the map is of a physical location that includes the current location of the electronic device, the map includes an indication of the current location of the electronic device. In some embodiments, the request to display respective information of the map is a request for navigation directions from a first location (e.g., a current location of the electronic device or another location) to a destination location. In some embodiments, the request to display respective information is a request to search for locations matching a search query. In some embodiments, the electronic device receives a request to search for a type of location (e.g., a search for “library,” “Italian food,” “breakfast”) or a request to search for a location by name (e.g., the name of a particular business or public building). In some embodiments, the input includes a voice input captured by a microphone included in the one or more input devices. In some embodiments, the input includes a text input provided using a hardware keyboard or soft keyboard included in the one or more input devices.

In some embodiments, in response to receiving the input, the electronic device displays the map of the physical area with a plurality of indications of a plurality of locations corresponding to the respective information, including a first indication of a first location displayed with increased visual emphasis relative to a second indication of a second location, such as indication 818a displayed with increased visual emphasis relative to indications 818b and 818c in FIG. 8C. In some embodiments, the plurality of indications of the plurality of locations are displayed at locations on the map that correspond to the physical locations in the physical area represented by the map. In some embodiments, the indications are icons or images, such as dots, pins, flags, or other shapes. In some embodiments, displaying the first indication with increased visual emphasis includes displaying the indication with a larger size, different color, less translucency, and/or less blur than the second indication. In some embodiments, displaying the first indication with increased visual emphasis includes displaying more information about the first location in the first indication than the amount of information about the second location included in the second indication. For example, the first indication is an image corresponding to the type of location of the first location (e.g., an icon indicating a restaurant, point of interest, trail, trailhead, or public building) and the second indication is a generic shape (e.g., circle, square, pin, or flag). In some embodiments, the electronic device displays a plurality of second indications of second locations corresponding to the respective information. In some embodiments, the electronic device displays one indication (e.g., the first indication) with visual emphasis relative to the other visual indication(s) (e.g., the second indication or a plurality of second indications) without displaying another indication with the same amount of visual emphasis as the first indication. In some embodiments, the locations corresponding to the respective information are indications of available navigation routes to a destination provided in the input. In some embodiments, the indications include an outline of the navigation route. In some embodiments, the location corresponding to the respective information are search results corresponding to the search query provided by the user in the input.

In some embodiments, in response to receiving the input, the electronic device displays, a user interface element including information about the first location without displaying a user interface element including information about the second location, such as user interface element 824a in FIG. 8C. In some embodiments, the information about the first location includes a name of the first location, an address of the first location, and/or additional information about the first location based on the type of location of the first location, as described in more detail below. In some embodiments, the user interface element is displayed at a location overlaid on the map. In some embodiments, the user interface element is displayed at a location overlaid on the map so as not to obscure the first indication of the first location on the map. In some embodiments, the first user interface element is displayed overlaid on the second indication of the second location (or one or more second indications of one or more second locations). In some embodiments, the user interface element does not include information about the second location. In some embodiments, the user interface does not include another user interface element with information about the second location other than the second indication. Displaying the first indication, second indication, and user interface element including information about the first location enhances user interactions with the electronic device by providing improved visual feedback to the user.

In some embodiments, the first indication of the first location includes an indication of respective information about the first location, and the second indication of the second location does not include an indication of the respective information about the second location, such as the indication 824a in FIG. 8C. In some embodiments, the first indication includes an image or icon corresponding to the type of location of the first location. For example, if the first location is a hiking trail, the first indication includes an image of a hiker. As another example, if the first location is a trailhead, the first indication includes an image of a signpost. As another example, if the first location is a restaurant, the first indication includes an image of a plate and utensils, or an image corresponding to the type of cuisine of the restaurant. As another example, if the first location is a gas station, the first indication includes an image of a gas pump. In some embodiments, the second indication (and one or more additional indications of additional locations concurrently displayed) is a generic shape, like a dot, flag, or pin that does not include an image or icon corresponding to the type of location of the second location regardless of the type of location of the second location. Displaying the first indication with the indication of the respective information enhances user interactions with the electronic device by automatically surfacing information relevant to the user, thus saving time and reducing the inputs needed to interact with the electronic device.

In some embodiments, the input corresponding to a request to display respective information on the map is a request to search for locations corresponding to a search query, such as a search query provided in text entry field 812 in FIG. 8B. In some embodiments, the input includes a voice input provided by the user, wherein the user speaks the search query. In some embodiments, the input includes an input directed to a soft keyboard displayed using the display generation component, wherein the user types the search query with the soft keyboard. In some embodiments, valid search queries include searching for a type of location (e.g., trails, trailheads, restaurants, gas stations, post offices) or the name of a location (e.g., “West Loop Trail,” the name of a specific restaurant, or the name of a specific gas station). In some embodiments, in response to the search query, the electronic device displays a map of a physical area including the plurality of indications of the plurality of locations described in more detail above. Displaying the map with the plurality of indications of the plurality of locations as described above in response to an input including a search query enhances user interactions with the electronic device by displaying multiple search results concurrently, thus saving time and user inputs needed to view the plurality of results.

In some embodiments, the plurality of indications of a plurality of locations corresponding to the respective information are a plurality of indications of the locations corresponding to the search query, such as indications 820a through 820d in FIG. 8C. In some embodiments, the electronic device displays the indications of the plurality of locations matching the search query that are within the map area without displaying indications of locations that match the search query that are outside of the map area. In some embodiments, the electronic device displays the indications of the plurality of locations on the map at respective locations on the map corresponding to the locations in the physical area represented by the map. In some embodiments, in response to an input to pan and/or zoom the map area, the electronic device updates the geographic area represented by the map and/or updates the plurality of indications to display indications of search results within the updated map area. Displaying the search results of the search query on the map with the plurality of indications of the plurality of locations as described above enhances user interactions with the electronic device by displaying multiple search results concurrently, thus saving time and user inputs needed to view the plurality of results

In some embodiments, the plurality of indications of the plurality of locations corresponding to the respective information includes an indication of a trail corresponding to the search query, wherein the indication of the trail includes multiple points on the map corresponding to multiple points of the trail in the physical area, such as indications 818a through 818c in FIG. 8C. In some embodiments, the indication of the trail is an outline of the trail displayed with a different visual characteristic than the visual characteristic of other trail(s) and/or path(s) displayed on the map at the location corresponding to the location of the trail in the physical area represented by the map. For example, the indication of the trail is an outline of the trail displayed in a different color, greater line thickness, different line style (e.g., dash pattern), and/or different opacity than the indication(s) of other trail(s) and/or path(s) displayed on the map. Displaying the indication of the trail with multiple points on the map enhances user interactions with the electronic device by automatically showing information that is relevant to the user without requiring additional inputs.

In some embodiments, the plurality of indications of the plurality of locations corresponding to the respective information includes an indication of a trailhead corresponding to the search query, wherein the indication of the trailhead is displayed at a location on the map corresponding to a location of the trailhead in the physical area, such as indications 820a through 820d in FIG. 8D. In some embodiments, the indication of the trailhead is displayed at a single (x, y) location on the map that corresponds to the location of the trailhead in the physical area. Displaying the location of the trailhead on the map enhances user interactions with the electronic device by reducing the time and inputs needed for the user to understand where the trailhead is located.

In some embodiments, while displaying the map of the physical area with the first indication of the first location displayed with increased visual emphasis relative to the second indication of a second location and the user interface element including the information about the first location without displaying the user interface element including the information about the second location, receiving, via a hardware input device included in the one or more input devices, an input, such as the input directed to crown 801 in FIG. 8C. In some embodiments, the hardware input device is a dial or crown and receiving the input includes detecting the dial or crown being turned (e.g., by the user). In some embodiments, the input received using the hardware input device is similar to the input described with reference to method 1100.

In some embodiments, in response to receiving the input via the hardware input device, the electronic device updates display of the plurality of indications of the plurality of locations via the display generation component to display the second indication of the second location with increased visual emphasis relative to the first indication of the first location, such as display of indication 820d with increased visual emphasis relative to other indications 818a through 8a8e and 820a through 820c in FIG. 8D. In some embodiments, displaying the second visual indication of the second location with the increased visual emphasis includes one or more of the details described herein regarding display of the first indication of the first location with increased visual emphasis.

In some embodiments, in response to receiving the input via the hardware input device, the electronic device ceases to display, via the display generation component, the user interface element including the information about the first location, such displaying the user interface in FIG. 8D without user interface element 824a in FIG. 8C.

In some embodiments, in response to receiving the input via the hardware input device, the electronic device displays, via the display generation component, the user interface element including the information about the second location, such as user interface element 824b in FIG. 8D. In some embodiments, the electronic device replaces the user interface element including the information about the first location with the user interface element including the information about the second location. In some embodiments, the electronic device displays the user interface element including the information about the second location at the location in the display area at which the user interface element including the information about the first location was displayed. In some embodiments, the information about the second location includes the same type(s) of information included in the information about the first location if, for example, the first location and second location are the same type of location. In some embodiments, the information about the second location includes different type(s) of information from the information included in the information about the first location if, for example, the first location and second location are different types of locations. In some embodiments, in response to detecting an input selecting the second indication of the second location, the electronic device displays the user interface element including information about the second location and ceases display of the user interface element including information about the first location. In some embodiments, the electronic device does not display the user interface element including information about the second location and does not cease display of the user interface element including information about the first location in response to receiving an input selecting the indication of the second location. In some embodiments, in response to detecting the input directed to the hardware input device, including turning of the hardware input device in the first direction, the electronic device updates the user interface to include the user interface element with information about the second location as described above. In some embodiments, in response to detecting the input directed to the hardware input device, including turning of the hardware input device in a second direction different (e.g., opposite) from the first direction, the electronic device updates the user interface to include the user interface element with information about a third location different from the second location, in a manner similar to display of the information about the second location. For example, in addition to displaying information about the third location in the user interface element, the electronic device displays the indication of the third location on the map with increased visual emphasis relative to other indications displayed on the map. Displaying the user interface element including information about the second location in response to the input received using the hardware input device enhances user interactions with the electronic device

In some embodiments, while displaying the map of the physical area with the plurality of indications of the plurality of locations, the electronic device receives, via the one or more input devices, an input corresponding to a request to update the map to be a second map of a second physical area different from the physical area, such as the input with contact 803d in FIG. 8D. In some embodiments, the input is a swipe input detected using a touch sensitive display that displays the map.

In some embodiments, in response to receiving the input corresponding to the request to update the map to be the second map of the second physical area, such as the input with contact 803d in FIG. 8D, the electronic device displays, via the display generation component, the second map of the second physical area with a plurality of third indications of a plurality of third locations corresponding to the respective information, including a fourth indication of a fourth location displayed with increased visual emphasis relative to a fifth indication of a fifth location, such as map 802 in FIG. 8E. In some embodiments, the electronic device displays multiple indications of multiple locations with the reduced visual emphasis compared to the fourth indication of the fourth location. In some embodiments, the third indication is displayed in a manner similar to the manner of displaying the first indication described above and the fifth indication is displayed similarly to the manner of displaying the second indication described above. In some embodiments, the electronic device ceases display of indications of one or more locations that were displayed prior to receiving the input in response to receiving the input. In some embodiments, the updated map area no longer includes one or more of the plurality of locations displayed prior to receiving the input.

In some embodiments, in response to receiving the input corresponding to the request to update the map to be the second map of the second physical area, such as the input with contact 803d in FIG. 8D, the electronic device ceases to display, via the display generation component, the user interface element including the information about the first location, such as displaying the user interface in FIG. 8E without user interface element 824b in FIG. 8D.

In some embodiments, in response to receiving the input corresponding to the request to update the map to be the second map of the second physical area, such as the input with contact 803d in FIG. 8D, the electronic device displays, via the display generation component, a user interface element including information about the fourth location, such as user interface element 824c in FIG. 8E. In some embodiments, the electronic device ceases displaying the user interface element including the information about the first location because the updated map no longer includes the first location. In some embodiments, the updated map still includes the first location, but the electronic device still ceases display of the user interface element including the information about the first location and displays the user interface element including information about the fourth location. In some embodiments, the electronic device ceases display of the user interface element including the information about the first location and displays the user interface element including information about the fourth location in a manner similar to the manner described above of the electronic device ceasing display of the user interface element including the information about the first location and displaying the user interface element including information about the second location. Updating the map to include indications of the third plurality of locations and updating the user interface to include the user interface element including information about the fourth location in response to the input corresponding to the request to pan the map enhances user interactions with the electronic device by reducing the inputs needed to search for locations within a user-defined physical area.

In some embodiments, displaying the user interface element including the information about the first location includes, in accordance with a determination that the first location has a first value for a characteristic, the information includes first information about the first location, such as user interface element 824a in FIG. 8C including indications 826a through 826e with information about at trail. In some embodiments, the characteristic is a type of location of the first location if the first location is a location of a place or a mode of transportation if the first location is a navigation route. As described in more detail below, in some embodiments, the user interface element includes various different types of information about the first location depending on the type of location or mode of transportation.

In some embodiments, displaying the user interface element including the information about the first location includes, in accordance with a determination that the first location has a second value for the characteristic different from the first value, the information includes second information about the first location different from the first information, such as in user interface element 824b in FIG. 8D including indications 826f through 826j with information about a trailhead. In some embodiments, the electronic device ceases to display the user interface element including information about the first location and displays a user interface element including information about the second location or a fourth location, as described above. In some embodiments, if the second or fourth location has a different value for the characteristic than the value for the characteristic of the first location, the user interface element including the information about the second or fourth location includes different types of information than the types of information included in the user interface element including information about the first location. Displaying different information about the first location based on a value of a characteristic of the first location enhances user interactions with the electronic device by surfacing relevant information to the user without requiring additional inputs.

In some embodiments, the input corresponding to the request to display respective information includes a request to display navigation routes to a destination location, the plurality of indications of a plurality of locations corresponding to the respective information include a plurality of indications of the navigation routes to the destination location, such as the input in FIG. 8K with contact 803k and indications 842a through 842c of navigation routes in FIG. 8L.

In some embodiments, the user interface element including the information about the first location is a user interface element including information about a first navigation route to the destination location including, in accordance with a determination that the first navigation route uses a first mode of transportation, the first information corresponding to the first mode of transportation, such as indications 836i through 836n of information about a walking route in FIG. 8L. In some embodiments, regardless of the mode of transportation of the first navigation route, the electronic device displays an indication of estimated travel time and any relevant advisories for the first navigation route in the user interface element including information about the first navigation route. In some embodiments, advisories include information that may impact the route, such as the need to dismount and walk a bike along a biking route, the need to use stairs along a walking route, hazard(s) on the road along a driving route, and/or delays along a public transportation route. In some embodiments, the first indication of the first navigation route includes an indication of a main road used in the navigation route, such as the road with the longest distance along the route, the busiest road used along the route, or a road not used in other navigation routes that are also displayed.

In some embodiments, the user interface element including the information about the first location is a user interface element including information about a first navigation route to the destination location including, in accordance with a determination that the first navigation route uses a second mode of transportation different from the first mode of transportation, the second information corresponding to the second mode of transportation, such as indications 836o through 842g of information about a cycling route in FIG. 8M. In some embodiments, if the first navigation route is a walking navigation route, the user interface element including the information about the first navigation route includes an indication of a change in elevation along the first navigation route and/or an elevation map of the first navigation route. In some embodiments, if the first navigation route is a biking navigation route, the user interface element including the information about the first navigation route includes an indication of access rules of the road(s) included in the navigation route, such as the route using roads that have lanes bicycles share with automobiles. In some embodiments, these examples apply to user interface elements including information about a second navigation route that the electronic device displays in response to receiving an input using a hardware input device, as described in more detail above. Displaying different information depending on the mode of transportation of the first navigation route enhances user interactions with the electronic device by surfacing relevant information to the user without requiring additional user inputs.

In some embodiments, the first location is a location of a trail, and the user interface element (e.g., 842a in FIG. 8J) including the information about the first location includes an indication of a name of the trail (e.g., 826a), a distance between the location of the trail and a current location of the electronic device (e.g., 826c), an indication of a difficulty rating for the trail (e.g., 826c), an indication of a type of the trail (e.g., 826e), and an indication of a distance of a length of the trail (e.g., 826e). In some embodiments, the electronic device displays the location of the trail in response to receiving a search query as described above, such as a search for nearby trails or a search for the name of the trail. In some embodiments, the distance between the location of the trail and the current location of the electronic device is the distance to the closest access point to the trail, even if that access point is not a trailhead. In some embodiments, the distance is a distance as the crow flies. In some embodiments, the distance is the distance of a navigation route to the trail (e.g., a navigation route recommended based on one or more criteria such as distance, estimated duration, elevation change, popularity, difficulty, and/or hours of operation of trails and/or paths used by the navigation route). Example types of trails include out and back trails, point to point trails, and loop trails. Displaying information relevant to a trail in the user interface element including information about the trail enhances user interactions with the electronic device by surfacing relevant information to the user without requiring additional user inputs.

In some embodiments, the first location is a location of a trailhead, and the user interface element (e.g., 824b in FIG. 8D) including the information about the first location includes an indication of a name of the trailhead (e.g., 826f), an indication of a distance between the trailhead and a current location of the electronic device (e.g., 826h), and an indication of hours of operation of the trailhead (e.g., 826j). In some embodiments, the distance between the current location and the trailhead is a distance as the crow flies. In some embodiments, the distance is the distance of a navigation route to the trailhead (e.g., a navigation route recommended based on one or more criteria such as distance, estimated duration, elevation change, popularity, difficulty, and/or hours of operation of trails and/or paths used by the navigation route). Displaying information relevant to a trailhead in the user interface element including information about the trailhead enhances user interactions with the electronic device by surfacing relevant information to the user without requiring additional user inputs.

In some embodiments, such as in FIG. 8C, the plurality of indications of the plurality of locations corresponding to the respective information includes an indication (e.g., 818a) of a trail and an indication (e.g., 820a) of a trailhead. In some embodiments, the electronic device presents indications of trails concurrently with representations of trailheads on the map of the physical area. In some embodiments, the electronic device presents the indications of trails and trailheads in response to a request to search for trails and trailheads. In some embodiments, the request to search for trails and trail heads is received by the user entering a search query for trails and trailheads into a text entry field. In some embodiments, the request to search for trails and trailheads is received by the user selecting an option to display indications of nearby trails and/or trailheads on a map displayed in a user interface including other options to display indications of other types of locations. In some embodiments, the request to search for trails and trailheads is received by the user selecting an option that the electronic device display in response to detecting the current location of the electronic device in a predefined physical area, such as a hiking area, as described below with reference to method 1300. Concurrently displaying indications of trails and indications of trailheads on the map of the physical area enhances user interactions with the electronic device by presenting information likely to be relevant to the user without requiring additional user inputs, thereby saving time and/or conserving battery life.

In some embodiments, such as in FIG. 8H, the first location is a location of a restaurant, and the user interface element (e.g., 824d) including the information about the first location includes an indication (e.g., 826k) of a name of the restaurant, an indication (e.g., 826l) of a type of cuisine of the restaurant, an indication (e.g., 826u) of a distance between the restaurant and a current location of the electronic device, an indication (e.g., 826r) of hours of operation of the restaurant, and an indication (e.g., 826s) of ratings of the restaurant. Example types of cuisine include a country of origin of the cuisine (e.g., American, Mexican, French, Chinese, or Ethiopian), themes (e.g., gastropub or café), service type (e.g., takeout only, fast food, fast casual, full-service, family style, or fine dining) or types of menu items (e.g., sushi, pizza, or burritos). In some embodiments, the distance between the restaurant and the current location of the electronic device is the distance as the crow flies. In some embodiments, the distance between the restaurant and the current location of the electronic device is the distance of a navigation route from the current location of the electronic device to the restaurant that is selected based on one or more criteria (e.g., estimated travel time, route distance, traffic, number of turns required, advisories on the route, weather, cost, or hours of operation of segments of the route). In some embodiments, the restaurant ratings are crowd sourced reviews of how other users would rate their experience at the restaurant. Displaying information relevant to a restaurant in the user interface element including information about the restaurant enhances user interactions with the electronic device by surfacing relevant information to the user without requiring additional user inputs.

In some embodiments, such as in FIG. 8I, the first location is a location of a transit station, and the user interface element (e.g., 824e) including the information about the first location includes a plurality of indications (e.g., 836d through 836f) of a first plurality of transit lines available at the station. In some embodiments, the electronic device displays up to a threshold number of indications of transit lines available at the station in the user interface element including the information about the first location, such as up to 2, 3, 4, 5, or 10 indications of transit lines, even if additional transit lines are available at the station. In some embodiments, the first plurality of transit lines are selected based on one or more criteria, such as popularity, hours of operation, next arrival/departure time of the line, frequency of operation, and/or the user's usage history of one or more transit lines available at the station. In some embodiments, the user interface element further includes information such as distance/estimated walking time to the station from the current location of the electronic device and the name of the station.

In some embodiments, the electronic device receives, via the one or more input devices, an input selecting the user interface element including the information about the first location, such as an input directed to user interface element 824e in FIG. 8I. In some embodiments, the input is detected using a hardware input device, such as detecting a crown or dial being pressed like a button or detecting a button being pressed. In some embodiments, the input is detected using a touch screen on which the user interface element is displayed, such has detecting a contact at the location at which the user interface element is displayed by the touch screen.

In some embodiments, in response to receiving the input selecting the user interface element including the information about the first location, the electronic device displays second indications of the first plurality of transit lines available at the station and a second plurality of transit lines available at the station, such as displaying indications of the transportation lines indicated by indications 836d through 836f and additional indication of other transportation lines. In some embodiments, the electronic device displays the second indications in a scrollable list. For example, the scrollable list includes all of the transit lines available at the station. Displaying a subset of transit lines available at the station in the user interface element including the information about the first location and displaying additional transit lines in response to detecting selection of the user interface element enhances user interactions with the electronic device by displaying the most relevant information without further inputs and making additional information available in response to an input.

In some embodiments, while displaying the map of the physical area with the plurality of indications of the plurality of locations corresponding to the respective information, the electronic device receives, via the one or more input devices, a second input, such as the input with contact 803e directed to option 822b in FIG. 8F. In some embodiments, the second input is directed to a user interface element displayed overlaid on the map of the physical area. In some embodiments, the second input is detected using a touch screen or a hardware input device.

In some embodiments, in response to receiving the second input, the electronic device ceases to display the map of the physical area with the plurality of indications of the plurality of locations, such as displaying the user interface in FIG. 8G without map 802 and indications 820e through 820i and 818f through 818j. In some embodiments, the electronic device ceases display of the map and ceases display of the indications of the plurality of locations.

In some embodiments, in response to receiving the second input, the electronic device displays, via the display generation component, a second user interface element with information about the first location and a second user interface element including information about the second location, such as displaying indications 828a through 828d in FIG. 8G. In some embodiments, the second user interface elements are displayed in a scrollable list. In some embodiments, the scrollable list further includes user interface elements including information about other locations of the plurality of locations. In some embodiments, the second user interface element including information about the first location includes the same information as the user interface element including information about the first location. In some embodiments, the second user interface element including information about the first location includes different information from the user interface element including information about the first location. Toggling between displaying the map and displaying the second user interface elements enhances user interactions with the electronic device by providing the user with options for how to present information about the plurality of locations.

In some embodiments, while displaying the map of the physical area with the plurality of indications of the plurality of locations corresponding to the respective information and the user interface element including the information about the first location, the electronic device receives, via the one or more input devices, an input directed to the user interface element, such as input with contact 803e directed to user interface element 824c in FIG. 8E. In some embodiments, the input is a swipe input that includes detecting a contact at a location of a touch screen at which the user interface element is displayed followed by movement of the contact in a predetermined direction (e.g., without detecting liftoff of the contact between detecting the contact and the movement of contact). For example, the input is a downward swipe that starts at the location of the user interface element. In some embodiments, the input is detected using a hardware input device, such as a crown, button, or dial.

In some embodiments, in response to receiving the input directed to the user interface element, ceasing display of the user interface element and maintaining display of the map of the physical area with the plurality of indications of the plurality of locations corresponding to the respective information, such as the display of indication 818f without increased visual emphasis in FIG. 8F. In some embodiments, the electronic device displays additional indications of locations that at display area locations at which the user interface element had been displayed. In some embodiments, the electronic device does not initiate display of additional indications of locations even if there are locations corresponding to the information that correspond to portions of the map displayed at display area locations at which the user interface element had been displayed. In some embodiments, in response to the (e.g., swipe) input directed to the user interface element, the electronic device maintains display of the indication of the first location with increased visual emphasis. In some embodiments, while the electronic device forgoes display of the user interface element and displays the indication of the first location with increased visual emphasis, in response to receiving an input directed to the hardware device (e.g., turning the crown), the electronic device displays the indication of the first location without the increased visual emphasis and displays an indication of a different location with the increased visual emphasis. In some embodiments, in response to the (e.g., swipe) input directed to the user interface element, the electronic device updates display of the indication of the first location to be displayed without the increased visual emphasis, such as displaying the indication of the first location with the same visual emphasis as the second indication of the second location. Ceasing display of the user interface element in response to the input enhances user interactions with the electronic device by providing an efficient way of showing additional portions of the map of the physical area.

In some embodiments, while displaying the map of the physical area with the plurality of indications of the plurality of locations corresponding to the respective information without displaying the user interface element including the information about the first location, the electronic device receives, via the one or more input devices, an input directed to the map, such as an input directed to map 802 in FIG. 8F. In some embodiments, the input includes a swipe in a direction opposite of a swipe direction included in the input directed to the user interface element described above. In some embodiments, the input is a swipe input that includes detecting a contact at a location of a touch screen at which the map is displayed followed by movement of the contact in a predetermined direction (e.g., without detecting liftoff of the contact between detecting the contact and the movement of contact). For example, the input is an upward swipe that starts at the location of the map. In some embodiments, the input is detected using a hardware input device, such as a crown, button, or dial.

In some embodiments, in response to receiving the input directed to the map, the electronic device displays, via the display generation component, the user interface element including the information about the first location and maintaining display of the map of the physical area with the plurality of indications of the plurality of locations corresponding to the respective information, such as displaying the user interface in FIG. 8E. In some embodiments, displaying the user interface element includes obscuring one or more indications of locations on the map. In some embodiments, the electronic device displays the user interface element with information about a second location different from the first location in response to receiving the input directed to the map. For example, the electronic device displays information about the second location because the electronic device panned the map while the user interface element was not displayed and the first location is optionally no longer included on the map. In some embodiments, if the indication of the first location was displayed with visual emphasis when the input directed to the map was received, the electronic device continues to display the indication of the first location with visual emphasis in response to receiving the input. In some embodiments, if the indication of the first location was not displayed with visual emphasis (and no other visual indication was displayed with visual emphasis) when the input directed to the map was received, the electronic device updates the indication of the first location to be displayed with visual emphasis in response to receiving the input. Displaying the user interface element in response to the input enhances user interactions with the electronic device by providing an efficient way of showing additional information about a location included on the map.

In some embodiments, while displaying the map of the physical area with the plurality of indications of the plurality of locations corresponding to the respective information and the user interface element including the information about the first location, the electronic device receives, via the one or more input devices, an input directed to the user interface element, such as the input in FIG. 8J with contact 803j directed to user interface element 824a. In some embodiments, the input corresponds to selection of the user interface element. In some embodiments, the input is detected using a touch screen or a hardware input device.

In some embodiments, in response to receiving the input directed to the user interface element, the electronic device displays additional information about the first location, such as in FIG. 8K. In some embodiments, in response to receiving the input, the electronic device ceases display of the map. In some embodiments, in response to receiving the input, the electronic device displays a user interface including information about the first location in place of or overlaid on the map. In some embodiments, the user interface includes the information included in the user interface element that was displayed with the map and additional information not included in the user interface. Examples of additional information about the first location if the first location is a trail or trailhead are provided in the description of method 1300. Displaying additional information about the first location in response to receiving the input directed to the user interface element enhances user interactions with the electronic device by providing efficient ways of displaying information relevant to the user.

In some embodiments, the input corresponding to the request to display the respective information on the map of the physical area includes a request to display navigation directions to a destination location, such as the input with contact 803k directed to option 840h in FIG. 8K, and the plurality of indications of the plurality of locations corresponding to the respective information include a plurality of indications of a plurality of available navigation routes to the destination location including the first indication of a first navigation route displayed with increased visual emphasis relative to the second indication of a second navigation route, such as indications 842a through 842c in FIG. 8L. In some embodiments, in response to detecting a request to present navigation directions to a destination location, the electronic device displays a plurality of indications of available navigation routes on a map of a physical area at locations on the map corresponding to locations of the routes in the physical area represented by the map, with a first indication of a first navigation route displayed with increased visual emphasis relative to the indications of other available navigation routes and a user interface element with information about the first navigation route. In some embodiments, the information about the navigation route includes the information described above. In some embodiments, displaying the first indication of the first navigation route with increased visual emphasis compared to the other indications of available navigation routes includes displaying the first indication with a different color, greater thickness, greater opacity, different line style, or greater display brightness than the other indications of available navigation routes. Displaying the plurality of indications of navigation routes with a first indication of a first navigation route displayed with increased visual emphasis enhances user interactions with the electronic device by reducing the time and inputs needed to display information relevant to the user.

In some embodiments, while displaying the map of the physical area with the plurality of indications of the plurality of available navigation routes to the destination including the first indication of the first navigation route displayed with increased visual emphasis relative to the second indication of the second navigation route, such as map 802 with indications 842a through 842c in FIG. 8L, the electronic device displays, via the display generation component, a selectable option that, when selected, causes the electronic device to initiate navigation using the first navigation route, such as option 848 in FIG. 8L. In some embodiments, the selectable option is displayed overlaid on the map and the indications of the navigation routes.

In some embodiments, while displaying the map of the physical area with the plurality of indications of the plurality of available navigation routes to the destination including the first indication of the first navigation route displayed with increased visual emphasis relative to the second indication of the second navigation route, such as map 802 with indications 842a through 842c in FIG. 8L, the electronic device receives, via the one or more input devices, an input corresponding to selection of the selectable option, such as selection of option 848 in FIG. 8L. In some embodiments, the input is received using a touch screen and includes detecting a contact at the location of the touch screen at which the selectable option is displayed.

In some embodiments, in response to receiving the input corresponding to selection of the selectable option, the electronic device initiates navigation to the destination location using the first navigation route, such as according to method 1100. In some embodiments, while an indication of a different navigation route is displayed with increased visual emphasis relative to the indications of other navigation routes, the electronic device initiates navigation using the different navigation route in response to receiving the input directed to the selectable option. Displaying a navigation option in the user interface including the indications of the available navigation routes enhances user interactions with the electronic device by reducing the number of inputs needed to start navigation while reviewing available route options.

In some embodiments, the plurality of indications of available navigation routes to the destination location include indications of navigation segments with relatively high priority used in the available navigation routes displayed with increased visual emphasis and indications of navigation segments with relatively low priority used in the available navigation routes displayed with decreased visual emphasis, such as displaying indications 842a through 842c in FIG. 8L with portions corresponding to high priority navigation segments presented with increased visual emphasis. For example, navigation segments include roads, paths, trails, or portions of a public transportation route using a respective public transportation line. In some embodiments, the indication of the first route includes an indication of a road with relatively high priority displayed with increased visual emphasis and an indication of a road with relatively low priority displayed without the increased visual emphasis while the indication of the second route includes an indication of a road with relatively high priority displayed with increased visual emphasis and an indication of a road with relatively low priority displayed without the increased visual emphasis. In some embodiments, relatively high priority navigation segments are selected based on one or more criteria such as the distance along the route using the navigation segment, the popularity of the navigation segment, hours of operation of the navigation segment, and whether the navigation segment is used in other available navigation routes. In some embodiments, the increased visual emphasis includes displaying the segment of the route with high priority with increased visual emphasis as described above. In some embodiments, the increased visual emphasis includes displaying a written indication of the name of the relatively high priority navigation segment proximate to the indication of the navigation segment within the indication of the navigation route. Displaying indications of available navigation routes with segments using relatively high priority roads displayed with increased visual emphasis enhances user interactions with the electronic device by reducing the time and inputs needed to display information likely to be relevant to the user.

In some embodiments, displaying the map of the physical area with the plurality of indications of the plurality of available navigation routes to the destination location including the first indication of the first navigation route displayed with increased visual emphasis relative to the second indication of the second navigation route is in accordance with a determination that the input corresponding to the request to display the navigation directions to the destination location is a request to display the navigation directions to the destination location using a first mode of transportation, such as the user interface in FIG. 8M. In some embodiments, the first mode of transportation is walking, biking, or driving. In some embodiments, the electronic device displays available navigation routes for walking, biking, or driving as visual indications on a map as described above.

In some embodiments, the electronic device receives, via the one or more input devices, a second input corresponding to a request to display navigation directions to the destination location using a second mode of transportation different from the first mode of transportation. In some embodiments, the second mode of transportation is public transportation.

In some embodiments, in response to receiving the second input, the electronic device displays a visual indication of a navigation route using the first mode of transportation without displaying a map of a physical area with a plurality of indications of available navigation routes to the destination location using the first mode of transportation, such as in FIG. 8N. In some embodiments, the electronic device displays available navigation routes for public transportation as user interface elements with information about each available route in a list without displaying a map. In some embodiments, the user interface elements include information about each route such as which transit lines are included in the navigation route, the estimated time of arrival at the destination, the estimated duration of the navigation route, and/or the cost to use the navigation route. In some embodiments, the electronic device displays an option to display the available public transportation navigation routes on a map and, in response to detecting selection of the option, displays the indications of available public transportation routes on the map as described above. In some embodiments, the electronic device displays an option to display the available cycling, walking, or driving navigation routes without the map and, in response to detecting selection of the option, displays the user interface elements with information about available cycling, walking, or driving routes without the map as described. Displaying available navigation routes for different modes of transportation in different formats enhances user interactions with the electronic device by presenting information likely to be relevant to the user with fewer user inputs.

It should be understood that the particular order in which the operations in FIG. 9 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 1100, and/or 1300) are also applicable in an analogous manner to method 900 described above with respect to FIG. 9. For example, the operation of the electronic device to display information on a map, including indications of locations described above with reference to method 900 optionally has one or more of the characteristics of the presentation of a visual indication of a walking radius while in a maps application, display of navigation directions in different formats while navigating using different modes of transportation, and performance of additional features while the electronic device is in a predetermined area described herein with reference to other methods described herein (e.g., methods 700, 1100, and/or 1300). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 9 are, optionally, implemented by components depicted in FIGS. 1A-1B. For example, receiving operation 902b and/or displaying operations 902d and/or 902e are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Displaying Navigation Instructions in Different Formats while Using Different Modes of Transportation in a Maps Application

Users interact with electronic devices in many different manners. In some embodiments, an electronic device displays navigation directions while navigating from a current location of the electronic device to a destination location of the electronic device. In some embodiments, the electronic device displays the navigation directions in various formats depending on the mode of transportation. In some embodiments, each mode of transportation includes multiple formats to display the navigation directions. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

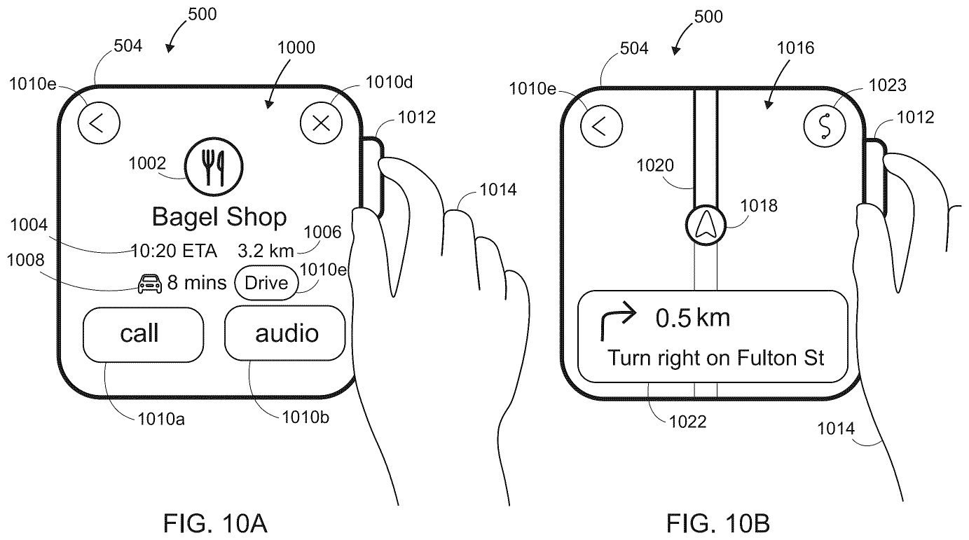

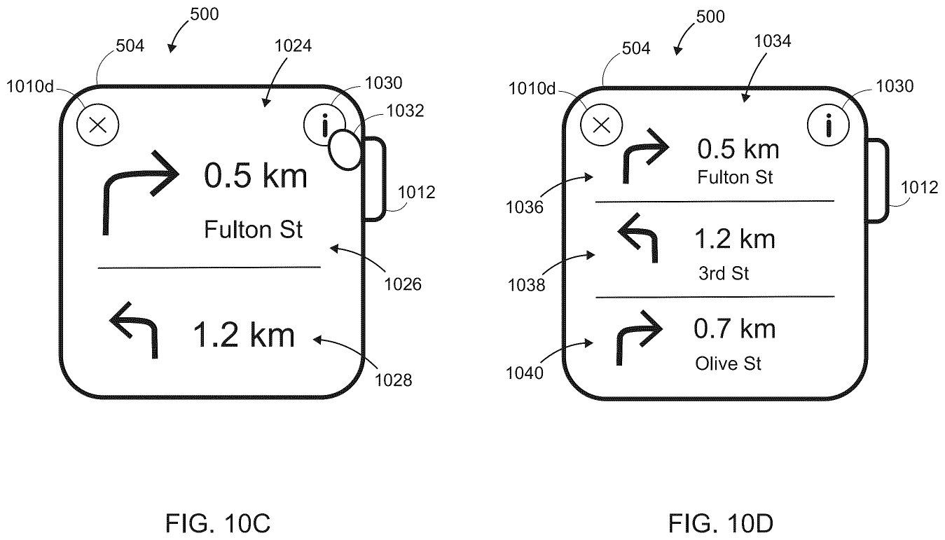

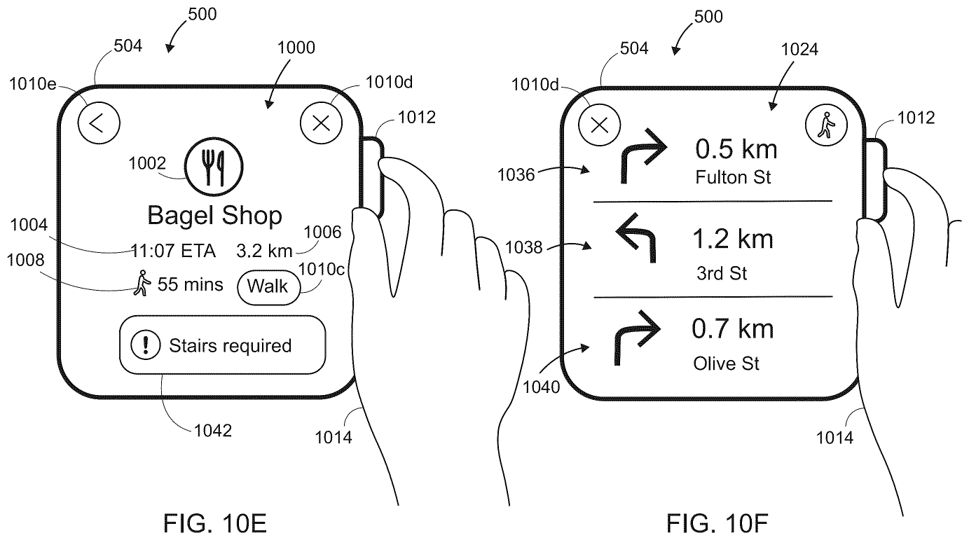

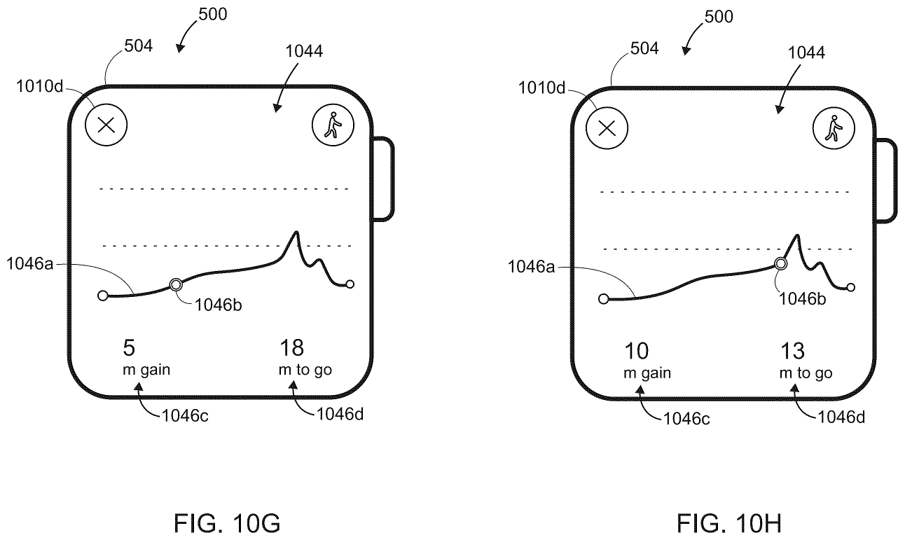

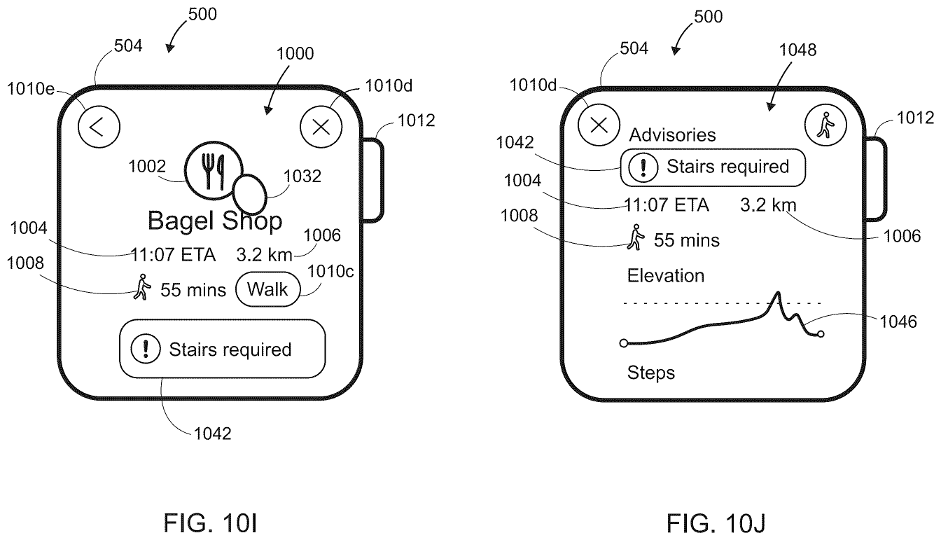

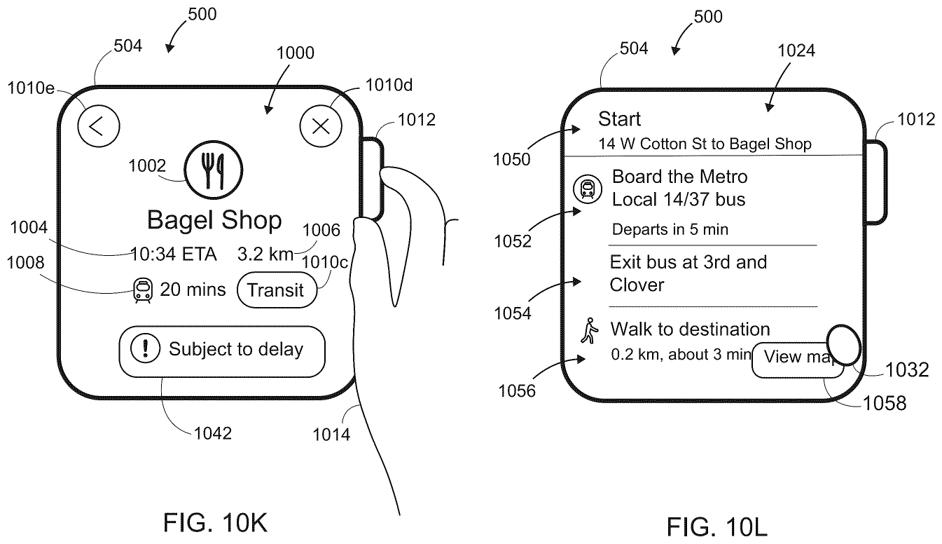

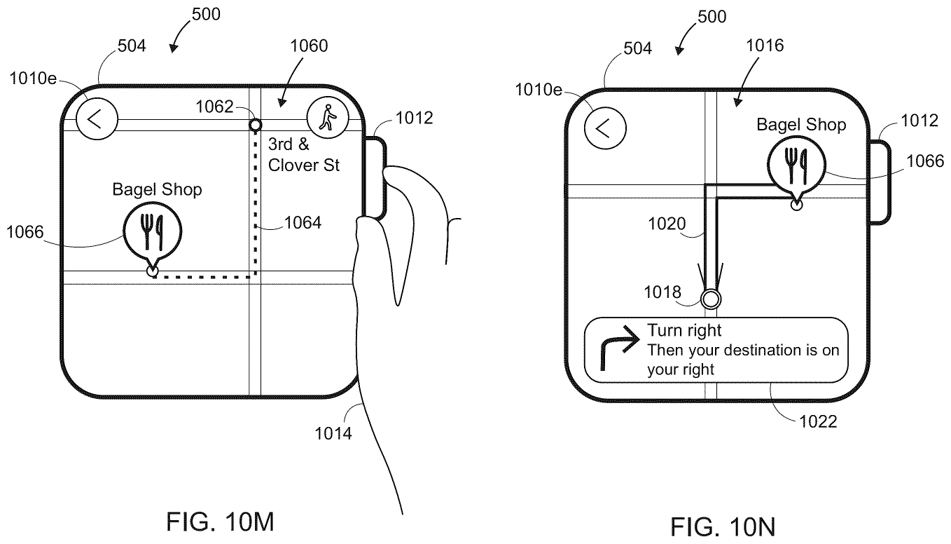

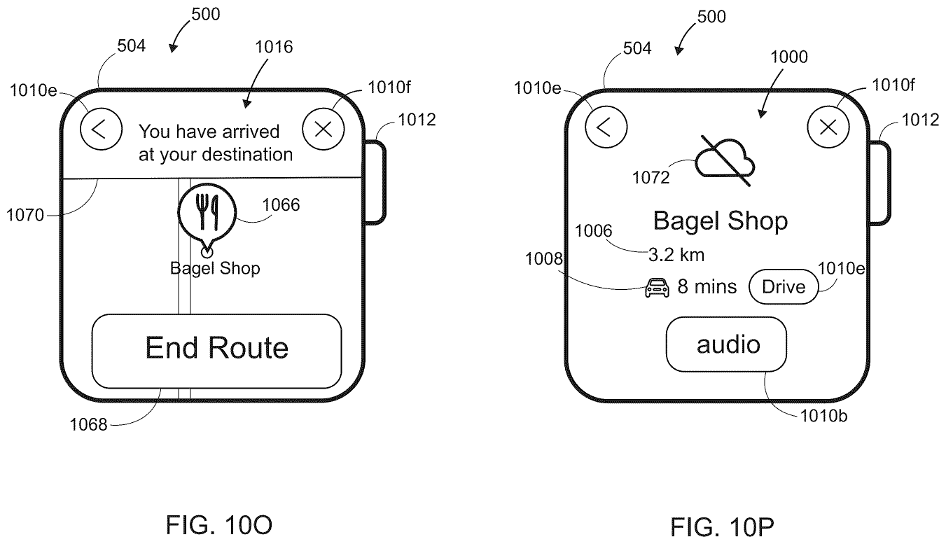

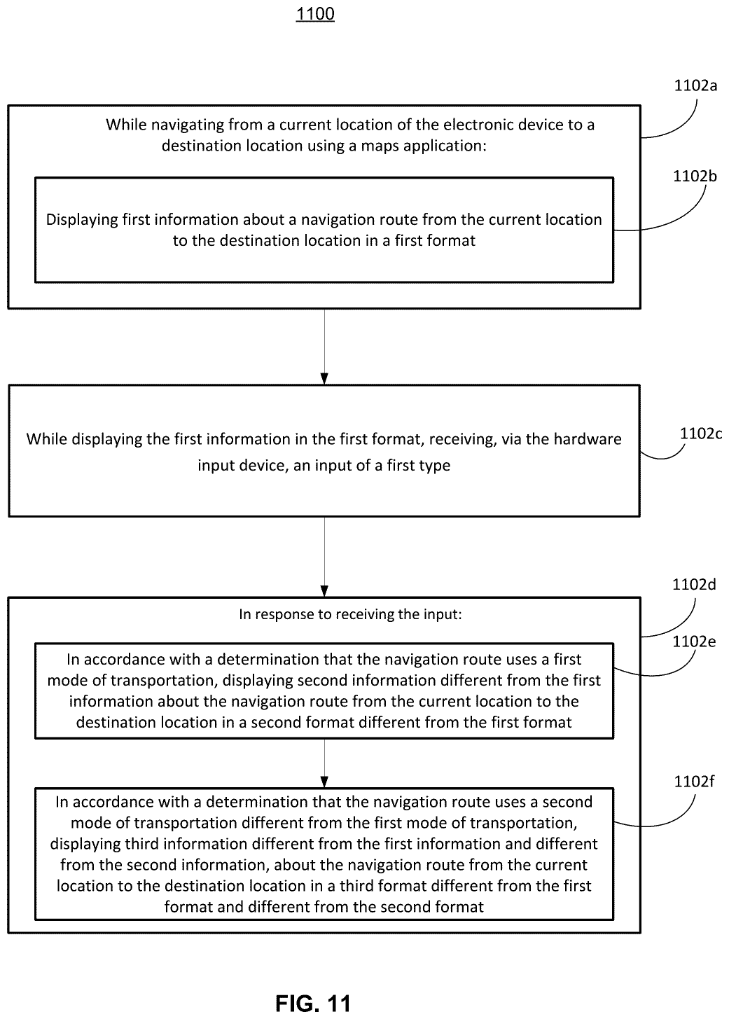

FIGS. 10A-10P illustrate exemplary ways in which an electronic device displays navigation directions in different formats while navigating using different modes of transportation. The embodiments in these figures are used to illustrate the processes described below, including the processes described with reference to FIG. 11. These figures are not meant to be limiting; other user interfaces are possible in accordance with method 1100 without departing from the scope of the disclosure.

FIG. 10A illustrates electronic device 500 displaying user interface 1000 (e.g., via a display device, via a display generation component, or via a touch screen 504). In some embodiments, user interface 1000 is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with electronic device 500. In some embodiments, electronic device 500 is a wearable device such as a smart watch. In some embodiments, the electronic device 500 includes a crown 1012. The electronic device 500 can receive inputs directed to the crown 1012, such as inputs that press the crown 1012 like a button and inputs that turn the crown 1012 like a dial.

In some embodiments, user interface 1000 is a user interface of a maps application. In some embodiments, user interface 1000 and the following user interfaces discussed in FIGS. 10A-10P are user interfaces of a maps application while presenting navigation directions using various modes of transportation (e.g., driving, walking, biking, or public transportation). In some embodiments, user interface 1000 in FIG. 10A is an overview user interface that is configured to display information about the navigation route in a first format for driving navigation directions, as described in method 1100. For example, user interface 1000 includes an indication 1002 of the destination location. Indication 1002 optionally includes a visual representation of the type of location the destination location is (e.g. a restaurant, bar, gas station, hiking trail, or hotel). For example, indication 1002 includes an image of knife and fork, corresponding to the navigation destination being a restaurant. In some embodiments, indication 1002 includes a textual description (“Bagel Shop”) of the destination location, such as the name of the destination location. In some embodiments, user interface 1000 also includes an indication 1004 of the estimated time of arrival at the navigation destination based the mode of transportation and the navigation route. For example, the estimated time of arrival in FIG. 10A is 10:20, while driving. In some embodiments, user interface 1000 also includes an indication 1006 of the distance (e.g., in miles or in kilometers) to the destination location based on the mode of transportation and the navigation route. In some embodiments, user interface 1000 also includes an indication 1008 of the mode of transportation. For example, the indication 1008 is a visual indication of a car for the driving mode of transportation. In some embodiments, indication 1008 also includes a time to the destination location. For example, in FIG. 10A, while in the driving mode of transportation, the drive time is 8 minutes. In some embodiments, user interface 1000 includes a plurality of selectable options 1010a through 1010e. In some embodiments, in response to detecting the selection of option 1010a, the electronic device 500 calls a phone number of the destination location (e.g., a phone number of a restaurant, gas station, hotel, and/or bar). In some embodiments, option 1010b is selectable to adjust the audio of the navigation instructions presented from electronic device 500. For example, selecting option 1010b optionally turns on verbal instructions. In some embodiments, while option 1010b is not selected, tactile feedback (e.g., vibrations) is used to provide navigational instructions about the route. In some embodiments, in response to detecting the selection of option 1010c, the electronic device 500 changes the mode of transportation of the current navigation. In some embodiments, in response to detecting the selection of option, the electronic device 500 cancels the current navigation. For example, the selection of option 1010d ceases the display of user interface 600 and displays a maps user interface of the maps application (e.g., a display of the map surrounding the current location). In some embodiments, in response to detecting the selection of option 1010e, the electronic device 500 returns to a home page of electronic device 500 or a different user interface of the maps application, while continuing to navigate to the destination location.

In some embodiments, electronic device 500 detects an input directed towards the crown 1012. In some embodiments, detecting the input includes detecting the user 1014 twisting the crown 1012, as described in method 1100. In some embodiments, in response detecting the input, electronic device 500 displays user interface 1016, as shown in FIG. 10B. In some embodiments, user interface 1016 is a user interface of the maps application that shows information about the navigation directions in a second format different from the format illustrated in FIG. 10A, as described with reference to method 1100.

In some embodiments, user interface 1016 includes map that includes an indication 1018 of a current location of the electronic device 500 and an indication 1020 of the navigation route currently being traveled by electronic device 500. For example, indication 1012 optionally represents a road, highway, or trail included in the navigation route. In some embodiments, a portion of indication 1012 is emphasized (e.g., highlighted, bolded, and/or otherwise colored differently than the other indications of the user interface 1016), which represents an upcoming portion of the navigation route. In some embodiments, user interface 1016 includes an indication 1022 of an upcoming maneuver of the navigation route. In some embodiments, indication 1022 includes a visual indication representing the upcoming maneuver (e.g., a right turn arrow, a left turn arrow, a straight arrow, or a u-turn arrow). FIG. 10B includes a right turn arrow representing a right turn as the next upcoming maneuver. In some embodiments, indication 1022 also includes a textual description of the upcoming maneuver. For example, the textual description includes a distance until the upcoming maneuver (“0.5 mi”), and a description of the upcoming maneuver (“Turn right on Fulton St”). In some embodiments, user interface 1016 includes a selectable option 1023, that, when selected, causes the electronic device 500 to display an overview of the navigation route. For example, the overview of the navigation route includes the navigation route highlighted on a map.

In some embodiments, electronic device 500 detects an input directed towards the crown 1012. In some embodiments, detecting the input includes detecting the user 1014 twisting the crown 1012, as described in method 1100. In some embodiments, twisting the crown 1012 clockwise cycles the user interfaces discussed below in one direction and twisting the crown 1012 counterclockwise cycles the user interfaces discussed below in another direction. In some embodiments, in response detecting the input, electronic device 500 displays user interface 1024, as shown in FIG. 10C. In some embodiments, user interface 1024 is a user interface of the maps application that shows information about the navigation directions in a third format, as described with reference to method 1100.

As shown in FIG. 10C, in some embodiments, user interface 1024 includes indications 1026 and 1028 of upcoming maneuvers included in the navigation directions. For example, in FIG. 10C, the electronic device 500 displays indications 1026 and 1028 of two upcoming maneuvers. In some embodiments, the electronic device 500 displays a different number of maneuvers in user interface 1024. In some embodiments, the user interface 1024 is not scrollable. In some embodiments, user interface 1024 includes an indication 1026 of the next upcoming maneuver in the navigation directions and an indication 1028 of the following upcoming maneuver (the maneuver after the maneuver indicated by indication 1026) in the navigation directions.

In some embodiments, indication 1026 has one or more characteristics of indication 1022, as described in FIG. 10B. In some embodiments, indication 1028 includes less information about the respective maneuver than the amount of information included in indication 1026. For example, indication 1028 includes a textual description of the distance to the maneuver (e.g., “1.2 km”) but not the location at which the maneuver occurs. In some embodiments, indication 1028 includes a visual indication of the maneuver (e.g., arrow pointing left), such as described in FIG. 10B. In some embodiments, once electronic device 500 completes the maneuver indicated by indication 1024, the electronic device 500 ceases display of indication 1024 and displays indication 1028 at the location of previously-displayed indication 1024. While indication 1028 is displayed in the location of previously-displayed indication 1024, the electronic device 500 optionally updates indication 1028 to have one or more characteristics of indication 1022, such as including a text description of the location of the maneuver. In some embodiments, while displaying indication 1028 at the location of indication 1026 in FIG. 10C, the electronic device 500 concurrently displays a different indication of a maneuver after the maneuver indicated by indication 1028 in the navigation directions at the location of indication 1028 in FIG. 10C with one or more characteristics of indication 1028 in FIG. 10C. For example, the indication of the maneuver after the maneuver indicated by indication 1028 includes an icon representing the maneuver and a text indication of the distance between the maneuver indicated by indication 1028 and the next maneuver.

In some embodiments, user interface 1024 includes a selectable option 1030, that, when selected, causes the electronic device 500 to display a user interface 1034 including a scrollable list of indications of upcoming maneuvers. In some embodiments, electronic device 500 detects an input selecting option 1030 with contact 1032 (e.g., of a finger on touch screen 504). In response to detecting the selection of option 1030 in FIG. 10C, electronic device 500 displays user interface 1034, as shown in FIG. 10D. In some embodiments, an input directed to the crown 1012, such as the crown 1012 being turned like a dial, while the electronic device 500 displays the user interface in FIG. 10C also results in the display of user interface 1034 in FIG. 10D.

FIG. 10D includes a plurality of indications (e.g., indications 1036, 1038, and 1040) of upcoming maneuvers included in the navigation directions. In some embodiments, and as described in method 1100, user interface 1034 includes a scrollable list of upcoming maneuvers. In some embodiments, 2, 3, 5, or 10 maneuvers are concurrently displayed in the user interface. In some embodiments, user interface 1034 includes indications 1036, 1038, and 1040 in a list format wherein the maneuver described in indication 1036 is the next upcoming maneuver in the navigation route, the maneuver described in indication 1038 follows the maneuver in indication 1036, and the maneuver described in indication 1040 follows the maneuver in indication 1038. In some embodiments, indications 1036, 1038, and 1040 include a visual indication of the maneuver (e.g., arrows), as described in FIG. 10B and a textual description of the maneuver. For example, the textual description includes the distance until the maneuver (“1.2 km”) and the location of the maneuver (“3^{rd} St”). In some embodiments, the distance until the next upcoming maneuver updates (e.g., indication 1036) as the electronic device 500 moves along the navigation route. In some embodiments, indications 1038 and 1040 do not update until they become the next upcoming maneuver. In some embodiments, in response to a scroll input, such as a swipe on the touch screen 504 or a twist of crown 1012, electronic device 500 displays additional maneuvers in the list of maneuvers on user interface 1034. For example, additional maneuvers optionally include further upcoming maneuvers or previously performed maneuvers.

While displaying the user interfaces described herein, a home screen user interface, such as described in method 1100, is optionally displayed in response to a selection input (e.g., pressing down) of the crown 1012 of the electronic device 500.

FIG. 10E illustrates user interface 1000 for navigation directions in a walking mode of transportation. FIG. 10E has one or more characteristics of FIG. 10A, as described above. However, while navigating using the walking mode of transportation, indication 1004 indicates an estimated time of arrival for walking (“11:7”), and indication 1008 includes a visual indication of a person and an estimated time to the destination location based on the walking mode of transportation. For example, FIG. 10E illustrates that while in a walking mode of transportation, the walk time to the destination location (“Bagel Shop”) is 55 minutes. In some embodiments, option 1010c includes an indication of the mode of transportation. For example, in FIG. 10E, option 1010c includes text (“Walk”) indicating that the mode of transportation is walking. In some embodiments, user interface 1000 also includes indication 1042. In some embodiments, indication 1042 indicates an advisory on the navigation route, as described in further detail in method 1100. For example, in FIG. 10E, indication 1042 includes a textual description indicating that there are stairs required on the navigation route. In some embodiments, if the navigation route has a different advisory, then indication 1042 would indicate the other advisory. In some embodiments, if the navigation route does not include advisories, the electronic device 500 forgoes displaying indication 1042. In some embodiments, indication 1042 is displayed while navigating in a mode of transportation different form walking. In some embodiments, indication 1042 includes advisories such as slowdowns (e.g., accidents, train delays, and/or detours), hazards (e.g., no bike lane) and/or accessibility notices (e.g., stairs required). In some embodiments, types of advisories vary depending on the mode of transportation.

In some embodiments, electronic device 500 detects an input directed towards the crown 1012. In some embodiments, detecting the input includes detecting the user 1014 twisting the crown 1012, as described in method 1100. In some embodiments, in response detecting the input, electronic device 500 displays user interface 1024, as shown in FIG. 10F. In some embodiments, FIG. 10F has one or more characteristics of FIG. 10D. For example, the electronic device 500 displays indications 1036, 1038, and 1040 of maneuvers included in the navigation directions in a scrollable list in FIG. 10F. In some embodiments, while displaying user interface 1024 while in a walking mode of transportation, electronic device 500 detects an input directed towards the crown 1012 such as detecting the user 1014 twisting the crown 1012, as described in method 1100. In response to the input shown in FIG. 10F, electronic device 500 displays user interface 1044, as shown in FIG. 10G.

FIG. 10G illustrates user interface 1044, which includes information about the navigation route in a different format than the format shown in FIGS. 10E-10F, including information about the elevation profile of the navigation route, as described in method 1100. In some embodiments, user interface 1044 includes an indication 1046a of the elevation profile of the navigation route (e.g., a graph of the elevation profile along the route). In some embodiments, the graph of elevation profile includes the distance along the navigation route on the x-axis and the elevation on the y-axis. In some embodiments, indication 1046b is an indication of the current location of the electronic device 500 displayed at a location within indication 1046a that corresponds to the location of the electronic device 500 within the navigation route. In some embodiments, indication 1046c indicates the elevation gain of the electronic device 500 (e.g., the elevation already gained while on the navigation route). In some embodiments, indication 1046d indicates the elevation gain remaining on the navigation route for electronic device 500.

In some embodiments, in response to movement of the electronic device 500 along the navigation route, electronic device 500 updates indications 1046b through 1046d on user interface 1044, as described in method 1100. For example, as the current location of electronic device 500 moves further on the navigation route, the electronic device 500 updates the position of indication 1046b on indication 1046a accordingly. In some embodiments, indication 1046b updates in real time as electronic device 500 moves. In some embodiments, indications 1046c through 1046d update in response to the movement of electronic device 500. For example, in FIG. 10H, indication 1046c reads “10 ft gain” in response to the electronic device 500 moving 5 ft in elevation and indication 1046d reads “13 ft to go” in response to the electronic device 500 moving 5 ft in elevation. As shown in FIG. 10H, the position of indication 1046b is at a different position relative to indication 1046a representing the electronic device 500 having moved further along the navigation route.

FIG. 10I illustrates the user interface 1000 for a walking mode of transportation, which is described in further detail in FIG. 10E, and in method 1100. In some embodiments, in response to a selection of indication 1002, the electronic device 500 displays detailed information about the navigation route in the walking mode of transportation. In some embodiments, electronic device 500 detects an input selecting indication 1002 with contact 1032. In response to the input, electronic device 500 displays user interface 1048, as shown in FIG. 10J. In some embodiments, user interface 1048 is a user interface including information about the navigation route. In some embodiments, user interface 1048 is an expanded user interface of user interface 1000 shown in FIG. 10I. For example, user interface 1048 shown in FIG. 10J includes indications 1004, 1006, 1008, 1042, and 1046, which are also shown in user interface 1000 (as described in FIGS. 10A and 10E), or user interface 1044 (as described in FIGS. 10G-H). In some embodiments, in response to a scroll input, such detecting turning of crown 1012, or a swipe input on the touch screen 504, additional information about the navigation route is displayed. For example, in response to the input, indications about the upcoming maneuvers are displayed (e.g., similar to indications 1036, 1038, and 1040 in FIG. 10D. In some embodiments, in response to the input, electronic device 500 displays some or all of the maneuvers on the navigation route in user interface 1048.

FIG. 10K illustrates an example user interface 1000 for presenting public transportation navigation directions. In some embodiments, a public transportation mode of transportation includes the use of trains, buses, subways. In some embodiments, the public transportation mode of transportation includes walking and/or biking to move from one public transportation option to another (e.g., walking between bus stops). In some embodiments, FIG. 10K has one or more characteristics of FIG. 10A and FIG. 10E, as described above. In some embodiments, in a public transportation mode of transportation, indication 1004 indicates an estimated time of arrival at the navigation destination using public transportation (“10:34”), and indication 1008 includes a visual indication of a train to represent public transportation and an estimated duration of the navigation route using public transportation. For example, the user interface 1000 in FIG. 10K indicates that, while using a public transportation, the estimated time to travel to the destination location (“Bagel Shop”) is 20 minutes. In some embodiments, option 1010c indicates the mode of transportation for the navigation directions (e.g., the text label “transit”). For example, in FIG. 10K, option 1010c includes text (“Transit”) indicating that the mode of transportation is public transportation. In some embodiments, user interface 1000 also includes indication 1042, which indicates advisories on the navigation route, as described in FIG. 10E and in method 1100.

In some embodiments, electronic device 500 detects an input directed towards the crown 1012. In some embodiments, detecting the input includes detecting the user 1014 twisting the crown 1012, as described in method 1100. In some embodiments, in response detecting the input shown in FIG. 10K, electronic device 500 displays user interface 1024, as shown in FIG. 10L. In some embodiments, and as discussed in FIG. 10D and FIG. 10F, user interface 1024 includes a plurality of indications 1052, 1054, and 1056 of upcoming route segments. In some embodiments, when navigating using public transportation, the electronic device 500 presents indications of route segments, which may include one or more maneuvers. In some embodiments, the route segments indicate when the navigation directions include changing public transportation lines and/or modes of transportation. For example, a first segment of a public transportation navigation route uses a first public transportation line and/or mode of transportation and a second segment of a public transportation navigation route uses a different public transportation line and/or different mode of transportation. In some embodiments, indication 1050 describes the starting location (e.g., the current location) of the navigation route. In some embodiments, indication 1052 describes a first upcoming route segment. For example, once electronic device 500 leaves the starting location, the next route segment uses a bus line, so the electronic device 500 displays instructions to “board the Metro local 14/37 bus”. In some embodiments, indication 1052 includes a visual representation of the type of transportation the first route segment uses. For example, indication 1052 instructs the user to board a bus, so the visual representation is a visual representation of a bus. In some embodiments, indication 1052 includes a relevant time indication, such as an estimated time of arrival of the bus to the bus station. In some embodiments, indication 1054 indicates the second upcoming route segment. For example, indication 1054 includes a textual description indicating the exit location to exit the bus (“Exit bus at 3^{rd} and Clover”). In some embodiments, indication 1054 includes one or more characteristics of indication 1052. In some embodiments, indication 1054 does not include an estimated time of arrival of the bus or a visual indication of a bus, because indication 1054 is optionally a route segment relating to the first upcoming route segment (e.g., getting off the bus). In some embodiments, indication 1056 indicates a third upcoming route using a different mode of transportation. In some embodiments, indication 1056 includes one or more characteristics of indication 1052. For example, indication 1056 includes a visual representation of the type of transportation (e.g., a walking person), a textual description describing the route segment, and a relevant time/distance indication (e.g., the distance to the destination, and an estimated time to arrival at the destination location).

In some embodiments, walking route portions include multiple maneuvers the user is responsible for executing. In some embodiments, the user interface 1024 in FIG. 10L further includes indications of the maneuvers included in the walking route segment, such as within indication 1056. In some embodiments, as shown in FIG. 10L, the user interface 1024 does not include indications of the maneuvers included in the walking route segment. In some embodiments, user interface 1024 includes a selectable option 1058 that, when selected, causes the electronic device 500 to display user interface 1060, an overview of non-public transportation portions of the navigation route (e.g., walking or biking), as shown in FIG. 10M. In some embodiments, in FIG. 10L, electronic device 500 receives an input selecting option 1058 (e.g., with contact 1032). In response to receiving the input in FIG. 10L, electronic device 500 displays user interface 1060, shown in FIG. 10M.

FIG. 10M illustrates user interface 1060 indicating a walking portion of public transportation navigation directions. In some embodiments, user interface 1060 includes a map including a visual indication 1064 of a walking portion of a public transportation navigation route. In FIG. 10M, the walking maneuver is illustrated in the user interface 1060. In some embodiments, in response to a swipe input using contact 1032 or a twist maneuver directed to the crown 1012, user interface 1060 displays an indication of a different upcoming route segment (e.g., the first upcoming route segment or the second upcoming route segment) on the map. In some embodiments, indication 1062 indicates the beginning of an upcoming route segment. In some embodiments, indication 1062 includes a textual description, such as a label, of a location of the upcoming maneuver (“3^{rd} & Clover St”). In some embodiments, indication 1064 includes an indication of an upcoming maneuver included in the route segment. For example, in FIG. 10M the electronic device 500 displays indication 1064 as a dotted line indicating that the upcoming route segment includes a right turn. In some embodiments, indication 1064 includes various line types and thickness (e.g., bolded line, colored line, and/or a different type of dotted line) to indicate different modes of transportation and/or different public transportation types for each upcoming route segment.

In some embodiments, the user interface 1060 further includes an indication 1066 of the end of the upcoming route segment. In some embodiments, indication 1066 includes a visual representation of the destination location, similar to indication 1002. In some embodiments, because the route segment shown in user interface 1060 is the last route segment in the navigation directions, as shown in FIG. 10M, indication 1066 includes a visual indication and/or textual description of the destination location. For example, indication 1066 includes a visual indication of a restaurant (e.g., a fork and knife icon) and a text description of the destination location (“Bagel Shop”).

In some embodiments, in response to receiving a twist input on crown 1012 from user 1014, as shown in FIG. 10M, electronic device 500 displays user interface 1016, as shown in FIG. 10N. As described above with reference to FIG. 10B, user interface 1016 includes information about the next maneuver (or route segment) in the navigation directions, such as shown by indication 1022. In some embodiments, user interface 1016 includes the indication 1018 of the current location of electronic device 500. In some embodiments, user interface 1016 includes indication 1020 that indicates information about the navigation route the electronic device 500 is currently on, as described above with reference to FIG. 10B. In some embodiments, if the destination location is within the boundaries of the map, the destination location is displayed on user interface 1016. For example, the destination location is displayed with indication 1066 on user interface 1016. As described in FIG. 10M, indication 1066 includes a visual indication and a textual description of the destination location.

FIG. 10O illustrates an example of the electronic device 500 displaying user interface 1016 in response to the electronic device 500 arriving at the destination location. In some embodiments, in response to detecting the current location of electronic device 500 at (or within a threshold distance of) the destination location, the electronic device 500 displays user interface 1016, including indication 1070. As shown in FIG. 10O, indication 1070 includes a textual description indicating that the electronic device 500 is at the destination location. In some embodiments, user interface 1016 also includes the indication 1066 of the destination location, as described in FIG. 10M, at the center of the user interface 1016. In some embodiments, user interface 1016 also includes a selectable option 1068, that, when selected, causes the electronic device 500 to cease the navigation to the destination location, as described in method 1100. For example, in response to detecting selection of option 1068, the electronic device 500 displays a user interface of a map without information about a current navigation route. Alternatively, in some embodiments, in response to detecting selection of option 1068, the electronic device 500 displays a home screen user interface in response to a selection input 1068. In some embodiments, in response to detecting selection of option 1068, the electronic device 500 begins navigation to a second location, as described in method 1100.

In some embodiments, the electronic device 500 is able to present navigation directions without access to the internet if the necessary maps are stored on the electronic device 500 or on another electronic device in communication with the electronic device 500 using a connection other than an internet connection. FIG. 10P illustrates an example of user interface 1000 when electronic device 500 does not have internet connectivity (e.g., in an area without service such as a tunnel or a remote location). In some embodiments, as described in method 1100, electronic device 500 uses map information transmitted from a second electronic device to navigate to the destination location. In some embodiments, the map information is available if the map information is downloaded on the second electronic device while the electronic device 500 does not have access to the internet. In some embodiments, navigation directions are unavailable if the map information is not downloaded and the electronic device 500 does not have access to the internet. In some embodiments, electronic device 500 uses map information transmitted from the second electronic device when there is no internet connectivity. Alternatively, in some embodiments, electronic device 500 uses map information transmitted from the second electronic device when with or without internet connectivity. In some embodiments, electronic device 500 and second electronic device communicate using wireless communication methods such as Bluetooth or Wi-Fi. In some embodiments, user interface 1000 displays an indication 1072 indicating that electronic device 500 does not have network connectivity. While the electronic device 500 does not have internet connectivity, indication 1004 and option 1010b shown in FIG. 10A are not displayed. In some embodiments, indication 1008 includes an estimated duration that does not factor in current conditions (e.g., traffic, detours, and/or accidents). In some embodiments, when network connectivity is restored, user interface 1000 displays the indications and selectable options shown in FIG. 10A.

FIG. 11 is a flow diagram illustrating a method in which an electronic device displays navigation directions in different formats while navigating using different modes of transportation according to some embodiments of the disclosure. The method 1100 is optionally performed at first and/or electronic devices such as device 100, device 300, or device 500 as described above with reference to FIGS. 1A-1B, 2-3, 4A-4B and 5A-5C. Some operations in method 1100 are, optionally combined and/or order of some operations is, optionally, changed.

As described below, the method 1100 provides ways in which an electronic device displays navigation directions in different formats while navigating using different modes of transportation. Displaying navigation directions in different formats while navigating using different modes of transportation makes content that the user may be interested in viewing easily accessible, thus reducing the number of inputs needed to view relevant information, thereby reducing power usage and improving the battery life of the electronic device.

In some embodiments, method 1100 is performed at an electronic device in communication with a display generation component and one or more input devices. In some embodiments, the electronic device is the electronic device described above with reference to one or more of method(s) 700, 900, and/or 1300. In some embodiments, the display generation component is the display generation component described above with reference to one or more of method(s) 700, 900, and/or 1300. In some embodiments, the one or more input devices are the one or more input devices described above with reference to one or more of method(s) 700, 900, and/or 1300.

In some embodiments, method 1100 is performed at an electronic device in communication with one or more input devices including a hardware input device and a display generation component. In some embodiments, the electronic device has one or more of the characteristics of the electronic device of method(s) 700 and/or 900. In some embodiments, the display generation component has one or more of the characteristics of the display generation component of method(s) 700 and/or 900. In some embodiments, the one or more input devices have one or more of the characteristics of the one or more input devices of method(s) 700 and/or 900. In some embodiments, method 1100 is performed at or by an automobile (e.g., at an infotainment system of an automobile having or in communication with one or more display generation components and/or input devices).

In some embodiments, the electronic device (e.g., electronic device 500 shown in FIG. 10A) navigates (1102a) from a current location of the electronic device to a destination location using a maps application. In some embodiments, the electronic device initiates navigation from a current location of the electronic device to a destination location in response to receiving an input. The input optionally includes interactions with one or more user interface elements in the maps application. For example, the electronic device detects a swipe gesture (e.g., in which an index finger of a hand touches down and moves across a touch sensitive display component), a tap gesture (e.g., in which an index finger of a hand touches a touch-sensitive display component), and/or an input via a hardware input device directed towards a selectable option or a user interface object in the maps app. In some embodiments, navigating from the current location to the destination location includes the electronic device providing audio and/or visual navigation instructions to the destination location.

In some embodiments, the electronic device displays (1102b) first information about a navigation route from the current location to the destination location in a first format, such as with user interface 1000, shown in FIG. 10A. In some embodiments, the first information includes images corresponding to the navigation route (e.g., graphical representation of the navigation route and/or maps) and information depending on the mode of transportation of the navigation route, described in greater detail below. In some embodiments, the information includes one or more of text and/or images communicating upcoming maneuvers (e.g., turns or merges from one road or path to another) in the navigation route. In some embodiments, the first format is a first layout of the first information in the user interface and/or the types (e.g., map, non-map image, text, and/or icons) of displayed information.

In some embodiments, while displaying the first information in the first format, the electronic device receives (1102c), via the hardware input device (e.g., a controller, crown, or dial), an input of a first type, such as the user 1014 turning crown 1012, shown in FIG. 10A. In some embodiments, the input is a directional input (e.g., not an input selecting a user interface element corresponding to the navigation information in the second format or the third format described below). In some embodiments, the input includes rotation of the hardware input device (e.g., with is a mechanical input element that is rotatable). For example, a clockwise twist of the hardware input device optionally displays a second information in place of the first information and a counter-clockwise twist of the hardware input device optionally displays the first information in place of the second information. In some embodiments, the input includes pushing down on the hardware input device (e.g., pushing down on a dial or a crown). Alternatively, in some embodiments, the electronic device optionally receives the input via a voice input captured by a microphone or a touch input on the touch sensitive display, as described above.

In some embodiments, in response to receiving the input (1102d), in accordance with a determination that the navigation route uses a first mode of transportation (e.g., walking, biking, driving, or transit), the electronic device displays (1102e) second information different from the first information about the navigation route from the current location to the destination location in a second format different from the first format, such as user interface 1016 shown in FIG. 10B. In some embodiments, the second information includes details about the navigation route as a function of the first mode of transportation. In some embodiments, the second information includes other images corresponding to the navigation route different than the images in the first information. In some embodiments, the second information is different from the first information in the type(s) of information (e.g., current location, estimated time of arrival, distance remaining, estimated duration remaining, one or more upcoming maneuvers, or a map of a portion of the route) included. In some embodiments, the second information is different from the first information in the level of detail of the information or the amount of information included.

In some embodiments, in accordance with a determination that the navigation route uses a second mode of transportation different from the first mode of transportation, the electronic device displays (1102f) third information different from the first information and different from the second information, about the navigation route from the current location to the destination location in a third format different from the first format and different from the second format, such as user interface 1024 shown in FIG. 10L. In some embodiments, the electronic device is continuing to provide audio and/or visual navigation directions to the destination location in response to the input. In some embodiments, the mode of transportation determines the information that is displayed on the electronic device and the format in which the information is displayed. In some embodiments, the third information includes details about the navigation route as a function of the second mode of transportation, as described below. In some embodiments, while navigating in a driving mode, the electronic device toggles displaying information about the navigation route in an overview format, a map format, and a list format for the navigational route, as described in more detail below. In some embodiments, while navigating in a walking or cycling mode, the electronic device toggles displaying information about the navigation route in an overview format, a list format, and an elevation/map format. In some embodiments, while navigating in a transit mode, the electronic device toggles displaying information about the navigation route in an overview format, list format, and a walking format. In some embodiments, while using the first mode of transportation, the third information in the third format is unavailable. In some embodiments, while using the second mode of transportation, the second information in the second format is unavailable. Displaying information in different formats while in different modes of transportation provides quick and efficient access to relevant content without the need for additional inputs and thereby reducing erroneous inputs to the electronic device.

In some embodiments, while navigating from a current location of the electronic device to a destination location using a maps application and while displaying the first information in the first format, the electronic device receives, via the hardware input device, a second input of a second type different from the first type, such as if hand 1014 were to press down on crown 1012 in FIG. 10B. In some embodiments, the second input includes a selection input, such as pushing down on the hardware input device (e.g., pushing down on a dial or a crown). In some embodiments, the second input includes pressing down on a touch-sensitive surface. In some embodiments, the electronic device displays the system user interface (e.g., a home screen) regardless of whether the first information, the second information, or the third information is displayed.

In some embodiments, in response to receiving the second input, the electronic device ceases display of the first information about the navigation route in the first format, such as if a user interface of a home screen of electronic device 500 were displayed in response to the input. In some embodiments, ceasing the display of the first information includes ceasing the display of a map and other images corresponding to the navigation route (e.g., a highlighted route on a map). In some embodiments, ceasing display of the first information includes ceasing display of a user interface associated with the maps application. In some embodiments, ceasing display of the first information does not includes ceasing the navigation from the current location of the electronic device to the destination location. For example, while navigating to the destination location and not displaying a user interface of the maps application, in accordance with a determination that the current location of the electronic device corresponds to an upcoming maneuver included in the navigation directions, the electronic device presents an indication of the maneuver, such as a visual, audio, and/or tactile indication. In some embodiments, the indication includes information about the maneuver, such as spoken audio and/or displayed images and/or text describing the maneuver.

In some embodiments, the electronic device displays, via the display generation component, a system user interface that is not a user interface of the maps application, such as a home screen user interface of electronic device 500. In some embodiments, the system user interface includes information different from the first information, the second information, and the third information. In some embodiments, the system user interface includes selectable options to display other user interfaces. For example, the system user interface includes icons to display user interfaces associated with one or more applications (e.g., maps, music, and/or photos application(s)). In some embodiments, the system user interface includes a selectable option to redisplay the first information about the navigation route in the first format. In some embodiments, the system user interface is a home screen user interface. The home screen user interface optionally has one or more characteristics of the home screen user interfaces described in FIG. 4a. Receiving different types of inputs that serve different functions provides quick and efficient access to relevant content thereby reducing erroneous inputs to the electronic device.

In some embodiments, displaying the first information in the first format includes displaying an indication of the destination location, such as indication 1002 in FIG. 10A (e.g., an icon and/or a label), an indication of an estimated time of arrival at the destination location, such as indication 1004 in FIG. 10A (e.g., in minutes and/or hours), an indication of a distance along the navigation route remaining to reach the destination location, such as indication 1006 in FIG. 10A (e.g., in miles, kilometers, feet, or meters), a first option that, when selected, causes the electronic device to place a phone call to a phone number associated with the destination location, such as option 1010a in FIG. 10A, and a second option that, when selected, causes the electronic device to change a setting related to audio indications of the navigation route, such as option 1010b in FIG. 10A (e.g., play audio on the electronic device or on a different electronic device). In some embodiments, the first information further includes an icon indicating the type of destination location. For example, an icon of a gas pump if the destination location is a gas station or an icon of a hiker if the destination location is a trail. In some embodiments, the first option and the second option are selectable options. The first option and the second option are optionally represented as buttons. In some embodiments, the first format includes an overview of the navigation route. The overview of the navigation route optionally includes the first information. In some embodiments, the first information about the navigation route includes an indication of the navigation route on a map in the maps application. For example, the navigation route is optionally highlighted on a map. In some embodiments, the first information includes advisories on the navigation route (e.g., hazards, delays, and/or accessibility notices). In some embodiments, the aforementioned indications and options are displayed in the second format including the second information or the third formation including the third information. In some embodiments, the first information in the first format is different from the information and formats described herein. Displaying the first and second option while displaying the first information provides quick and efficient access to relevant content without the need for additional inputs and thereby reducing erroneous inputs to the electronic device.

In some embodiments, displaying the first information in the first format includes displaying a map of a geographic area that includes a current location of the electronic device, such as indication 1018 in FIG. 10B, the map including an indication of the current location of the electronic device, and an indication of a portion of the navigation route, such as indication 1020 in FIG. 10B. In some embodiments, the electronic device displays the indication of the current location of the electronic device at the bottom center of the map of the geographic area. In some embodiments, the electronic device displays the indication of the current location of the electronic device at the center of the map of the geographic area. In some embodiments, smaller roads not on the navigational route are not shown in the map of the geographic area while the indication of the portion of the navigation route is shown. In some embodiments, the indication of the portion of the navigation route is shown as a visual emphasis overlayed on the map. For example, roads on the navigational route are shown with visual emphasis. For example, the roads in the navigational route are emphasized with a color (e.g., blue, green, or red) different than the roads not in the navigation route. For example, the roads in the navigation route are labeled (e.g., with the road name). In some embodiments, the indication of the current location of the electronic device includes a dot located on the map at the current location of the electronic device.

In some embodiments, a visual indication of an upcoming maneuver is included in the navigation route, such as indication 1022 in FIG. 10B. In some embodiments, maneuvers include left turns, right turns, and/or going straight past a potential turn. In some embodiments, the visual indication of the upcoming maneuver includes a visual indication of an arrow representing the maneuver. For example, an arrow curving to the right to represent a right turn. In some embodiments, if a second upcoming maneuver following the current upcoming maneuver is within a threshold distance of the current upcoming maneuver, the electronic device concurrently displays indications of both maneuvers. The threshold distance is optionally 50 m, 100 m, 200 m, or 500 m. For example, if the upcoming maneuver is turning right and the next upcoming maneuver is turning left 35 m after turning right, both visual indications of the maneuvers are displayed. In some embodiments, 1 or 2 or 3 upcoming maneuvers are displayed at the same time. In some embodiments, the aforementioned visual indication and map are displayed in the second format including the second information or the third formation including the third information. In some embodiments, the first information in the first format is different from the information and formats described herein. Displaying a visual indication of an upcoming maneuver concurrently with the map enhances user interactions with the electronic device by providing improved visual feedback to the user without requiring a user input.

In some embodiments, displaying the first information in the first format includes displaying a plurality of visual indications of a plurality of upcoming maneuvers, such as indication 1026 and indication 1028 in FIG. 10C, in the navigation route and a selectable option, such as option 1030 in FIG. 10C. In some embodiments, the selectable option is a button. In some embodiments, the selectable option is located in a corner of the display of the electronic device. In some embodiments, the first selectable option includes a label or other descriptor, such as an icon describing the result of selecting the selectable option. For example, the label is an icon that described that a selection of the selectable option includes showing a plurality of visual indications of a plurality of upcoming maneuvers.

In some embodiments, the electronic device receives, via the one or more input devices, an input selecting the selectable option, such as with contact 1032 on option 1030 in FIG. 10C. In some embodiments, the first input includes a user interaction with the first selectable option, such as tapping on a touch-sensitive screen (e.g., using a finger). In other embodiments, the first input includes a user interaction of the above user interactions with a crown or dial, such as clicking with the crown or dial and/or twisting with the crown and/or dial while input focus is directed to the selectable option.

In some embodiments, in response to receiving the input selecting the selectable option, the electronic device displays the plurality of visual indications of the plurality of upcoming maneuvers (e.g., indications 1036, 1038, and 1040 in FIG. 10D) and a second visual indication of a second upcoming maneuver different from the plurality of upcoming maneuvers in a scrollable list, such as indication 1038 in FIG. 10D. Prior to receiving the input, and in some embodiments, two upcoming maneuvers are displayed at the same time in a list that cannot be scrolled. In some embodiments, 1, 3, or 5 maneuvers are displayed at the same time in a list that cannot be scrolled prior to receiving the input. In some embodiments, prior to receiving the input, no maneuvers or only a subset (not all maneuvers) are displayed. In response to receiving the input, the electronic device optionally displays all maneuvers (e.g., upcoming, current, and previous) in a scrollable list. In some embodiments, 1, 2, 3, or 5, maneuvers are displayed at the same time in the scrollable list. Alternatively or additionally, in some embodiments, the electronic device displays all maneuvers in a scrollable list in response to receiving an input (e.g., rotating a crown of a hardware input device) with and/or without displaying the selectable option. In some embodiments, the aforementioned information is displayed in the second format including the second information or the third formation including the third information. In some embodiments, the first information in the first format is different from the information and formats described herein. Displaying a scrollable list of upcoming maneuvers provides quick and efficient access to relevant content without the need for additional inputs and thereby reducing erroneous inputs to the electronic device.

In some embodiments, displaying the first information in the first format includes displaying a first visual indication of an elevation of the navigation route along a distance of the navigation route, such as indication 1046a in FIG. 10G, with a second visual indication corresponding to the current location of the electronic device within the navigation route, such as indication 1046d in FIG. 10G. The first visual indication is optionally a graphical representation of the elevation on the navigation route. For example, the mileage is on the x axis and the elevation is on the y axis. In some embodiments, the first information is displayed in the first format while the mode of transportation includes walking or biking. In some embodiments, the second visual indication is a circle or dot representing the current location of the electronic device on the first visual indication. For example, a dot on a graph of the elevation representing the current location. In some embodiments, the aforementioned information is displayed in the second format including the second information or the third formation including the third information. In some embodiments, the first information in the first format is different from the information and formats described herein. Displaying the first and second visual indications while displaying the first information provides quick and efficient access to relevant content without the need for additional inputs and thereby reducing erroneous inputs to the electronic device.

In some embodiments, while the current location of the electronic device within the navigation route is a first location, the electronic device displays the first visual indication of the elevation of the navigation route along the distance of the navigation route including the second visual indication at a location of the first visual indication that corresponds to the first location of the electronic device, such as with indication 1046a and indication 1046b in FIG. 10G. In some embodiments, the second visual indication is overlayed on the first visual indication. In some embodiments, the second visual indication is at the location corresponding to the elevation and distance on the navigational route of the electronic device.

In some embodiments, the electronic device detects movement of the electronic device from the first location to a second location within the navigation route, such as shown by the movement of indication 1046b between FIG. 10G and 10H.

In some embodiments, while the current location of the electronic device within the navigation route is the second location, the electronic device displays the first visual indication of the elevation of the navigation route along the distance of the navigation route, such as indication 1046a in FIG. 10H, including the second visual indication at a location of the first visual indication that corresponds to the second location of the electronic device, such as indication 1046b in FIG. 10H. In some embodiments, the second visual indication updates in real time as the electronic device moves in distance and elevation of the navigational route. In some embodiments, a third visual indication is included in the first information displayed in the first format. The third visual indication is optionally a visual indication corresponding to the next upcoming maneuver, as discussed in further detail in below. Displaying a visual indication of the current location while displaying the elevation of the navigation route enhances user interactions with the electronic device by surfacing relevant information to the user with fewer inputs.

In some embodiments, navigating from the current location of the electronic device to the destination location includes the electronic device receiving, from a second electronic device in communication with the electronic device through a connection other than an internet connection (e.g., wireless connections such as Bluetooth, or wired connections), map data stored on the second electronic device, wherein the electronic device and the second electronic device are not connected to an internet connection, such as with user interface 1000 shown in FIG. 10P. In some embodiments, the map data is stored in a maps application similar to the maps application of the electronic device. In some embodiments, while using map data stored on the second electronic device, the electronic device shows an offline visual indication while in the maps application. In some embodiments, while the electronic device is in an area of the map wherein the second electronic device does not have the map data of the area and the electronic device is not connected to the internet, the map data ceases to be displayed. In some embodiments, while the map data is not displayed, the information about the navigation route also ceases to be displayed. In some embodiments, if the electronic device reconnects to the internet connection, the electronic device ceases to use the map data stored on the second electronic device and instead uses online map data from the internet. Using an offline map provided by a second electronic device while the electronic device is not connected to the internet provides efficient access to necessary information without the need for additional inputs thereby reducing erroneous inputs to the electronic device.

In some embodiments, while navigating from the current location of the electronic device to the destination location and while displaying the first information about the navigation route in the first format, the electronic device detects arrival of the electronic device at the navigation destination, such as shown with user interface 1016 in FIG. 10O. In some embodiments, detecting arrival of the electronic device includes detecting when the electronic device is within a threshold distance of the navigation destination. For example, the threshold distance may be 5 m, 1 m, or 0.1 m.

In some embodiments, in response to detecting arrival of the electronic device at the navigation destination, the electronic device displays fourth information about the navigation route in a fourth format including displaying an option that, when selected, causes the electronic device to cease navigation to the destination location, such as indication 1068 in FIG. 10O. In some embodiments, the electronic device switches to the fourth format (e.g., from the first, second or third formats) in response to an input such as the input of the first type as described above. In some embodiments, the fourth information about the navigational route includes information as a function of the current mode of transportation. In some embodiments, the fourth format includes a graphical representation of the navigational route. In some embodiments, the fourth format includes a portion of a map including the current location of the electronic device and an indication of the destination location. In some embodiments, a selection input, as discussed in above is used to select the option. In some embodiments, ceasing navigation to the destination location includes displaying a map in the maps application without the navigation route. In some embodiments, if the navigation route includes multiple destinations, displaying the fourth information includes displaying an option, that when selected, causes the electronic device to navigate to a second location (e.g., a second destination). Displaying an option to cease navigation when the electronic device arrives at the navigation destination provides quick and efficient access to relevant content without the need for additional inputs and thereby reducing erroneous inputs to the electronic device.

It should be understood that the particular order in which the operations in FIG. 11 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 900, and/or 1300) are also applicable in an analogous manner to method 1100 described above with respect to FIG. 11. For example, the operation of the electronic device to display navigation directions in different formats while navigating using different modes of transportation described above with reference to method 1100 optionally has one or more of the characteristics of the presentation of information on a map, including indications of locations, the presentation of a visual indication of a walking radius in a maps application, and the presentation of additional features while the current location of the electronic device is in a predetermined area described herein with reference to other methods described herein (e.g., methods 700, 900, and/or 1300). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 11 are, optionally, implemented by components depicted in FIGS. 1A-1B. For example, displaying operations 1102b, 1102e, and/or 1102f are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

### Performing Additional Features Associated with a Predetermined Area

Users interact with electronic devices in many different manners, including displaying maps of predetermined areas (e.g., hiking areas, as described herein) and maps outside of predetermined areas. In some embodiments, in accordance with a determination that the electronic device is currently in a predetermined area, the electronic device performs additional functions, such as presenting an indication that, when selected, causes the electronic device to display a map with indications of respective locations within the predefined area. Enhancing interactions with a device reduces the amount of time needed by a user to perform operations, and thus reduces the power usage of the device and increases battery life for battery-powered devices. It is understood that people use devices. When a person uses a device, that person is optionally referred to as a user of the device.

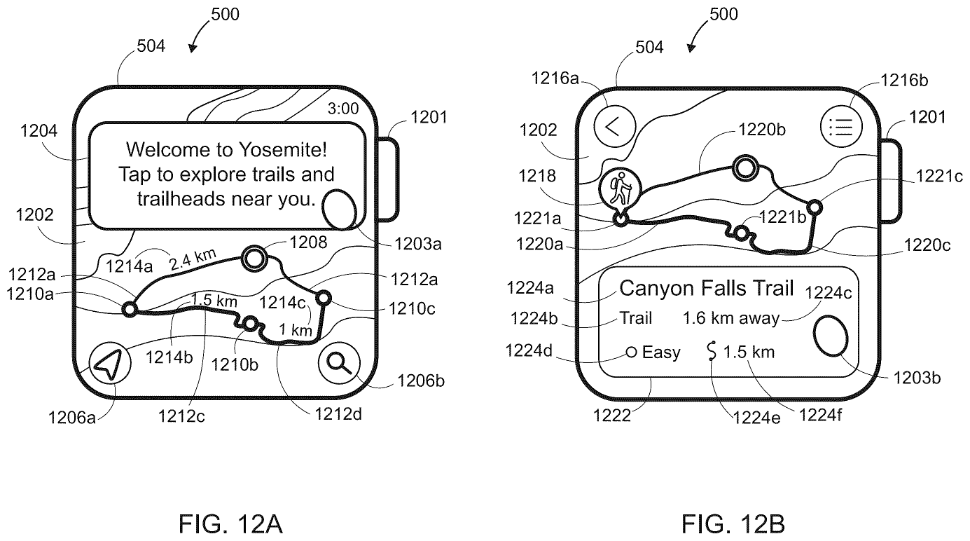

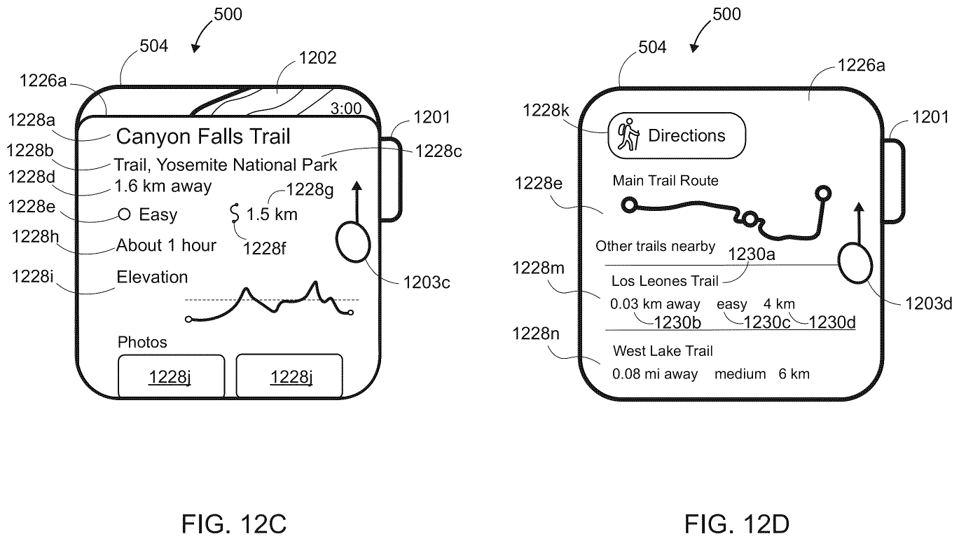

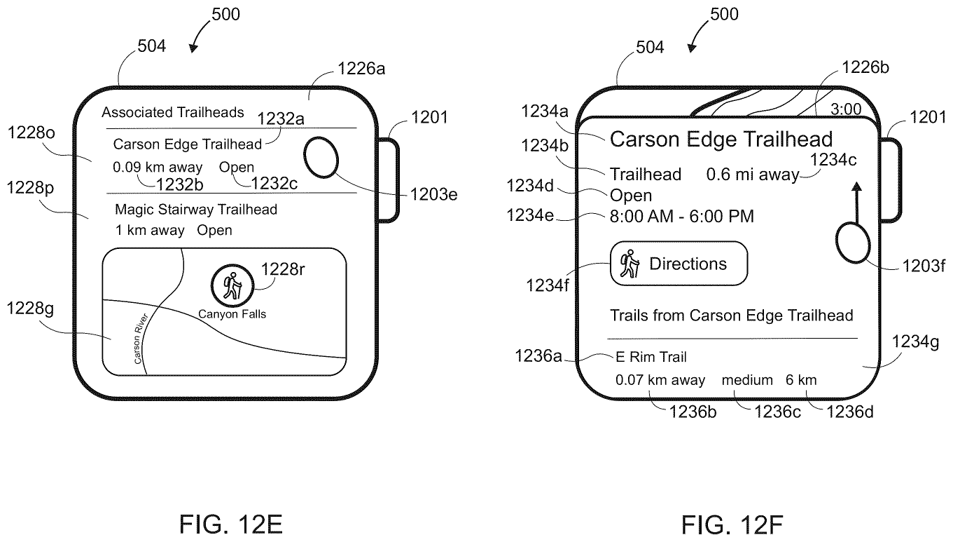

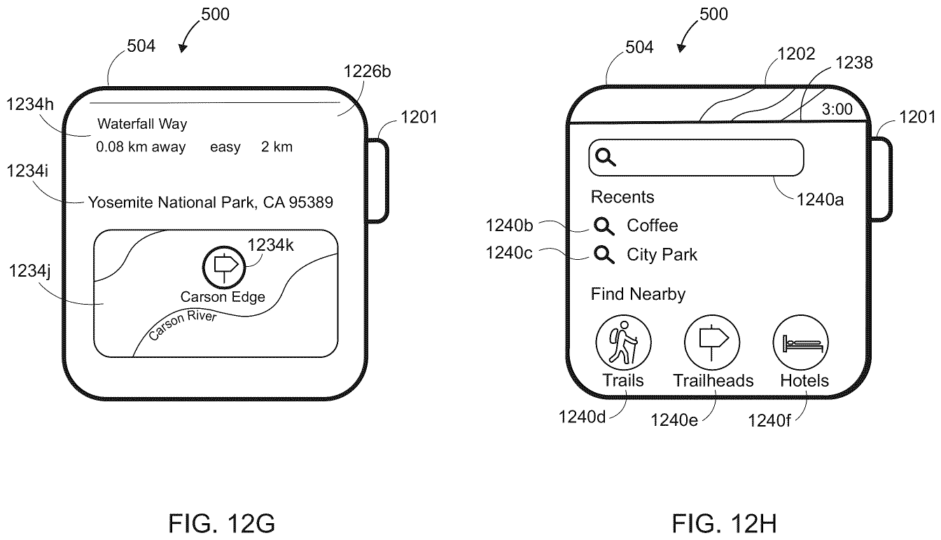

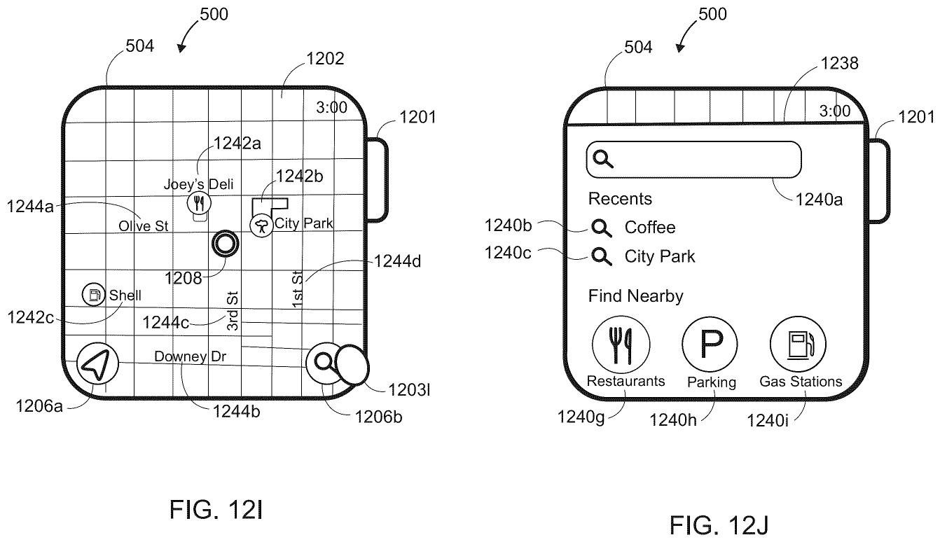

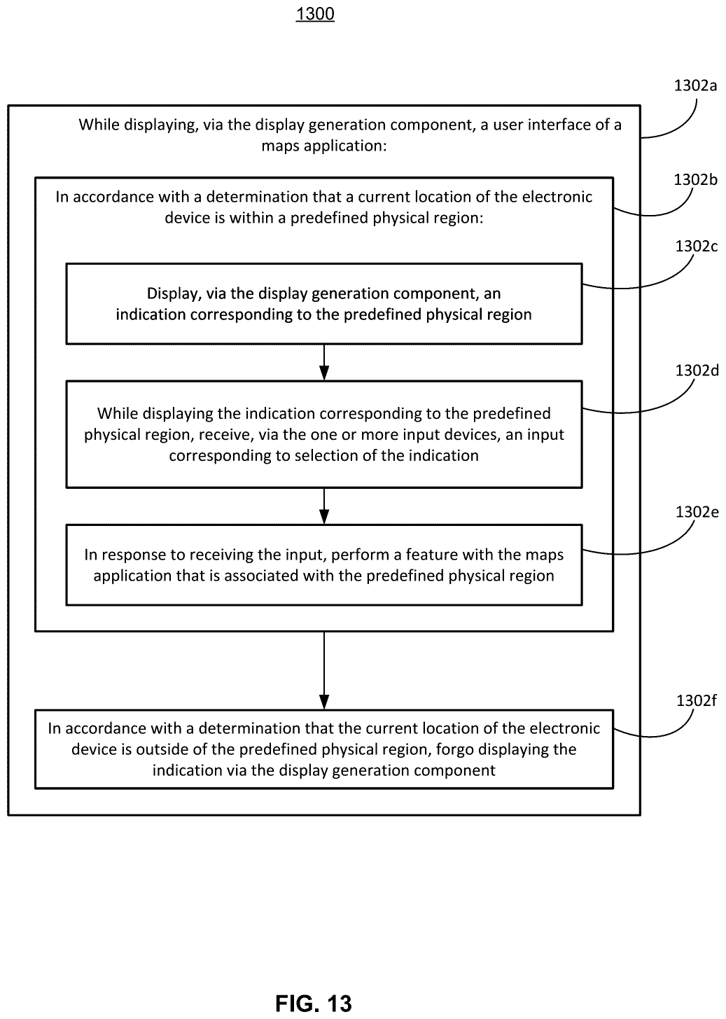

FIGS. 12A-12J illustrate exemplary ways in which an electronic device 500 performs additional features while the current location of the electronic device 500 is in a predetermined area according to some embodiments of the disclosure. For example, the predetermined area, is a hiking area, such a park or other area with hiking trails. The embodiments in these figures are used to illustrate the processes described below, including the processes described with reference to FIG. 13. These figures are not meant to be limiting; other user interfaces are possible in accordance with method 1300 without departing from the scope of the disclosure.

FIG. 12A illustrates electronic device 500 displaying user interface (e.g., via a display device, via a display generation component, or via a touch screen 504). In some embodiments, the user interface is displayed via a display generation component. In some embodiments, the display generation component is a hardware component (e.g., including electrical components) capable of receiving display data and displaying a user interface. In some embodiments, examples of a display generation component include a touch screen display (such as touch screen 504), a monitor, a television, a projector, an integrated, discrete, or external display device, or any other suitable display device that is in communication with device 500. In some embodiments, device 500 is a wearable device such as a smart watch. In some embodiments, the electronic device 500 includes a crown 1201. The electronic device 500 can receive inputs directed to the crown 1201, such as inputs that press the crown 1201 like a button and inputs that turn the crown 1201 like a dial.

As shown in FIG. 12A, the electronic device 500 displays a map 1202. For example, the current location of the electronic device 500 is in a hiking area, and the map 1202 has one or more characteristics described above with reference to method 700. The map 1202 in FIG. 12A includes an indication 1208 of the current location of the electronic device 500, indications 1212a, 1212b, 1212c, and 1212d of trails, indications 1210a, 1210b, and 1210c of trail junctions, and indications 1214a, 1214b, and 1214c of distances between trail junctions. The electronic device 500 displays an option 1206a that, when selected, updates the orientation and/or centering of the map 1202 as described above with reference to method 700 and an option 1206b to search/browse locations nearby as described above with reference to method 900 overlaid on the map 1202, as shown in FIG. 12A.

As described above, the current location of the electronic device 500 is in a hiking area. In some embodiments, while the electronic device 500 is in the hiking area, the electronic device 500 displays specialized content on the map 1202 as described above with reference to method 700. Additionally or alternatively, in some embodiments, in response to detecting the current location of the electronic device 500 in the hiking area, the electronic device 500 displays indication 1204. The indication 1204 optionally includes the name of the hiking area (“Yosemite”) and prompts the user to select the indication 1204 to view trails and trailheads in the hiking area. As shown in FIG. 12A, the electronic device 500 receives an input including selection of the indication 1204 with contact 1203a. In response to the input shown in FIG. 12A, the electronic device 500 displays indications of trails and trailheads in the hiking area, as shown in FIG. 12B.

FIG. 12B illustrates an example of the electronic device 500 displaying indications 1220a through 1220d of trails and indications 1221a and 1221b of trailheads in the hiking area in which the electronic device 500 is currently located. In some embodiments, the manner in which the electronic device 500 displays the indications 1220a through 1220d of trails and indications 1221a and 1221b of trailheads includes one or more characteristics of method 900 described above. For example, the electronic device 500 displays indication 1220a of a respective trail with increased visual emphasis relative to indications 1220b and 1220c, including displaying indication 1220a with greater line thickness, darker color, and/or decreased translucency compared to indications 1220b and 1220c and displaying indication 1220a with icon 1218. In some embodiments, the electronic device 500 also displays, overlaid on map 1202, an option 1216a that, when selected, causes the electronic device 500 to navigate back to the user interface in FIG. 12A and an option 1216b that, when selected, causes the electronic device 500 to display the indications of trails and trailheads in a list view, as described above with reference to method 900. Additionally, as shown in FIG. 12B, the electronic device 500 displays a user interface element 1222 overlaid on the map 1202 that includes information about the trail corresponding to indication 1220a, such as an indication 1224a of the name of the trail, an indication 1224b that the trail is a trail, an indication 1224c of the distance between an access point of the trail and the current location of the electronic device, an indication 1224d of the difficulty of the trail, an indication 1224e that the trail is a point-to-point trail, and an indication 1224f of the distance of the trail.

As shown in FIG. 12B, the electronic device 500 receives an input including selection of user interface element 1222 with contact 1203b. In response to the input shown in FIG. 12B, the electronic device 500 displays a user interface with additional information about the trail, as shown in FIG. 12C.

FIG. 12C illustrates an example of the electronic device 500 displaying a user interface 1226a including information about a trail overlaid on map 1202 in response to receiving the input illustrated in FIG. 12B. For example, the user interface 1226a includes information about the trail that corresponds to indication 1220a and user interface element 1222 in FIG. 12B. As shown in FIG. 12C, the user interface 1226a includes an indication 1228a of the name of the trail, an indication 1228b that the trail is a trail, an indication 1228c of the park in which the trail is located, an indication 1228d of the distance between the current location of the electronic device 500 and the trail, an indication 1228f that the trail is a point-to-point t rail, an indication 1228g of the distance of the trail, an indication 1228h of the estimated duration to hike the trail, an indication 1228i of the elevation profile of the trail, and photos 1228j of the trail.

In some embodiments, as described below with reference to FIGS. 12D and 12E, the user interface 1226a includes additional content accessed by scrolling. For example, in FIG. 12C, the electronic device 500 receives an input including movement of contact 1203c that corresponds to a request to scroll the user interface 1226a. In response to the input illustrated in FIG. 12C, the electronic device 500 scrolls the user interface 1226a to the location shown in FIG. 12D. In some embodiments, the electronic device 500 would also scroll the user interface 1226a in response to receiving an input including turning of crown 1201.

FIG. 12D illustrates an example of the electronic device 500 displaying another portion of the user interface 1226a with information about the trail in response to the scrolling input shown in FIG. 12C. In some embodiments, as shown in FIG. 12D, once the user scrolls the user interface 1226a down from the top of user interface 1226a shown in FIG. 12C, the electronic device 500 no longer displays map 1202 beneath user interface 1226a. In some embodiments, in response to receiving input(s) scrolling the user interface 1226a back to the top and/or past the top, the electronic device 500 displays map 1202 again. In some embodiments, the electronic device 500 displays an option that, when selected, causes the electronic device 500 to navigate back in the user interface to the user interface shown in FIG. 12B.

As shown in FIG. 12D, the user interface includes an option 1228k to present navigation directions from the current location of the electronic device 500 to the trail, an indication 12281 of the trail route, and indications 1228m and 1228n of other trails near the trail associated with the user interface 1226a. For example, indication 1228m includes an indication 1230a of the name of the other trail, an indication 1230b of the distance from the current location to the other trail, an indication 1230c of the difficulty of the other trail, and an indication 1230d of the distance of the other trail. Indication 1228n includes similar elements as indication 1228m corresponding to the trail indicated by indication 1228n. In some embodiments, in response to detecting an input selecting indication 1228m or 1228n, the electronic device 500 displays a user interface including additional information about the trail corresponding to the selected indication that is similar to the user interface illustrated in FIGS. 12C-12E.

As shown in FIG. 12D, the electronic device 500 receives another scrolling input including movement of contact 1203d. In response to the input illustrated in FIG. 12D, the electronic device 500 displays the portion of the user interface 1226a shown in FIG. 12E. In some embodiments, if the electronic device 500 had detected movement of the contact 1203d in the opposite direction, the electronic device 500 would scroll the user interface 1226a in the opposite direction, such as to show the portion of the user interface 1226a illustrated in FIG. 12C. Additionally or alternatively, in some embodiments, the electronic device 500 would also scroll the user interface 1226a in response to receiving an input including turning of crown 1201.

FIG. 12E illustrates an example of the electronic device 500 displaying another portion of the user interface 1226a with information about the trail in response to the scrolling input shown in FIG. 12D. As described above with reference to FIG. 12D, the electronic device 500 may not display the map 1202 while displaying a portion of the user interface 1226a scrolled down from the top of the user interface 1226a. In some embodiments, the electronic device 500 displays the maps 1202 again in response to one or more of the inputs described above with reference to FIG. 12D.

As shown in FIG. 12E, the user interface 1226a further includes indications 1228o and 1228p of trailheads associated with (e.g., connected to) the trail and a map 1228q including an indication 1228r of the location of the trail. For example, indication 1228o includes an indication 1232a of the name of the trailhead, an indication 1232b of the distance to the trailhead from the current location of the electronic device, and an indication 1232c that the trailhead is currently open. In some embodiments, the indication 1228o of the trailhead includes hours of operation of the trailhead in addition or as an alternative to the indication 1232c that the trailhead is open. In some embodiments, if the trailhead is currently closed, the indication 1232c that the trailhead is open is replaced with an indication that the trailhead is closed.

As shown in FIG. 12E, the electronic device 500 receives an input including selection of indication 1228o with contact 1203e. In response to the input shown in FIG. 12E, the electronic device 500 displays a user interface with information about the trailhead, as shown in FIG. 12F.

FIG. 12F illustrates an example of the electronic device 500 displaying a user interface 1226b with information about a trailhead in response to the input shown in FIG. 12E. In some embodiments, the electronic device 500 would also display the user interface 1226b in response to receiving selection of another user interface element associated with the trailhead, such as a user interface element displayed in a user interface similar to the user interface in FIG. 12B. As shown in FIG. 12F, the user interface 1226b includes an indication 1234a of the name of the trailhead; an indication 1234b that he trailhead is a trailhead; an indication 1234c of the distance between the trailhead and the current location of the electronic device 500; an indication 1234d that the trailhead is currently open; an indication 1234e of the hours of operation of the trailhead, a selectable option 1234f that, when selected, causes the electronic device 500 to present navigation directions to the trailhead; and an indication 1234g of a trail connected to the trailhead. In some embodiments, in response to receiving an input selecting the option 1234f to present navigation directions to the trailhead, the electronic device 500 presents indications of available navigation routes as described above with reference to method 900. In some embodiments, while presenting the navigation directions, the electronic device 500 displays one or more of the user interfaces described above with reference to method 1100. As shown in FIG. 12F, the indication 1234g of the trail includes an indication 1236a of the name of the trail, an indication 1236b of the distance from the current location of the electronic device 500 to the trail, an indication 1236c of the difficulty rating of the trail, and an indication 1236d of the distance of the trail. In some embodiments, in response to detecting selection of indication 1234g, the electronic device 500 displays a user interface with information about the trail similar to user interface 1226a described above with reference to FIGS. 12C-12E.

As shown in FIG. 12F, the electronic device 500 receives a scrolling input including movement of contact 1203f. In response to the input illustrated in FIG. 12F, the electronic device 500 displays the portion of the user interface 1226b shown in FIG. 12G. Additionally or alternatively, in some embodiments, the electronic device 500 would also scroll the user interface 1226b in response to receiving an input including turning of crown 1201.

FIG. 12G illustrates an example of the electronic device 500 displaying another portion of the user interface 1226b in response to receiving the scrolling input illustrated in FIG. 12F. In some embodiments, as shown in FIG. 12G, once the user scrolls the user interface 1226b down from the top of user interface 1226b shown in FIG. 12F, the electronic device 500 no longer displays map 1202 beneath user interface 1226b. In some embodiments, in response to receiving input(s) scrolling the user interface 1226b back to the top and/or past the top, the electronic device 500 displays map 1202 again. In some embodiments, the electronic device 500 displays an option that, when selected, causes the electronic device 500 to navigate back in the user interface to the user interface shown in FIG. 12B or the user interface 1226a shown in FIGS. 12C-12E.

As shown in FIG. 12G, the user interface 1226b further includes an indication 1234h of another trail connected to the trailhead, an indication 1234i of the park and zip code in which the trailhead is located, and a map 1234j with an indication 1234k of the location of the trailhead. In some embodiments, indication 1234h includes similar elements as indication 1234g described above with reference to FIG. 12F. In some embodiments, in response to detecting selection of indication 1234h, the electronic device 500 displays a user interface with information about the trail similar to user interface 1226a described above with reference to FIGS. 12C-12E.

In some embodiments, additionally or alternatively to displaying indication 1204 overlaid on map 1202 in FIG. 12A in accordance with a determination that the current location of the electronic device 500 is in the hiking area, the electronic device 500 customizes options for viewing locations near the electronic device 500 depending on whether or not the electronic device 500 is in the hiking area.

For example, in FIG. 12H the electronic device 500 displays a search/find user interface 1238 overlaid on map 1202 while the current location of the electronic device 500 is in the hiking area. In some embodiments, the electronic device 500 displays the user interface 1238 in response to detecting selection of option 1206b in FIG. 12A. As shown in FIG. 12H, the user interface 1238 includes a text entry field 1240a into which the user can enter a search query for searching with the maps application; options 1240b and 1240c of previously-performed searches that, when selected, cause the electronic device 500 to display search results corresponding to the selected indication; and selectable options 1240d through 1240f that, when selected, cause the electronic device 500 to present locations of the type indicated by the selected option. In some embodiments, in response to receiving an input corresponding to a request to search for locations, such as selection of one of options 1240b through 1240f, or receiving an input corresponding to a request to search for locations matching the query entered into text entry field 1240a, the electronic device 500 displays the search results according to one or more steps of method 900 described above.

In some embodiments, options 1240d through 1240f are scrollable to reveal additional options that, when selected, cause the electronic device 500 to present additional options corresponding to other types of places. In some embodiments, the electronic device 500 displays the option 1240d to view search results for trails and the option 1240e to view search results for trailheads with higher priority (e.g., first in the list) than the other options because the current location of the electronic device 500 is in the hiking area. Examples of other options include options to view search results for restaurants, parking, gas stations, electric vehicle charging stations, bike shops, cafes, and convenience stores.

FIG. 12I illustrates an example of the electronic device 500 displaying a map 1202 while the current location of the electronic device 500 is outside of the hiking area. For example, the current location of the electronic device 500 is in a city. As shown in FIG. 12I, the map 1202 includes indications 1242a, 1242b, and 1242c of points of interest; indications 1244a, 1244b, 1244c, and 1244d of street names; and an indication 1208 of the current location of the electronic device 500. In some embodiments, in response to detecting selection of one of the indications 1242a through 1242c of points of interest, the electronic device 500 displays a user interface with more information about the location corresponding to the selected indication. In some embodiments, the user interface with more information about the location is similar to the user interfaces described above with reference to FIGS. 8C-8G, but may include different types of information depending on the type of location the user interface is about. As shown in FIG. 12I, the electronic device 500 displays options 1206a and 1206b overlaid on the map, as described in more detail above with reference to FIG. 12A. In some embodiments, because the current location of the electronic device 500 is not in a hiking area, the electronic device 500 does not display an indication similar to indication 1204 described above with reference to FIG. 12A.

As shown in FIG. 12I, the electronic device 500 receives an input including selection of option 1206b with contact 12031. In response to the input illustrated in FIG. 12I, the electronic device 500 displays the search/find user interface 1238 shown in FIG. 12J.

FIG. 12J illustrates an example of the electronic device 500 displaying the search/find user interface 1238 while the current location of the electronic device 500 is outside of a hiking area in response to the input illustrated in FIG. 12I. In some embodiments, user interface 1238 in FIG. 12J is the same as the user interface 1238 in FIG. 12H, but instead of displaying the option 1240d to view trails, the option 1240e to view trailheads, and the option 1240f to view hotels before options to view other types of locations; the user interface in FIG. 12J includes an option 1240g to view restaurants, an option 1240h to view parking, and an option 1240i to view gas stations ahead of options to view other types of locations because the electronic device 500 is not currently in the hiking area in FIG. 12J.

FIG. 13 is a flow diagram illustrating a method in which an electronic device performs additional features while the current location of the electronic device is in a predetermined area according to some embodiments of the disclosure. The method 1300 is optionally performed at first and/or electronic devices such as device 100, device 300, or device 500 as described above with reference to FIGS. 1A-1B, 2-3, 4A-4B and 5A-5C. Some operations in method 1300 are, optionally combined and/or order of some operations is, optionally, changed.

As described below, the method 1300 provides ways in which an electronic device performs additional functions in response to detecting the electronic device is in a predetermined area. Performing additional functions associated with the predetermined area enhances user interactions with the computer system by reducing the number of inputs needed to perform functions likely of interest to the user based on the current location of the electronic device, thereby reducing power usage and improving the battery life of the electronic device.

In some embodiments, method 1300 is performed at an electronic device in communication with a display generation component and one or more input devices. In some embodiments, the electronic device has one or more of the characteristics of the electronic device of method(s) 700, 900, and/or 1100. In some embodiments, the display generation component has one or more of the characteristics of the display generation component of method(s) 700, 900, and/or 1100. In some embodiments, the one or more input devices have one or more of the characteristics of the one or more input devices of method(s) 700, 900, and/or 1100. In some embodiments, method 1300 is performed at or by an automobile (e.g., at an infotainment system of an automobile having or in communication with one or more display generation components and/or input devices).

In some embodiments, while displaying, via the display generation component, a user interface of a maps application, in accordance with a determination that a current location of the electronic device is within a predefined physical region, such as in FIG. 12A, the electronic device displays, via the display generation component, an indication corresponding to the predefined physical region, such as indication 1204 in FIG. 12A. In some embodiments, the maps application presents maps of physical areas according to method(s) 700, 900, and/or 1100, presents navigation directions according to method(s) 900 and/or 1100, and presents information about physical areas and/or locations according to method(s) 700, 900, and/or 1100. In some embodiments, the predefined physical region is a predefined physical region in which additional functionality of the maps application is available. For example, the predefined physical region is a park including hiking trails, trailheads, and/or points of interest and the additional functionality includes displaying information about available trails, trailheads, and/or points of interest in a format not available outside of the predefined physical region. In some embodiments, there are multiple predefined physical regions in which the additional functionality is available. For example, the additional functionality is available when the current location of the electronic device is in a park included in a predefined plurality of parks. In some embodiments, the user interface of the maps application includes a map of a physical region including the current location of the electronic device and the indication is displayed overlaid on the map. In some embodiments, the user interface of the maps application includes written information and non-map images related to a physical region and the indication is displayed overlaid on the information and images. In some embodiments, the indication includes text describing the additional functionality, such as text describing additional information related to the predefined physical region that the maps application is able to display while the electronic device is in the predefined physical region. For example, while in a park, the electronic device displays an indication including text about trail and trailhead information available in another user interface of the maps application while the electronic device is in the park.

In some embodiments, while displaying, via the display generation component, a user interface of a maps application, in accordance with a determination that a current location of the electronic device is within a predefined physical region, such as in FIG. 12A, while displaying the indication corresponding to the predefined physical region, the electronic device receives, via the one or more input devices, an input corresponding to selection of the indication, such as the input in FIG. 12A including contact 1203a on indication 1204. In some embodiments, receiving the input corresponding to selection of the indication includes detecting a tap on a touch screen at a location at which the indication is displayed.

In some embodiments, while displaying, via the display generation component, a user interface of a maps application, in accordance with a determination that a current location of the electronic device is within a predefined physical region, such as in FIG. 12A, in response to receiving the input, the electronic device performs a feature with the maps application that is associated with the predefined physical region, such as displaying the user interface in FIG. 12B. In some embodiments, the feature is not available outside of the predefined physical region. In some embodiments, the feature is available within the predefined physical region and outside of the predefined physical region. In some embodiments, outside of the predefined region, the electronic device performs the function after receiving a sequence of one or more inputs defining a search query and requesting to view search results, whereas while within the predefined region, the electronic device performs the function in response to receiving an input selecting the indication without receiving the sequence of inputs defining the search query. In some embodiments, the indication includes information about the feature with the maps application that is not available outside of the predefined physical region. For example, the feature is a guide to trails and trailheads included in a park. In some embodiments, in response to detecting selection of the indication, the electronic device displays indications of trails and trailheads on a map according to one or more steps of method 900 described above. In some embodiments, the trails and trailheads included in the map are selected based on proximity to the current location of the electronic device, and the electronic device displays indications of trails and trailheads that are within a threshold distance of the current location of the electronic device and forgoes displaying indications of trails and trailheads more than the threshold distance from the current location of the electronic device. In some embodiments, the map the electronic device displays in response to the input includes an indication of the current location of the electronic device.

In some embodiments, while displaying, via the display generation component, a user interface of a maps application, in accordance with a determination that the current location of the electronic device is outside of the predefined physical region, such as in FIG. 12I, the electronic device forgoes displaying the indication via the display generation component, such as displaying the user interface in FIG. 12I without indication 1204 in FIG. 12A. In some embodiments, if the electronic device is not displaying a user interface of the maps application while in the predefined physical region, the electronic device forgoes displaying the indication. In some embodiments, if the electronic device is in a location other than the predefined physical region, the electronic device forgoes displaying the indication irrespective of whether or not the electronic device is displaying a user interface of the maps application. Displaying the indication of the feature in response to detecting the electronic device within the predefined physical region enhances user interactions with the electronic device by reducing the number of inputs needed to access the feature and by providing improved visual feedback to the user indicating the existence of the feature.

In some embodiments, performing the feature with the maps application that is associated with the predefined physical region includes displaying, via the display generation component, a user interface including a visual indication of a location within the predefined physical region, such as indications 1218 and/or 1221a through 1221c and/or 1220a through 1220c in FIG. 12B (or a plurality of visual indications of a plurality of locations within the predefined physical region). In some embodiments, the visual indication indicates a location within the predefined physical region of an activity associated with the predefined physical region or a point of interest of the predefined physical region. For example, the predefine physical region is a hiking area (e.g., a park including trails and/or trailheads) and the feature associated with the predefined physical region is displaying indications of trails and/or trailheads near the current location of the electronic device in the predefined physical region. For example, the electronic device displays indications of trails and trailheads within a threshold distance (e.g., 100, 200, 300, or 500 meters or 1, 2, 3, or 5 kilometers) of the location of the electronic device and/or up to a predetermined number (e.g., 3, 5, 7, 10, or 20) of indications of trails and trailheads that are closest to the current location of the electronic device. In some embodiments, the electronic device determines which indications of trails and trailheads to display based on a plurality of criteria, such as distance from the current location of the electronic device, popularity, hours of operation, and/or how many other indications are to be displayed compared to a threshold. In some embodiments, the electronic device displays the indications of trails and/or trailheads according to one or more steps of method 900 described above. Displaying the visual indication of the location within the predefined physical region enhances user interaction with the electronic device by reducing the number of inputs needed to view information about the location within the predefined physical region, which saves time and reduces power consumption.

In some embodiments, while displaying the user interface of the maps application, the electronic device displays, via the display generation component, a trailhead user interface element that includes information about a trailhead within the predefined physical region, such as user interface 1226b in FIG. 12F. In some embodiments, the electronic device displays indications of trails and/or trailheads according to one or more steps of method 900 and/or as described above in response to receiving the input selecting the indication corresponding to the predefined physical region. In some embodiments, the indications of trails and/or trailheads include an indication of the trailhead. In some embodiments, the electronic device displays the trailhead user interface element in response to detecting selection of the indication of the trailhead. Examples of information that could be included in the trailhead user interface element are described in more detail below. In some embodiments, the trailhead user interface element is displayed within a trail user interface element as described below. In some embodiments, the trailhead user interface element is displayed outside of a trail user interface element. Displaying the trailhead user interface enhances user interactions with the electronic device by reducing the time and inputs needed for the user to view information relevant to the predefined physical region including the current location of the electronic device.

In some embodiments, the trailhead user interface element includes a first trail user interface element including information about a first trail that connects to the trailhead and a second trail user interface element different from the first trail user interface element including information about a second trail that connects to the trailhead, such as indication 1234g in FIG. 12F and/or indication 1236h in FIG. 12G included in user interface 1226b. In some embodiments, the trail user interface elements included in the trailhead user interface include a subset of information included in trail user interface elements not displayed in a trailhead user interface element described below. In some embodiments, the trailhead user interface element includes indications of all of the trails connected to the trailhead. In some embodiments, the trailhead user interface element includes indications of a subset of trails connected to the trailhead based on one or more criteria, such as prioritizing trails based on length, elevation, type, distance, estimated time to hike, hours of operation, and/or popularity. Displaying trail user interface elements associated with trails that connect to the trailhead in the trailhead user interface element enhances user interactions with the electronic device by reducing the time and number of inputs needed to browse trails based on the trailhead(s) to which the trails connect.

In some embodiments, such as in FIG. 12F, the first trail user interface element (e.g., 1234g) includes an indication (e.g., 1236a) of a name of the first trail, an indication of a type of the first trail, such as an indication that the trail is a loop trail, an out and back trail, or a point-to-point t trail, an indication (e.g., 1236b) of a distance between the current location of the electronic device and an access point of the first trail, and/or a length (e.g., 1236d) of the first trail, and the second trail user interface element includes an indication of a name of the second trail, an indication of a type of the second trail, an indication of a distance between the current location of the electronic device and an access point of the second trail, and/or a length of the second trail, such as the elements of indication 1234h in FIG. 12G. In some embodiments, the type of trail indicates the route type of the trail, such as out and back, point to point, or loop. In some embodiments, the type of trail indicates the terrain of the trail, such as paved, dirt trail, or a different ground covering. In some embodiments, the type of trail indicates modes of transportation allowed on the trail, such as hiking/walking/running, biking, and/or horseback. In some embodiments, the indication of distance between the access point and the current location of the electronic device is an indication of the distance from the current location of the electronic device to the closest access point to the trail, which may be a trailhead, a junction with another trail that is not a trailhead, or another access point that is not a trailhead or a junction with another trail. Displaying information about the first and second trails in trail user interface elements included in the trailhead user interface element enhances user interactions with the electronic device by reducing the time and number of inputs needed to browse trails based on the trailhead(s) to which the trails connect.

In some embodiments, the trailhead user interface element includes an indication of a distance between the trailhead and the current location of the electronic device, such as indication 1234c in FIG. 12F. In some embodiments, the distance is a distance of the shortest route from the current location to the trailhead using trails and/or other predefined roads and/or routes in the physical area including the trailhead and the current location of the electronic device. In some embodiments, the distance is the distance from the current location of the electronic device to the trailhead as the crow flies. Displaying the indication of the distance between the trailhead and the current location of the electronic device in the trailhead user interface element enhances user interactions with the computer system by reducing the number of inputs needed to view relevant information about the trailhead, thereby reducing time and battery life needed for operation of the electronic device and reducing the likelihood of user error.

In some embodiments, the trailhead user interface element includes a map of a physical area that includes the trailhead and an indication of the address of the trailhead.

In some embodiments, the trailhead user interface element includes a selectable option, such as option 1234f in FIG. 12F. In some embodiments, the selectable option includes an icon or image associated with navigation. For example, the maps application includes other user interfaces for navigation that include navigation options that feature the icon or image associated with navigation. In some embodiments, the selectable option is displayed overlaid on other contents of the trailhead user interface element and remains fixed at a position displayed by the display generation component when the electronic device scrolls other contents of the trailhead user interface element.

In some embodiments, while displaying the trailhead user interface element with the selectable option, the electronic device receives, via the one or more input devices, an input selecting the selectable option, such as receiving an input directed to option 1234f in FIG. 12F. In some embodiments, the input is received using a touch screen in communication with the electronic device, such as detecting a contact at a position of the touch screen at which the option is displayed. In some embodiments, the input is received using a hardware input device, such as detecting depression of a button or crown in communication with or integrated with the electronic device while current focus is directed to the selectable option.

In some embodiments, in response to receiving the input selecting the selectable option, the electronic device presents navigation directions to a location of the trailhead, such as according to method 1100 (e.g., from the current location of the electronic device). In some embodiments, presenting navigation directions to the location of the trailhead includes presenting one or more visual indications of a one or more available routes to the trailhead according to one or more steps of method 900 described above. In some embodiments, while presenting the one or more indications of the one or more available routes to the trailhead, the electronic device receives an input selecting one of the indications. In some embodiments, in response to receiving the input selecting one of the indications, the electronic device presents navigation directions to the trailhead using the route corresponding to the selected indication, optionally according to one or more steps of method 1300 described below. Presenting navigation directions to the trailhead in response to detecting selection of the option included in the trailhead user interface element enhances user interactions with the electronic device by reducing the number of inputs needed to initiate navigation to the trailhead, which reduces the opportunities for user error, saves time and reduces energy use by the electronic device.

In some embodiments, while displaying the user interface of the maps application, the electronic device displays, via the display generation component, a trail user interface element that includes information about a trail within the predefined physical region, such as user interface element 1226a in FIG. 12C. In some embodiments, the electronic device displays indications of trails and/or trailheads according to one or more steps of method 900 and/or as described above in response to receiving the input selecting the indication corresponding to the predefined physical region. In some embodiments, the indications of trails and/or trailheads include an indication of the trail. In some embodiments, the electronic device displays the trail user interface element in response to detecting selection of the indication of the trail. Examples of information that could be included in the trail user interface element are described in more detail below. In some embodiments, the trail user interface element is displayed within a trailhead user interface element as described above. In some embodiments, the trail user interface element is displayed outside of a trailhead user interface element. Displaying the trail user interface enhances user interactions with the electronic device by reducing the time and inputs needed for the user to view information relevant to the predefined physical region including the current location of the electronic device.

In some embodiments, such as in FIGS. 12C-12E, the trail user interface element includes an indication (e.g., 1228a) of a name of the trail, an indication (e.g., 1228c) of a name of the predefined physical region, an indication of hours of operation of the trail, such as including an indication of hours of operation in user interface 1226a, an indication (e.g., 1228e) of a difficulty of the trail, an indication (e.g., 1228g) of a length of the trail, an indication of elevation (e.g., 1228i) of the trail, an indication (e.g., 1228h) of an estimated time to hike the trail, an indication (e.g., 1228d) of a distance between an access point of the trail to the current location of the electronic device, a photo (e.g., 1228j) of the trail (or a plurality of photos of the trail), and/or an address of the trail, such as including an address of the trail in user interface element 1226a. In some embodiments, the indication of the distance between the access point of the trail to the current location of the electronic device has one or more of the characteristics described above with reference to the trail user interface element included in the trailhead user interface element. In some embodiments, the address of the trail is an address of a trailhead to which the trail connects. In some embodiments, the address of the trail is an address of the access point of the trail described previously and/or above. Displaying the information about the trail described above enhances user interactions with the electronic device by reducing the time and inputs needed for the user to view information relevant to the predefined physical region including the current location of the electronic device.

In some embodiments, such as in FIG. 12E, the trail user interface element (e.g., 1226a) includes a map (e.g., 1228g) of a region including the trail, wherein the map includes a visual indication (e.g., 1228r) of the trail and a visual indication of a trailhead associated with the trail. In some embodiments, if the trail connects to more than one trailhead, the map includes indications of the plurality of trailheads to which the trail connects. In some embodiments, if the trail connects to more than one trailhead, the map includes an indication of one of the trailheads without including indications of the other trailheads to which the trail connects, with the trailhead being selected based on criteria such as distance to the current location of the electronic device, popularity, and/or hours of operation. Displaying the map including the indications of the trail and trailhead within the trail user interface element enhances user interactions with the electronic device by reducing the time and inputs needed for the user to view information relevant to the predefined physical region including the current location of the electronic device.

In some embodiments, the trail user interface element includes a first trailhead user interface element including information about a first trailhead associated with the trail and a second trailhead user interface element different from the first trailhead user interface element including information about a second trailhead associated with the trail different from the first trailhead, such as indications 1228o and 1228p in FIG. 12E. In some embodiments, the first trailhead user interface element and the second trailhead user interface element include a subset of information about the first and second trailheads that would be included in trailhead user interface elements for the first and second trails displayed outside of the trail user interface element. In some embodiments, the first trailhead user interface element and the second trailhead user interface element are displayed in an order of priority based on one or more criteria such as distance to the current location of the electronic device, hours of operation, and/or popularity. Displaying trailhead user interface elements associated with trailheads to which the trail connects in the trail user interface element enhances user interactions with the electronic device by reducing the time and number of inputs needed to browse trailheads based on the trails connected to the trailheads.

In some embodiments, such as in FIG. 12E, the first trailhead user interface element (e.g., 1228o) includes an indication (e.g., 1232a) of a name of the first trailhead, a first trailhead indication, such as an indication “trailhead” included in element 1228o, an indication (e.g., 1232b) of a distance between the first trailhead and the current location of the electronic device, and/or an indication (e.g., 1232c) of hours of operation of the first trailhead, and the second trailhead user interface element (e.g., 1228p) includes an indication of a name of the second trailhead, a second trailhead indication, an indication of a distance between the second trailhead and the current location of the electronic device, and/or an indication of hours of operation of the second trailhead. In some embodiments, the trailhead indication is an image or the text “trailhead” indicating that the first or second trailhead is a trailhead (optionally as opposed to a trail). In some embodiments, the indication of distance between the trailhead and the current location of the electronic device is an indication of distance of the shortest navigation route to the trailhead that uses trails and/or other predefined paths included in the maps application. In some embodiments, the indication of distance between the trailhead and the current location of the electronic device is an indication of distance between the current location of the electronic device and the trailhead as the crow flies. Displaying information about the first and second trailheads in trailhead user interface elements included in the trail user interface element enhances user interactions with the electronic device by reducing the time and number of inputs needed to browse trailheads based on the trails connected to the trailhead(s).

In some embodiments, the trail user interface element further includes a selectable option, such as option 1228k in FIG. 12D. In some embodiments, the selectable option includes an icon or image associated with navigation, as described above with reference to the option to navigate to a trailhead included in the trailhead user interface element. In some embodiments, the selectable option is displayed overlaid on other contents of the trail user interface element and remains fixed at a position displayed by the display generation component when the electronic device scrolls other contents of the trail user interface element.

In some embodiments, while displaying the trail user interface element including the selectable option, the electronic device receives, via the one or more input devices, an input selecting the selectable option, such as an input selecting option 1228k. In some embodiments, the input is received using a touch screen in communication with the electronic device, such as detecting a contact at a position of the touch screen at which the option is displayed. In some embodiments, the input is received using a hardware input device, such as detecting depression of a button or crown in communication with or integrated with the electronic device while current focus is directed to the selectable option.

In some embodiments, in response to receiving the input selecting the selectable option, the electronic device presents navigation directions from a current location of the electronic device to an access point of the trail, such as according to method 1100 (e.g., from the current location of the electronic device). In some embodiments, the access point of the trail is the closest access point of the trail to the current location of the electronic device, which may be a trailhead, a junction with another trail that is not a trailhead, or another access point that is not a trailhead or a junction with another trail. In some embodiments, presenting navigation directions to the location of the access point includes presenting one or more visual indications of a one or more available routes to the access point according to one or more steps of method 900 described above. In some embodiments, while presenting the one or more indications of the one or more available routes to the access point, the electronic device receives an input selecting one of the indications. In some embodiments, in response to receiving the input selecting one of the indications, the electronic device presents navigation directions to the access point using the route corresponding to the selected indication, optionally according to one or more steps of method 1300 described below. Presenting navigation directions to the access point of the trail in response to detecting selection of the option included in the trail user interface element enhances user interactions with the electronic device by reducing the number of inputs needed to initiate navigation to the access point of the trail, which reduces the opportunities for user error, saves time and reduces energy use by the electronic device.

In some embodiments, the electronic device is in communication with a second electronic device via a connection other than an internet connection. In some embodiments, the electronic device is a wearable device, such as a smart watch and the second electronic device is a mobile device such as a smartphone, tablet, or media player. In some embodiments, the connection other than the internet connection is another wireless connection, such as a Bluetooth connection.

In some embodiments, the electronic device displays a map in the user interface of the maps application while the electronic device and the second electronic device are not connected to the internet connection based on data stored on the second electronic device and/or data stored on the electronic device, such as displaying map 1202 in FIG. 12A without an internet connection. In some embodiments, while the second electronic device does not have access to the internet, the second electronic device and electronic device are able to present maps and navigation directions of areas for which the second electronic device and/or the electronic device has downloaded map data and/or maps. In some embodiments, if the electronic device and second electronic device are not connected to the internet connection and the second device and the electronic device do not have a map or map data for a physical location including the current location of the electronic device and/or the destination of the navigation directions, it may not be possible to present the navigation directions. In some embodiments, while the electronic device and/or second electronic device are not connected to the internet connection, the maps user interface includes an icon indicating that there is no internet connection. In some embodiments, while the electronic device and/or second electronic device are connected to the internet connection, the electronic device and/or second electronic device are able to present maps and/or navigation directions without the second electronic device and/or the electronic device having downloaded map(s) or map data including the current location of the electronic device and/or the navigation destination. Presenting navigation directions based on data stored on the second electronic device while the electronic device and the second electronic device are not connected to the internet connection enhances user interactions with the electronic device by expanding functionality of the maps application when there is no internet connection.

In some embodiments, the electronic device displays, in the user interface of the maps application, a first option that, when selected, causes the electronic device to display visual indications of trails and/or trailheads near the current location of the electronic device, and a second option that, when selected, causes the electronic device to display visual indications of locations near the current location of the electronic device of a type other than trails or trailheads, such as options 1240d through 1240f in FIG. 12H. In some embodiments, locations “near” the electronic device include locations within a threshold distance of the electronic device, a predetermined number of locations ranked by distance from the electronic device, and/or locations selected based on one or more criteria, as described above. In some embodiments, the first and second options are selectable options to search for nearby locations belonging to a respective category, such as trails, trailheads, restaurants, gas stations, convenience stores, grocery stores, bike shops, transit stations, and/or electric vehicle charging stations. In some embodiments, in response to detecting selection of the first option or second option, the electronic device presents search results in the respective category corresponding to the selected option according to one or more steps of method 900 described above.

In some embodiments, in accordance with the determination that the current location of the electronic device is within the predefined physical region, the first option is displayed with higher priority than the second option, such as displaying options 1240d and 1240e in FIG. 10H, with additional options accessed by scrolling options 1240d through 1240f. In some embodiments, displaying the first option with higher priority than the second option includes displaying the first option to the left of the second option in a horizontally-scrolling list where the first item in the list is on the left. In some embodiments, displaying the first option with higher priority than the second option includes displaying the first option above the second option in a vertically-scrolling list where the first item in the list is on the top. In some embodiments, the predefined physical region is a hiking area, as described above, and while the current location of the electronic device is in the hiking area, the electronic device presents option(s) for displaying trails and/or trailheads nearby with higher priority than option(s) for displaying other types of locations nearby.

In some embodiments, in accordance with the determination that the current location of the electronic device is not within the predefined physical region, the second option is displayed with higher priority than the first option, such as displaying options 1240g through 1240i in FIG. 12J, with additional options accessed by scrolling. In some embodiments, displaying the second option with higher priority than the first option includes displaying the second option to the left of the first option in a horizontally-scrolling list where the first item in the list is on the left. In some embodiments, displaying the second option with higher priority than the first option includes displaying the second option above the first option in a vertically-scrolling list where the first item in the list is on the top. In some embodiments, the predefined physical region is a hiking area, as described above, and while the current location of the electronic device is outside of the hiking area, the electronic device presents option(s) for displaying trails and/or trailheads nearby with lower priority than option(s) for displaying other types of locations nearby. Displaying the first option associated with trails and/or trailheads with higher priority than the second option associated with another type of location while in the predefined physical region enhances user interactions with the electronic device by reducing the time and/or inputs needed to find options relevant to the predefined physical area.

In some embodiments, while displaying, in the user interface of the maps application, a map of a physical area including current location of the electronic device, in accordance with the determination that the current location of the electronic device is within the predefined physical region, the map includes visual indications of respective information about the physical area, such as displaying map 1202 in FIG. 12A with indications 1212a through 1212d and 1214a through 1214c. In some embodiments, the visual indications of respective information include visual indications of elevation, trail junctions, and/or distances between trail junctions. In some embodiments, the indications of elevation are topographical lines indicating the grade of changes in elevation in the physical region and/or numerical indications of elevation at respective locations within the physical region. In some embodiments, the indications of trail junctions are images and/or icons displayed at locations where two or more trails meet, optionally displayed in addition to visual indications of the trails. In some embodiments, the indications of distances between trail junctions are numerical indications in units of distance or estimated walking time. In some embodiments, the electronic device forgoes displaying indications of one or more types of information at lower zoom levels and displays the indications of the one or more types of information at higher zoom levels. For example, at a first zoom level, the electronic device forgoes display of indications of trail junctions and indications of distance between trail junctions and, in response to an input to zoom in to a second zoom level higher than the first zoom level, the electronic device displays the indications of trail junctions without displaying the indications of distances between trail junctions. In this example, in response to receiving another input to zoom in while at the second zoom level, the electronic device displays the map at a third zoom level higher than the second zoom level and displays the indications of distances between trail junctions while displaying the indications of trail junctions. In some embodiments, the predefined physical region is a park including hiking trails and/or trailheads. In some embodiments, while the current location of the electronic device is outside of the predefined physical area, the electronic device displays a map of the predefined physical region including the visual indications of respective information about the physical area as described above. The map may include or not include information about a respective type of feature in the physical area in the predefined physical region without departing from the scope of the disclosure. In some embodiments, the map of the predefined physical region further includes indications of other types of features, such as roads and points of interest.

In some embodiments, while displaying, in the user interface of the maps application, a map of a physical area including current location of the electronic device, in accordance with the determination that the current location of the electronic device is not within the predefined physical region, the map does not include visual indications of respective information about the physical area, such as displaying map 1202 in FIG. 12I without indications 1212a through 1212d and 1214a through 1214c displayed in FIG. 12A. In some embodiments, the electronic device does not display the indications of the respective information while the current location of the electronic device is outside of the predefined physical region because the region outside of the predefined physical region does not include features such as elevation change, trails, and/or trail junctions. In some embodiments, if the area outside of the predefined physical region includes such features, the electronic device displays visual indications of those features. In some embodiments, if the area outside of the predefined physical region includes such features, the electronic device forgoes displaying the visual indications of those features because the area is outside of the predefined physical region. In some embodiments, while the current location of the electronic device is within the predefined physical area, the electronic device displays a map of an area outside of the predefined physical region without the visual indications of respective information about the physical area as described above. The map may include or not include information about a respective type of feature in the physical area outside of the predefined physical region without departing from the scope of the disclosure. In some embodiments, the map of area outside of the predefined physical region further includes indications of other types of features, such as roads and points of interest. Displaying visual indications of respective information relevant to the predefined physical area on the map of the predefined physical area enhances user interactions with the electronic device by surfacing information relevant to the user without having to receive a user input.

In some embodiments, maps including the predefined physical area (e.g., a park or hiking area) are displayed with a visual characteristic different from a visual characteristic of maps of other physical areas outside of the predefined physical area. For example, the background color of the map is different (e.g., green) for maps of the predefined physical area than the background color of the map for areas outside of the predefined physical area (e.g., grey). In some embodiments, maps including the predefined physical area include visual details, such as hill shading and physical feature labels, not included in maps of areas outside of the predefined physical area. In some embodiments, physical feature labels include labels of natural landforms, such as hills, mountains, valleys, and/or canyons.

In some embodiments, performing the feature with the maps application that is associated with the predefined physical region includes displaying one or more visual indications of one or more trails or one or more trailheads in the predefined physical region, such as indications 1218 and/or 1221a through 1221c and/or 1220a through 1220c in FIG. 12B. In some embodiments, the electronic device displays the visual indications of the trails and/or trailheads similarly to methods of displaying information described above with reference to method 900. For example, in response to detecting selection of the indication corresponding to the predefined physical region described above, the electronic device displays a map including visual indications of trails and trailheads in the predefined physical region. In some embodiments, the map is of a portion of the predefined physical region that includes the current location of the electronic device. In some embodiments, the visual indications include visual indications of trails and trailheads selected from more trails and trailheads based on one or more criteria, such as proximity to the current location of the electronic device, hours of operation, and/or popularity. Displaying indications of trails and trailheads in response to selection of the indication corresponding to the physical region enhances user interactions with the electronic device by automatically surfacing information relevant to the user.

It should be understood that the particular order in which the operations in FIG. 13 have been described is merely exemplary and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., methods 700, 900, and/or 1100) are also applicable in an analogous manner to method 1300 described above with respect to FIG. 13. For example, the operation of the electronic device to perform additional features while in a predetermined area described above with reference to method 1300 optionally has one or more of the characteristics of the presentation of the walking radius while in a maps application, presentation of information on a map including indications of locations, and presentation of navigation directions in different formats while navigating using different modes of transportation described herein with reference to other methods described herein (e.g., methods 700, 900 and/or 1100). For brevity, these details are not repeated here.

The operations in the information processing methods described above are, optionally, implemented by running one or more functional modules in an information processing apparatus such as general purpose processors (e.g., a as described with respect to FIGS. 1A-1B, 3, 5A-5J) or application specific chips. Further, the operations described above with reference to FIG. 13 are, optionally, implemented by components depicted in FIGS. 1A-1B. For example, displaying operation 1302c and/or receiving operation 1302d are, optionally, implemented by event sorter 170, event recognizer 180, and event handler 190. When a respective predefined event or sub-event is detected, event recognizer 180 activates an event handler 190 associated with the detection of the event or sub-event. Event handler 190 optionally utilizes or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

As described above, one aspect of the present technology is collecting location information. The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, collecting location information can be used to display maps of the physical area in which the electronic device is located. Accordingly, use of such personal information data enables users to use electronic devices to view maps of relevant geographic areas. Further, other uses for personal information data that benefit the user are also contemplated by the present disclosure. For instance, location data may be used to present navigation directions while the electronic device is traveling.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of location services, the present technology can be configured to allow users to select to “opt in” or “opt out” of participation in the collection of personal information data during registration for services or anytime thereafter. In another example, users can select not to enable location services in a specific application (e.g., first application and/or second application). In addition to providing “opt in” and “opt out” options, the present disclosure contemplates providing notifications relating to the access or use of personal information. For instance, a user may be notified upon initiating content collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an electronic device displays maps of physical areas without sensing the current location of the electronic device.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

1-21. (canceled)

22. A method comprising:
at an electronic device in communication with a display generation component and one or more input devices:
while displaying a user interface of a maps application:
receiving, via the one or more input devices, an input corresponding to a request to display respective information on a map of a physical area; and
in response to receiving the input:
displaying the map of the physical area with a plurality of indications of a plurality of locations corresponding to the respective information, including a first indication of a first location displayed with increased visual emphasis relative to a second indication of a second location; and
displaying, a user interface element including information about the first location without displaying a user interface element including information about the second location.

23. The method of claim 22, wherein the first indication of the first location includes an indication of respective information about the first location, and the second indication of the second location does not include an indication of the respective information about the second location.

24. The method of claim 22, wherein the input corresponding to a request to display respective information on the map is a request to search for locations corresponding to a search query.

25. The method of claim 24, wherein the plurality of indications of a plurality of locations corresponding to the respective information are a plurality of indications of the locations corresponding to the search query.

26. The method of claim 24, wherein the plurality of indications of the plurality of locations corresponding to the respective information includes an indication of a trail corresponding to the search query, wherein the indication of the trail includes multiple points on the map corresponding to multiple points of the trail in the physical area.

27. The method of claim 24, wherein the plurality of indications of the plurality of locations corresponding to the respective information includes an indication of a trailhead corresponding to the search query, wherein the indication of the trailhead is displayed at a location on the map corresponding to a location of the trailhead in the physical area.

28. The method of claim 22, further comprising:
while displaying the map of the physical area with the first indication of the first location displayed with increased visual emphasis relative to the second indication of a second location and the user interface element including the information about the first location without displaying the user interface element including the information about the second location, receiving, via a hardware input device included in the one or more input devices, an input; and
in response to receiving the input via the hardware input device:
updating display of the plurality of indications of the plurality of locations via the display generation component to display the second indication of the second location with increased visual emphasis relative to the first indication of the first location;
ceasing to display, via the display generation component, the user interface element including the information about the first location; and
displaying, via the display generation component, the user interface element including the information about the second location.

29. The method of claim 22, further comprising:
while displaying the map of the physical area with the plurality of indications of the plurality of locations, receiving, via the one or more input devices, an input corresponding to a request to update the map to be a second map of a second physical area different from the physical area; and
in response to receiving the input corresponding to the request to update the map to be the second map of the second physical area:
displaying, via the display generation component, the second map of the second physical area with a plurality of third indications of a plurality of third locations corresponding to the respective information, including a fourth indication of a fourth location displayed with increased visual emphasis relative to a fifth indication of a fifth location;
ceasing to display, via the display generation component, the user interface element including the information about the first location; and
displaying, via the display generation component, a user interface element including information about the fourth location.

30. The method of claim 22, wherein displaying the user interface element including the information about the first location includes:
in accordance with a determination that the first location has a first value for a characteristic, the information includes first information about the first location; and
in accordance with a determination that the first location has a second value for the characteristic different from the first value, the information includes second information about the first location different from the first information.

31. The method of claim 30, wherein the input corresponding to the request to display respective information includes a request to display navigation routes to a destination location, the plurality of indications of a plurality of locations corresponding to the respective information include a plurality of indications of the navigation routes to the destination location, and the user interface element including the information about the first location is a user interface element including information about a first navigation route to the destination location including:
in accordance with a determination that the first navigation route uses a first mode of transportation, the first information corresponding to the first mode of transportation; and
in accordance with a determination that the first navigation route uses a second mode of transportation different from the first mode of transportation, the second information corresponding to the second mode of transportation.

32. The method of claim 22, wherein the first location is a location of a trail, and the user interface element including the information about the first location includes an indication of a name of the trail, a distance between the location of the trail and a current location of the electronic device, an indication of a difficulty rating for the trail, an indication of a type of the trail, and an indication of a distance of a length of the trail.

33. The method of claim 22, wherein the first location is a location of a trailhead, and the user interface element including the information about the first location includes an indication of a name of the trailhead, an indication of a distance between the trailhead and a current location of the electronic device, and an indication of hours of operation of the trailhead.

34. The method of claim 22, wherein the plurality of indications of the plurality of locations corresponding to the respective information includes an indication of a trail and an indication of a trailhead.

35. The method of claim 22, wherein the first location is a location of a restaurant, and the user interface element including the information about the first location includes an indication of a name of the restaurant, an indication of a type of cuisine of the restaurant, an indication of a distance between the restaurant and a current location of the electronic device, an indication of hours of operation of the restaurant, and an indication of ratings of the restaurant.

36. The method of claim 22, wherein the first location is a location of a transit station, and the user interface element including the information about the first location includes a plurality of indications of a first plurality of transit lines available at a station, and the method further comprises:
receiving, via the one or more input devices, an input selecting the user interface element including the information about the first location; and
in response to receiving the input selecting the user interface element including the information about the first location, displaying second indications of the first plurality of transit lines available at the station and a second plurality of transit lines available at the station.

37. The method of claim 22, further comprising:
while displaying the map of the physical area with the plurality of indications of the plurality of locations corresponding to the respective information, receiving, via the one or more input devices, a second input; and
in response to receiving the second input:
ceasing to display the map of the physical area with the plurality of indications of the plurality of locations; and
displaying, via the display generation component, a second user interface element with information about the first location and a second user interface element including information about the second location.

38. The method of claim 22, further comprising:
while displaying the map of the physical area with the plurality of indications of the plurality of locations corresponding to the respective information and the user interface element including the information about the first location, receiving, via the one or more input devices, an input directed to the user interface element; and
in response to receiving the input directed to the user interface element, ceasing display of the user interface element and maintaining display of the map of the physical area with the plurality of indications of the plurality of locations corresponding to the respective information.

39. The method of claim 38, further comprising:
while displaying the map of the physical area with the plurality of indications of the plurality of locations corresponding to the respective information without displaying the user interface element including the information about the first location, receiving, via the one or more input devices, an input directed to the map; and
in response to receiving the input directed to the map, displaying, via the display generation component, the user interface element including the information about the first location and maintaining display of the map of the physical area with the plurality of indications of the plurality of locations corresponding to the respective information.

40. The method of claim 22, further comprising:
while displaying the map of the physical area with the plurality of indications of the plurality of locations corresponding to the respective information and the user interface element including the information about the first location, receiving, via the one or more input devices, an input directed to the user interface element; and
in response to receiving the input directed to the user interface element, displaying additional information about the first location.

41. The method of claim 22, wherein the input corresponding to the request to display the respective information on the map of the physical area includes a request to display navigation directions to a destination location, and the plurality of indications of the plurality of locations corresponding to the respective information include a plurality of indications of a plurality of available navigation routes to the destination location including the first indication of a first navigation route displayed with increased visual emphasis relative to the second indication of a second navigation route.

42. The method of claim 41, further comprising:
while displaying the map of the physical area with the plurality of indications of the plurality of available navigation routes to the destination location including the first indication of the first navigation route displayed with increased visual emphasis relative to the second indication of the second navigation route:
displaying, via the display generation component, a selectable option that, when selected, causes the electronic device to initiate navigation using the first navigation route; and
receiving, via the one or more input devices, an input corresponding to selection of the selectable option; and in response to receiving the input corresponding to selection of the selectable option, initiating navigation to the destination location using the first navigation route.

43. The method of claim 41, wherein the plurality of indications of available navigation routes to the destination location include indications of navigation segments with relatively high priority used in the available navigation routes displayed with increased visual emphasis and indications of navigation segments with relatively low priority used in the available navigation routes displayed with decreased visual emphasis.

44. The method of claim 41, wherein displaying the map of the physical area with the plurality of indications of the plurality of available navigation routes to the destination location including the first indication of the first navigation route displayed with increased visual emphasis relative to the second indication of the second navigation route is in accordance with a determination that the input corresponding to the request to display the navigation directions to the destination location is a request to display the navigation directions to the destination location using a first mode of transportation, and the method further comprises:
receiving, via the one or more input devices, a second input corresponding to a request to display navigation directions to the destination location using a second mode of transportation different from the first mode of transportation; and in response to receiving the second input:
displaying a visual indication of a navigation route using the first mode of transportation without displaying a map of a physical area with a plurality of indications of available navigation routes to the destination location using the first mode of transportation.

45. An electronic device in communication with a display generation component and one or more input devices:
one or more processors;
memory; and
one or more programs, wherein the one or more programs are stored in the memory and configured to be executed by the one or more processors, the one or more programs including instructions for:
while displaying a user interface of a maps application:
receiving, via the one or more input devices, an input corresponding to a request to display respective information on a map of a physical area; and
in response to receiving the input:
displaying the map of the physical area with a plurality of indications of a plurality of locations corresponding to the respective information, including a first indication of a first location displayed with increased visual emphasis relative to a second indication of a second location; and
displaying, a user interface element including information about the first location without displaying a user interface element including information about the second location.

46. A non-transitory computer readable storage medium storing one or more programs, the one or more programs comprising instructions, which when executed by one or more processors of an electronic device in communication with a display generation component and one or more input devices, cause the electronic device to perform a method comprising:
while displaying a user interface of a maps application:
receiving, via the one or more input devices, an input corresponding to a request to display respective information on a map of a physical area; and
in response to receiving the input:
displaying the map of the physical area with a plurality of indications of a plurality of locations corresponding to the respective information, including a first indication of a first location displayed with increased visual emphasis relative to a second indication of a second location; and
displaying, a user interface element including information about the first location without displaying a user interface element including information about the second location.

47-94. (canceled)
